(19) United States
(12) Patent Application Publication
(10) Pub. No.: US 2018/0273564 A1
(43) Pub. Date: Sep. 27, 2018

(54) CARBON MONOXIDE RELEASING MOLECULES

(71) Applicant: AUCKLAND UNISERVICES LIMITED, Auckland (NZ)

(72) Inventors: Christian HARTINGER, Auckland (NZ); Leonard James WRIGHT, Auckland (NZ)

(73) Assignee: AUCKLAND UNISERVICES LIMITED, Auckland (NZ)

(21) Appl. No.: 15/381,340

(22) Filed: Dec. 16, 2016

(30) Foreign Application Priority Data
Dec. 16, 2015 (NZ) 715213
Apr. 5, 2016 (NZ) 718640

(51) Int. Cl. C07F 15/00; C07F 11/00; C01B 32/40

(52) U.S. Cl. CPC C07F 15/0046; G01N 2021/3155; C01B 32/40; C07F 11/00

(57) ABSTRACT

Disclosed are carbon monoxide releasing complexes comprising a transition metal, at least one carbon monoxide ligand, and a pH responsive ligand that modulates the release of carbon monoxide, compositions comprising such complexes, and methods of using such compounds for treating various diseases and conditions and preserving cells, tissue or organs for transplantation.

### FIELD OF THE INVENTION

The present invention generally relates to carbon monoxide releasing complexes comprising a transition metal, at least one carbon monoxide ligand, and a pH responsive ligand that modulates the release of carbon monoxide, compositions comprising such complexes, and methods of using such compounds for treating various diseases and conditions and preserving cells, tissue or organs for transplantation.

### BACKGROUND TO THE INVENTION

Carbon monoxide (CO) is a colourless, tasteless and odourless gas. Despite gaseous CO being severely toxic at high levels, CO is constantly produced endogenously in mammalian cells with basal production levels at around 500 μmol per day (Hartsfield, C. L. Antioxid. Redox Signaling. 2002, 4, 301-307). The main source of endogenously produced CO is via the degradation of haem by haem oxygenase (HO) (Santos-Silva, T.; Mukhopadhyay, A.; D Seixas, J.; J L Bernardes, G.; C Romao, C.; J Romao, M. Curr. Med. Chem. 2011, 18, 3361-3366). There are two isoforms of haem oxygenase; inducible HO (HO-1) and constitutive HO (HO-2). HO-2 is present under normal conditions and is expressed primarily in the brain, testes and cerebral vascular systems. HO-2 is not triggered by external stimuli and serves to regulate cerebral function (Parfenova, H.; Leffler, C. W. Curr. Pharm. Des. 2008, 14, 443-453). HO-1, however, is triggered by external stimuli and is highly expressed when a cell is under stress such as UV_{A}-radiation, carcinogens, ischemia-reperfusion damage and endotoxic shock (Motterlini, R.; Mann, B. E.; Foresti, R. Expert Opin. Investig. Drugs 2005, 14, 1305-1318). This suggests that the induced formation of HO-1 to activate this pathway of haem degradation is an important defense mechanism within the body. HO-1 has been shown to have anti-inflammatory, antihypertensive, antiproliferative and antiapoptotic properties (Chiu, H.; Brittingham, J. A.; Laskin, D. L. Toxicol. Appl. Pharmacol. 2002, 181, 106-115; Gray, C. P.; Arosio, P.; Hersey, P. Blood 2002, 99, 3326-3334; Nakagami, T.; Toyomura, K.; Kinoshita, T.; Morisawa, S. Biochim. Biophys. Acta 1993, 1158, 189-193; and Vile, G. F.; Basu-Modak, S.; Waltner, C.; Tyrrell, R. M. Proc. Natl. Acad. Sci. 1994, 91, 2607-2610).

The protective properties shown by HO-1 are mediated by all three products of the catabolism of haem by HO-1: free iron (FeI), gaseous CO and bilirubin (Abraham, N. G.; Kappas, A. Pharmacol. Rev. 2008, 60, 79-127). However, CO in particular has a large mediating effect on these processes, especially in anti-inflammatory responses (Otterbein, L. E.; Soares, M. P.; Yamashita, K.; Bach, F. H. Trends Immunol. 2003, 24, 449-455). CO is now widely regarded, along with nitric oxide (NO) and hydrogen sulfide (H₂S), to be an important gaseotransmitter.

Numerous studies have determined that administering exogenous CO at very low, therapeutic doses can also provide beneficial therapeutic effects. However, the use of gaseous CO has several limitations. Being a gas, specialised inhalation devices have to be used. As a result, administration is limited to use in hospitals, which can be inconvenient for patients. Furthermore, when inhaled, CO has a high affinity for haemoglobin (Hb) forming carboxyhaemoglobin (COHb) and thus does not reach target tissues effectively. COHb levels of greater than 10% are toxic and start to induce symptoms such as dizziness and nausea while at higher level COHb becomes lethal (Romao, C. C.; Blättler, W. A.; Seixas, J. D.; Bernardes, G. J. Chem. Soc. Rev. 2012, 41, 3571-3583). The low selectivity and dose-limiting toxicity of gaseous CO is a major limitation for its use in human therapy.

Carbon monoxide releasing molecules (CORMs) have been proposed as an alternative to the administration of gaseous CO. However, many known CORMs lack tissue selectivity.

There is an ongoing need for further CORMs. It is an object of the present invention to go some way to meeting this need; and/or at least provide the public with a useful choice.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### SUMMARY OF THE INVENTION

In a first aspect, the present invention consists in a complex comprising:

a transition metal;
at least one carbon monoxide ligand coordinated to the transition metal; and
a pH responsive ligand coordinated to the transition metal that modulates the release of carbon monoxide from the complex such that the rate of release of carbon monoxide at a pH from about 6.0 to about 6.5 is greater than the rate of release of carbon monoxide at normal physiological pH (7.4);
or a pharmaceutically acceptable salt or solvate thereof.

In another aspect, the present invention consists in a composition comprising a complex of the present invention, and a carrier, diluent or excipient.

In another aspect, the present invention consists in a method of treating a disease or condition modulated by carbon monoxide (CO) or a disease or condition responsive to CO modulation in a subject in need thereof, the method comprising administering to the subject a complex or a composition of the present invention.

In another aspect, the present invention consists in a method of modulating the levels of carbon monoxide in a subject in need thereof, the method comprising administering to the subject a complex or a composition of the present invention that modulates the levels of CO at a site of desired activity in a subject, or in an organ, tissue or cell to be treated.

In another aspect, the present invention consists in a method of treating disease or condition selected from the group consisting of inflammation, hypertension, abnormal cell proliferation, cell apoptosis, allograft rejection, organ rejection, cardiovascular diseases or conditions, liver failure, tumor growth, myocardial ischemia, myocardial infarction, nephrotoxicity, renal failure, platelet aggregation, reperfusion injury, and microbial infection in a subject in need thereof, the method comprising administering to the subject a complex or composition of the present invention.

In another aspect, the present invention consists in a method of treating allograft rejection in a subject in need thereof, the method comprising administering a complex or composition of the present invention to a cell donor, tissue donor, or organ donor prior to transplantation of a cell, tissue, or organ from the donor to the subject in need thereof.

In another aspect, the present invention consists in a method of preserving a cell, tissue, or organ, the method comprising contacting the cell, tissue, or organ with a complex or composition of the present invention.

In another aspect, the present invention consists in a method of treating a reperfusion injury in a subject in need thereof, the method comprising administering to the subject a complex or composition of the present invention.

In another aspect, the present invention consists in a method of treating cancer in a subject in need thereof, the method comprising administering to the subject a complex or composition of the present invention.

In another aspect, the present invention consists in the use of a complex or composition of the invention in the manufacture of a medicament for treating a disease or condition.

In a further aspect, the present invention consists in a complex or composition of the invention for use in treating a disease or condition.

In another aspect, the present invention consists in the use of a complex or composition of the invention in the manufacture of a medicament for treating a disease or condition wherein the disease or condition is selected from the group consisting of a disease or condition modulated by carbon monoxide (CO); a disease or condition responsive to CO modulation; or inflammation, hypertension, abnormal cell proliferation, cell apoptosis, allograft rejection, organ rejection, cardiovascular diseases or conditions, liver failure, tumor growth, myocardial ischemia, myocardial infarction, nephrotoxicity, renal failure, platelet aggregation, reperfusion injury and microbial infection.

In another aspect, the present invention consists in the use of a complex or composition of the invention in the manufacture of a medicament for use in preserving a cell, tissue, or organ.

In a further aspect, the present invention consists in a complex or composition of the invention for use in treating a disease or condition wherein the disease or condition is selected from the group consisting of a disease or condition modulated by carbon monoxide (CO); a disease or condition responsive to CO modulation; or inflammation, hypertension, abnormal cell proliferation, cell apoptosis, allograft rejection, organ rejection, cardiovascular diseases or conditions, liver failure, tumor growth, myocardial ischemia, myocardial infarction, nephrotoxicity, renal failure, platelet aggregation, reperfusion injury and microbial infection.

In another aspect, the present invention consists in a complex or composition of the invention for preserving a cell, tissue, or organ.

The following embodiments and preferences may relate alone or in any combination of any two or more to any of the above aspects.

In various embodiments, the initial rate at 20° C. or half-life (t_{1/2}) at 20° C. of release of carbon monoxide at a pH from about 6.0 to 6.5 is at least about 1.1, 1.2, 1.3, 1.4, 1.5, 1.6, 1.7, 1.8, 1.9, 2, 2.5, 3, 3.5, or about 4 times greater than the initial rate of release at 20° C. or the half life of release at 20° C. at normal physiological pH when measured by myoglobin assay. Preferably, the rate of release is at least about 2, 2.5, 3, 3.5, or 4 times greater.

In various embodiments, the transition metal is selected from groups 5 to 9 and periods 4 to 6 of the periodic table, for example ruthenium, iron, osmium, manganese, vanadium, cobalt, rhodium, iridium, nickel, chromium, molybdenum, or tungsten. In various embodiments, the transition metal is selected from Ru, Os, Mn, Fe, Rh, Ir, Mo, W, V, Ni, Cr, or Co.

In various embodiments, the transition metal is Ru(0), Ru(II), Ru(III), Os(0), Os(II), Os(III), Os(IV), Mn(0), Mn(II), Mn(III), Mn(IV), Fe(0), Fe(II), Fe(III) Rh(I), Rh(II), Rh(III), Ir(I), Ir(II), Ir(III), Mo(0), Mo(II), Mo(III), Mo(IV), W(0), W(II), W(III), W(IV), V(II), V(III), V(IV), Ni(0), Ni(II), Ni(III), Cr(0), Cr(II), Cr(III), Cr(IV), Co(I), Co(II), or Co(III).

In various embodiments, the transition metal is in the +II oxidation state.

In various embodiments, the transition metal is ruthenium, iron, osmium, manganese, vanadium, or molybdenum. In various embodiments, the transition metal is ruthenium, iron, osmium, manganese, or vanadium.

In various embodiments, the transition metal is ruthenium, iron, osmium, or molybdenum. In various embodiments, the transition metal is ruthenium, iron, or osmium.

In certain embodiments, the transition metal is ruthenium, osmium, or molybdenum. In certain embodiments, the transition metal is ruthenium or osmium.

In exemplary embodiments, the transition metal is ruthenium or molybdenum. In exemplary embodiments, the transition metal is ruthenium (for example Ru(II)).

In exemplary embodiments, the transition metal is molybdenum (for example Mo(0)).

In various embodiments, the complex comprises from 1 to 5 CO ligands coordinated to the transition metal, for example from 1-4, 1-3, 1-2, 2-5, 2-4, or 2-3 CO ligands.

In various embodiments, the complex comprises two or more, for example two, three, or four, carbon monoxide ligands coordinated to the transition metal.

In exemplary embodiments, the complex comprises two or three CO ligands coordinated to the transition metal.

In various embodiments, greater than 50, 60, 70, 75, 80, 85, 90, 95, 96, 97, 98, or 99 mol % of the pH responsive ligand is in a protonated form at a pH from about 6.0 to about 6.5 and greater than 50, 60, 70, 75, 80, 85, 90, 95, 96, 97, 98, or 99 mol % of the pH responsive ligand is in the form of a conjugate base of the protonated form at normal physiological pH.

In various embodiments, the pH responsive ligand (when coordinated to the transition metal) has a pKa from about 5 to about 9, for example from about 6 to about 8. In various embodiments, the pKa is from about 6-7.5 or 6-7.

In various embodiments, the pH responsive ligand is monodentate, bidentate, tridentate, or tetradentate. In certain embodiments, the pH responsive ligand is bidentate or tridentate.

In exemplary embodiments, the pH responsive ligand is bidentate.

In various embodiments, the pH responsive ligand comprises at least one (for example one, two, or three) group of the formula (A):

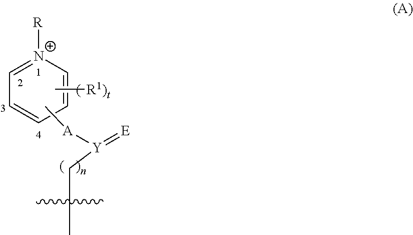

wherein:
E at each instance or A at each instance is independently coordinated to the transition metal;
when E is coordinated to the transition metal A is independently a protonated nitrogen atom (—NH—) or an negatively charged nitrogen atom (—N⁻—) and Y=E is independently C═O, C═S, C═Se, C═NR′, or S(═O)₂;
when A is coordinated to the transition metal A is independently a negatively charged nitrogen atom (—N⁻—) and Y=E is independently C═O, C═S, C═Se, C═NR′, or S(═O)₂ or a protonated form thereof;
each pyridinium ring attached to A is independently attached to A via the 2- or 4-position of the pyridinium ring;
t at each instance is independently an integer from 0-4;
n at each instance is independently an integer from 0-6 (for example 0-3);
R at each instance is independently selected from —PR¹¹R¹¹ or —NR¹¹R¹¹ or alkyl, alkenyl, alkynyl, carbocyclyl, carbocyclylalkyl, aryl, arylalkyl, heteroaryl, heterocyclyl, ether, or polyether, each of which is optionally substituted with one or more optional substituents;
R¹⁰ at each instance and R¹¹ at each instance are each independently selected from hydrogen or alkyl, alkenyl, alkynyl, carbocyclyl, carbocyclylalkyl, aryl, arylalkyl, heteroaryl, heterocyclyl, each of which is optionally substituted with one or more optional substituents; or R¹⁰ and R¹¹ together with the atom to which they are attached form a heterocyclic or heteroaryl ring optionally substituted with one or more optional substituents;
R′ at each instance is independently selected from hydrogen or alkyl, alkenyl, alkynyl, carbocyclyl, carbocyclylalkyl, aryl, arylalkyl, heteroaryl, heterocyclyl, each of which is optionally substituted with one or more optional substituents;
R¹ at each instance is independently N₃, halo, or cyano, or alkyl, alkenyl, alkynyl, carbocyclyl, carbocyclylalkyl, aryl, arylalkyl, heteroaryl, heterocyclyl, ether, or polyether, each of which is optionally substituted with one or more optional substituents;
or a tautomer, stereoisomer, or resonance form thereof.

In certain embodiments, the pH responsive ligand has the formula (I):

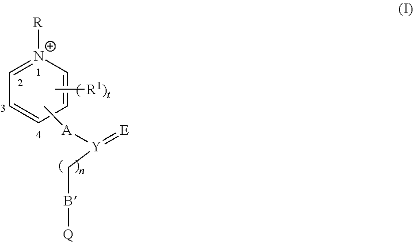

wherein
Q is selected from -J, -E′, -E″-G, -T-G, or

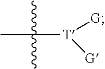

G and G′ are each independently

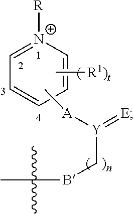

J is a non-coordinating group;
E′ is a donor group comprising a donor atom selected from O, N, C, S, Se, or P coordinated to the transition metal that together with the A or E coordinated to the transition metal and the atoms through which they are attached forms a 4 to 8 membered (for example, 5 or 6 membered) chelate ring with the transition metal;
E″ is a donor group comprising a donor atom selected from O, N, C, S, Se, or P coordinated to the transition metal that together with each A or E coordinated to the transition metal and the atoms through which they are attached independently forms a 4 to 8 membered (for example, 5 or 6 membered) chelate ring with the transition metal;
T is a bond or a non-coordinating group that together with the pair of A or E coordinated to the transition metal and the atoms through which they are attached forms a 5 to 11 membered (for example 5 to 8 membered) chelate ring with the transition metal;
T′ is a non-coordinating group that together with each pair of A or E coordinated to the transition metal and the atoms through which they are attached forms a 6 to 11 membered (for example 6 to 8 membered) chelate ring with the transition metal;
B′ at each instance is independently selected from a bond or a bridging group comprising a linear chain of from 1 to 4 atoms (for example 1 or 2 atoms) selected from C, N, Si, P, B, O, and S, wherein each free valence site is occupied by one or more independently selected R′; and
A, Y=E, t, n, R, R′, and R¹ are as defined in any of the preceding embodiments;
or a tautomer, stereoisomer, or resonance form thereof.

In specifically contemplated embodiments, the complex is six coordinate. In exemplary embodiments, the complex is octahedral (including substantially octahedral).

In various embodiments, the complex comprises one or more other ligands coordinated to the transition metal selected from a monodentate (for example chloride) or bidentate ligand.

In various embodiments, the complex comprises at least one CO ligand, a pH responsive ligand, and one or more other monodentate or bidentate ligands that occupy the remaining coordination sites of the transition metal.

In exemplary embodiments, the complex does not comprise a pi-coordinated aromatic or heteroaromatic ring system.

In various embodiments, the complex is a compound of the formula (II):

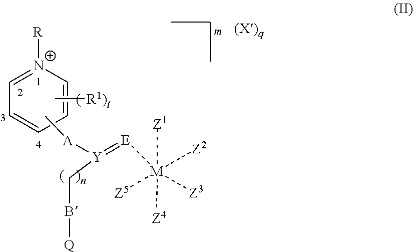

wherein:
m represents the charge of the complex and is 0 or a negative or positive integer;
q is 0 when m is 0 or q is 1 when m is a negative or positive integer (i.e. X′ is absent when m is 0 and X′ is present when m is a negative or positive integer);
X′ is one or more anions that balance the charge of the complex when m is a positive integer or one or more cations that balance the charge of the complex when m is a negative integer;
M is a transition metal selected from Ru, Os, Mn, Fe, Rh, Ir, Mo, W, V, Ni, Cr, or Co;
Q is selected from -J, -E′, -E″-G, -T-G, or

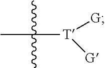

G and G′ are each independently

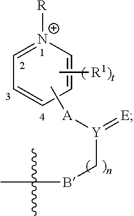

J is a non-coordinating group;
E′ is a donor group comprising a donor atom selected from O, N, C, S, Se, or P coordinated to the transition metal that together with E coordinated to the transition metal and the atoms through which they are attached forms a 4 to 8 membered (for example, 5 or 6 membered) chelate ring with the transition metal;
E″ is a donor group comprising a donor atom selected from O, N, C, S, Se, or P coordinated to the transition metal that together with each E coordinated to the transition metal and the atoms through which they are attached independently forms a 4 to 8 membered (for example, 5 or 6 membered) chelate ring with the transition metal;
T is a bond or a non-coordinating group that together with the pair of E coordinated to the transition metal and the atoms through which they are attached forms a 5 to 11 membered (for example 5 to 8 membered) chelate ring with the transition metal;
T′ is a non-coordinating group that together with each pair of E coordinated to the transition metal and the atoms through which they are attached forms a 6 to 11 membered (for example 6 to 8 membered) chelate ring with the transition metal;
A at each instance is independently is a protonated nitrogen atom (—NH—) or an negatively charged nitrogen atom (—N⁻—);
each pyridinium ring attached to A is independently attached to A via the 2- or 4-position of the pyridinium ring;
Y=E at each instance is independently C═O, C═S, C═Se, C═NR′, or S(═O)₂;
E at each instance is coordinated to the transition metal;
B′, t, n, R, R′, and R¹ are as defined in any of the preceding embodiments described herein;
Z¹, Z², Z³, Z⁴, and Z⁵ are each independently CO, or a monodentate ligand;
or any two cis Z¹, Z², Z³, Z⁴, and Z⁵ together form a bidentate ligand;
or, when Q is -E′, Z⁵ is a coordination bond between the donor atom of E′ and M;
or, when Q is -E″-G, Z⁴ is a coordination bond between the donor atom of E″ and M and Z⁵ is a coordination bond between the E of G and M;
or, when Q is

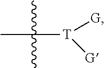

Z⁴ is a coordination bond between the E of G and M and Z⁵ is a coordination bond between the E of G′ and M;
provided that at least one of Z¹, Z², Z³, Z⁴, and Z⁵ is CO;
or a pharmaceutically acceptable salt, solvate, tautomer, stereoisomer, or resonance form thereof.

In various embodiments, each optional substituent is independently selected from halogen, —CN, —NO₂, —N₃, —SO₂H, —SO₃H, —OH, —OR^{a}, —ON(R^{b})₂, —N(R^{b})₂, —N(R^{b})₃⁺X⁻, —N(OR^{c})R^{b}, —SH, —SR^{a}, —SSR^{c}, —C(═O)R^{a}, —CO₂H, —CHO, —CR^{a}(OR^{c})₂, —CO₂R^{a}, —OC(═O)R^{a}, —OCO₂R^{a}, —C(═O)N(R^{b})₂, —OC(═O)N(R^{b})₂, —NR^{b}C(═O)R^{a}, —NR^{b}CO₂R^{a}, —NR^{b}C(═O)N(R^{b})₂, —C(═NR^{b})R^{a}, —C(═NR^{b})OR^{a}, —OC(═NR^{b})R^{a}, —OC(═NR^{b})OR^{a}, —NR^{b}C(N(R^{b})₂)N(R^{b})₂⁺X⁻, —OC(═NR^{b})N(R^{b})₂, —NR^{b}C(═NR^{b})N(R^{b})₂, —C(═O)NR^{b}SO₂R^{a}, —NR^{b}SO₂R^{a}, —SO₂N(R^{b})₂, —SO₂R^{a}, —SO₂OR^{a}, —OSO₂R^{a}, —S(═O)R^{a}, —OS(═O)R^{a}, —Si(R^{a})₃, —OSi(R^{a})₃—C(═S)N(R^{b})₂, —C(═O)SR^{a}, —C(═S)SR^{a}, —SC(═S)SR^{a}, —SC(═O)SR^{a}, —OC(═O)SR^{a}, —SC(═O)OR^{a}, —SC(═O)R^{a}, —P(═O)₂R^{a}, —OP(═O)₂R^{a}, —P(═O)(R^{a})₂, —OP(═O)(R^{a})₂, —OP(═O)(OR^{c})₂, —P(═O)₂N(R^{b})₂, —OP(═O)₂N(R^{b})₂, —P(═O)(NR^{b})₂, —OP(═O)(NR^{b})₂, —NR^{b}P(═O)(OR^{c})₂, —NR^{b}P(═O)(NR^{b})₂, —P(R^{c})₂, —P(OR^{c})₂, —P(R^{c})₃⁺X⁻, —P(OR^{c})₃, —OP(R^{c})₂, —OP(R^{c})₃⁺X⁻, —B(R^{a})₂, —B(OR^{c})₂, —B(OR^{c})₃⁻X⁺, —BR^{a}(OR^{c}), ═O, ═S, ═NN(R^{b})₂, ═NNR^{b}C(═O)R^{a}, ═NNR^{b}C(═O)OR^{a}, ═NNR^{b}S(═O)₂R^{a}, ═NR^{b}, ═NOR^{c}, alkyl (for example C₁₋₁₀ alkyl or C₁₋₂₀ alkyl), perhaloalkyl (for example C₁₋₁₀ perhaloalkyl), alkenyl (for example C₂₋₁₀ alkenyl), alkynyl (for example C₂₋₁₀ alkynyl), carbocyclyl (for example C₃₋₁₀ carbocyclyl), heterocyclyl (for example 3-14 membered heterocyclyl), aryl (for example C₆₋₁₄ aryl), and heteroaryl (for example 5-14 membered heteroaryl), wherein each alkyl, alkenyl, alkynyl, carbocyclyl, heterocyclyl, aryl, and heteroaryl is optionally substituted with from 1 to 5 independently selected R^{d};

R^{a} at each instance is independently selected from C₁₋₁₀ alkyl, C₁₋₁₀ perhaloalkyl, C₂₋₁₀ alkenyl, C₂₋₁₀ alkynyl, C₃₋₁₀ carbocyclyl, 3-14 membered heterocyclyl, C₆₋₁₄ aryl, and 5-14 membered heteroaryl, or two R^{a} groups are joined to form a 3-14 membered heterocyclyl or 5-14 membered heteroaryl ring, wherein each alkyl, alkenyl, alkynyl, carbocyclyl, heterocyclyl, aryl, and heteroaryl is optionally substituted with from 1 to 5 groups independently selected from C₁₋₁₀ alkyl, C₁₋₁₀ perhaloalkyl, C₂₋₁₀ alkenyl, C₂₋₁₀ alkynyl, C₃₋₁₀ carbocyclyl, 3-14 membered heterocyclyl, C₆₋₁₄ aryl, and 5-14 membered heteroaryl;
R^{b} at each instance is independently selected from hydrogen, —OH, —OR^{a}, —N(R^{c})₂, —CN, —C(═O)R^{a}, —C(═O)N(R^{c})₂, —CO₂R^{a}, —SO₂R^{a}, —C(═NR^{c})OR^{a}, —C(═NR^{c})N(R^{c})₂, —SO₂N(R^{c})₂, —SO₂R^{c}, —SO₂OR^{c}, —SOR^{a}, —C(═S)N(R^{c})₂, —C(═O)SR^{c}, —C(═S)SR^{c}, —P(═O)₂R^{a}, —P(═O)(R^{a})₂, —P(═O)₂N(R^{c})₂, —P(═O)(NR^{c})₂, C₁₋₁₀ alkyl, C₁₋₁₀ perhaloalkyl, C₂₋₁₀ alkenyl, C₂₋₁₀ alkynyl, C₃₋₁₀ carbocyclyl, 3-14 membered heterocyclyl, C₆₋₁₄ aryl, and 5-14 membered heteroaryl, or two R^{b} groups are joined to form a 3-14 membered heterocyclyl or 5-14 membered heteroaryl ring, wherein each alkyl, alkenyl, alkynyl, carbocyclyl, heterocyclyl, aryl, and heteroaryl is optionally substituted with from 1 to 5 groups independently selected from C₁₋₁₀ alkyl, C₁₋₁₀ perhaloalkyl, C₂₋₁₀ alkenyl, C₂₋₁₀ alkynyl, C₃₋₁₀ carbocyclyl, 3-14 membered heterocyclyl, C₆₋₁₄ aryl, and 5-14 membered heteroaryl;
R^{c} at each instance is independently selected from hydrogen, C₁₋₁₀ alkyl, C₁₋₁₀ perhaloalkyl, C₂₋₁₀ alkenyl, C₂₋₁₀ alkynyl, C₃₋₁₀ carbocyclyl, 3-14 membered heterocyclyl, C₆₋₁₄ aryl, and 5-14 membered heteroaryl, or two R^{c} groups are joined to form a 3-14 membered heterocyclyl or 5-14 membered heteroaryl ring, wherein each alkyl, alkenyl, alkynyl, carbocyclyl, heterocyclyl, aryl, and heteroaryl is optionally substituted with from 1 to 5 groups independently selected from C₁₋₁₀ alkyl, C₁₋₁₀ perhaloalkyl, C₂₋₁₀ alkenyl, C₂₋₁₀ alkynyl, C₃₋₁₀ carbocyclyl, 3-14 membered heterocyclyl, C₆₋₁₄ aryl, and 5-14 membered heteroaryl; and
R^{d} at each instance is independently selected from halogen, —CN, —NO₂, —N₃, —SO₂H, —SO₃H, —OH, —OR^{a}, —N(R^{b})₂, —N(R^{b})₃⁺X⁻, —N(OR^{c})R^{b}, —SH, —SR^{a}, —SSR^{c}, —C(═O)R^{a}, —CO₂H, —CHO, —CO₂R^{a}, —OC(═O)R^{a}, —C(═O)N(R^{b})₂, —NR^{b}CO₂R^{a}, —NR^{b}C(═O)N(R^{b})₂, —C(═NR^{b})R^{a}, —NR^{b}C(N(R^{b})₂)N(R^{b})₂⁺X⁻, —SO₂R^{a}, —OSO₂R^{a}, —C(═S)N(R^{b})₂, —P(═O)(R^{a})₂, —OP(═O)(OR^{c})₂, —P(R^{c})₂, —P(OR^{c})₂, —P(R^{c})₃⁺X⁻, P(OR^{c})₃, —OP(R^{c})₂, —OP(R^{c})₃⁺X⁻, —B(R^{a})₂, —B(OR^{c})₂, ═O, ═S, ═NR^{b}, ═NOR^{c}, alkyl (for example C₁₋₁₀ alkyl or C₁₋₂₀ alkyl), perhaloalkyl (for example C₁₋₁₀ perhaloalkyl), alkenyl (for example C₂₋₁₀ alkenyl), alkynyl (for example C₂₋₁₀ alkynyl), carbocyclyl (for example C₃₋₁₀ carbocyclyl), heterocyclyl (for example 3-14 membered heterocyclyl), aryl (for example C₆₋₁₄ aryl), and heteroaryl (for example 5-14 membered heteroaryl); and
X⁻ is a counteranion.

In various embodiments, each optional substituent is independently selected from halogen, —CN, —NO₂, —N₃, —SO₂H, —SO₃H, —OH, —OR^{a}, —N(R^{b})₂, —N(R^{b})₃⁺X⁻, —N(OR^{c})R^{b}, —SH, —SR^{a}, —SSR^{c}, —C(═O)R^{a}, —CO₂H, —CHO, —CO₂R^{a}, —OC(═O)R^{a}, —C(═O)N(R^{b})₂, —NR^{b}CO₂R^{a}, —NR^{b}C(═O)N(R^{b})₂, —C(═NR^{b})R^{a}, —NR^{b}C(N(R^{b})₂)N(R^{b})₂⁺X⁻, —SO₂R^{a}, —OSO₂R^{a}, —C(═S)N(R^{b})₂, —P(═O)(R^{a})₂, —OP(═O)(OR^{c})₂, —P(R^{c})₂, —P(OR^{c})₂, —P(R^{c})₃⁺X⁻, P(OR^{c})₃, —OP(R^{c})₂, —OP(R^{c})₃⁺X⁻, —B(R^{a})₂, —B(OR^{c})₂, ═O, ═S, ═NR^{b}, ═NOR^{c}, alkyl (for example C₁₋₁₀ alkyl or C₁₋₂₀ alkyl), perhaloalkyl (for example C₁₋₁₀ perhaloalkyl), alkenyl (for example C₂₋₁₀ alkenyl), alkynyl (for example C₂₋₁₀ alkynyl), carbocyclyl (for example C₃₋₁₀ carbocyclyl), heterocyclyl (for example 3-14 membered heterocyclyl), aryl (for example C₆₋₁₄ aryl), and heteroaryl (for example 5-14 membered heteroaryl), wherein each alkyl, alkenyl, alkynyl, carbocyclyl, heterocyclyl, aryl, and heteroaryl is optionally substituted with from 1 to 5 independently selected R^{d}.

In various embodiments, J is selected from —OH, —SO₃H, —NO₂, halo, —CN, —C(═O)R′, —C(NR′)R′, —NR′R′, aliphatic, heteroaliphatic, carbocyclyl, aryl, heterocyclyl, or heteroaryl, each of which is optionally substituted with one or more optional substituents.

In certain embodiments, J is selected from aliphatic, heteroaliphatic, carbocyclyl, aryl, heterocyclyl, or heteroaryl, each of which is optionally substituted with one or more optional substituents.

In various embodiments, E′ and E″ are each independently selected from:

(i) an acyclic group comprising from 1 to 10 carbon atoms (for example 1 to 6 carbon atoms), wherein at least one carbon atom is replaced by the donor atom and wherein one or more other carbon atoms are optionally replaced by a heteroatom selected from O, N, or S, wherein the acyclic group is optionally substituted with one or more optional substituents;
(ii) a carbocyclic, aromatic, heterocyclic, or heteroaromatic ring system substituted with an acyclic group comprising from 1 to 10 carbon atoms (for example 1 to 6 carbon atoms), wherein at least one carbon atom of the acyclic group is replaced by the donor atom and wherein one or more other carbon atoms of the acyclic group are optionally replaced by a heteroatom selected from O, N, or S, wherein the ring system and acyclic group are each independently optionally substituted with one or more optional substituents; or
(iii) a carbocyclic, aromatic, heterocyclic, or heteroaromatic ring system comprising the donor atom, wherein the donor atom is endocyclic, and wherein the ring system is optionally substituted with one or more optional substituents.

It will be appreciated that in some embodiments all of the carbon atom(s) of an acyclic group can be replaced with one or more heteroatoms.

In various embodiments relating to E′ or E″, the acyclic group of (i) of (ii) comprises a —NR″₂, —N(OR″)R″, —NO₂, —N(O⁻)R″, —O⁻, —OR″, —S⁻, —S—S—R″, —N═N—R″, —PR″₂, —OP(OR″)₂, —CN, —SR″, —C(═O)R″, —C(═O)OR″, —OC(═O)R″, —C(═O)O⁻, —SO₃⁻, —C(═O)NR″₂, —NR″C(═O)R″, —C(═S)R″, —C(═S)OR″, —OC(═S)R″, —C(═S)SR″, —SC(═S)R″, —C(═O)SR″, —SC(═O)R″, —C(═S)NR″₂, —NR″C(═S)R″, —C(═NR″)R″, —N═CR″₂, —SO₂⁻, —SO₂R″, —OPO₃R″⁻, —OPO₃²⁻, —OPO₃³⁻, —N₃, —C(═O)NR″⁻, —N⁻—C(═O)R″, —C(═S)NR″⁻, —N—C(═S)R″, or —NR″CO₂⁻ group comprising the donor atom, wherein R″ at each instance is independently selected from a bond or hydrogen, or alkyl, alkenyl, alkynyl, carbocyclyl, carbocyclylalkyl, aryl, arylalkyl, heteroaryl, or heterocyclyl, each of which is optionally substituted with one or more optional substituents.

In various embodiments, R″ is selected from hydrogen, or alkyl, alkenyl, alkynyl, carbocyclyl, carbocyclylalkyl, aryl, arylalkyl, heteroaryl, or heterocyclyl, each of which is optionally substituted with one or more optional substituents.

In various embodiments relating to E′ or E″, the acyclic group of (i) or (ii) comprises a —NR″₂, —C(═NR″)R″, —N═CR″₂, —PR″₂, —C(═O)NR″⁻, —N—C(═O)R″, or —C(═O)R″ comprising the donor atom.

In various embodiments relating to E′ or E″, the ring system of (iii) comprising the endocyclic donor atom comprises a —O—, carbene, —S—, —NR′″—, —N═, phosphite, phosphine, lactam, lactone, thiolactam, or thiolactone group comprising the donor atom, wherein R′″ at each instance is independently selected from hydrogen, —OH, or —OR′, or alkyl, alkenyl, alkynyl, carbocyclyl, carbocyclylalkyl, aryl, arylalkyl, heteroaryl, or heterocyclyl, each of which is optionally substituted with one or more optional substituents.

In various embodiments, E′ and E″ are each independently a monocyclic heteroaromatic ring system (for example a nitrogen containing heterocyclic ring system) comprising the endocyclic donor atom, wherein the ring system is optionally substituted with one or more optional substituents.

In exemplary embodiments, E′ and E″ are each independently a pyridyl ring optionally substituted with one or more optional substituents.

In various embodiments, T and T′ are each independently:

(i) a bridgehead comprising a C, N, B, P, or Si atom to which each B′ is attached, wherein each free valence site is occupied by one or more independently selected R′; or
(ii) an acyclic bridgehead group comprising from 2 to 10 carbon atoms, wherein one or more carbon atoms are optionally replaced by a heteroatom selected from O, N, or S, wherein the acyclic bridgehead group is optionally substituted with one or more optional substituents; or
(iii) a cyclic bridgehead group comprising one or more carbocyclic, aromatic, heterocyclic, heteroaromatic, borazine, or phosphazine rings (for example a carbohydrate or calixarene), wherein the cyclic bridgehead group is optionally substituted with one or more optional substituents.

In various embodiments, T or T′ are each independently a bridgehead comprising a C, N, B, P, or Si atom to which each B′ is attached, wherein each free valence site is occupied by one or more independently selected R′.

In various embodiments, T is C(R′)₂ or NR′″ and B′ at each instance is a bond; or T′ is CR′ or N and B′ at each instance is a bond.

In various embodiments relating to T or T′, the acyclic bridgehead group of (ii) is an aliphatic or heteroaliphatic group; or the cyclic bridgehead group of (ii) is a monocyclic aromatic or heteroaromatic ring system.

In various embodiments, B′ at each instance is independently selected from a bond or a C, N, Si, P, B, O, or S atom, wherein each free valence site is occupied by one or more independently selected R′.

In exemplary embodiments, B′ at each instance is a bond.

In certain specifically contemplated embodiments, the complex is a compound of the formula (II-A) or (II-B):

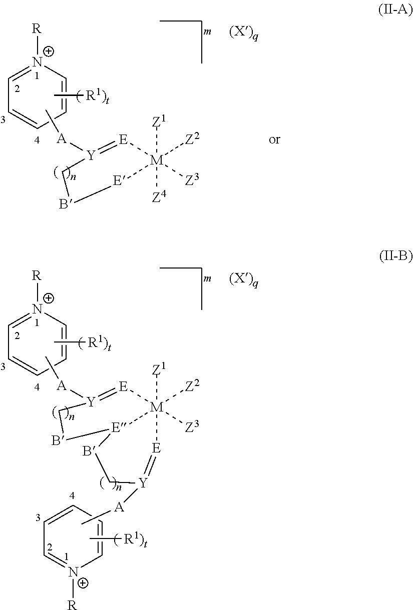

wherein:
E′ and E″ are each independently a carbocyclic, aromatic, heterocyclic, or heteroaromatic ring system comprising an endocyclic donor atom selected from O, N, C, S, Se, or P coordinated to the transition metal, and wherein the ring system is optionally substituted with one or more optional substituents; and
the remaining variables as defined in any of the preceding embodiments described herein;
or a pharmaceutically acceptable salt, solvate, tautomer, stereoisomer, or resonance form thereof.

In various embodiments, the complex is a compound of the formula (II-A).

In other embodiments, the complex is a compound of the formula (II-B).

In exemplary embodiments, the complex is a compound of formula (II-A1) or (II-B1):

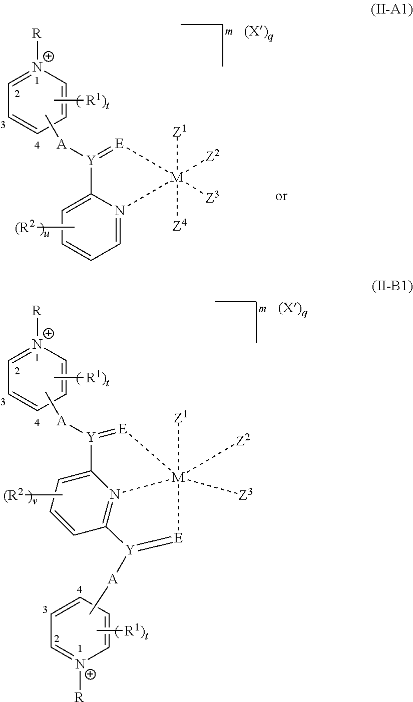

wherein:
R² is an optional substituent as defined in any of the preceding embodiments described herein;
u is an integer from 0-4;
v is an integer from 0-3; and
the remaining variables are as defined in any of the preceding embodiments described herein;
or a pharmaceutically acceptable salt, solvate, tautomer, stereoisomer, or resonance form thereof.

In exemplary embodiments, the complex is a compound of the formula (II-A1).

In other embodiments, the complex is a compound of the formula (II-B1).

In certain specifically contemplated embodiments, Y=E at each instance is independently C═O or C═S.

In exemplary embodiments, Y=E at each instance is C═O.

In various embodiments:

(i) the monodentate ligand comprises a neutral donor atom selected from N, P, S, or O or a negatively charged donor atom selected from a halide (for example Cl⁻, Br or r), N, P, S, or O; or
(ii) the bidentate ligand comprises (a) two neutral donor atoms independently selected from N, C, P, S, or O; (b) a neutral donor atom independently selected from N, C, P, S, or O and a negatively charged donor atom independently selected from N, C, P, S, or O; or (c) two negatively charged donor atoms independently selected from N, C, P, S, or O; wherein the two donor atoms of the bidentate ligand together with the atoms to which they are attached form a 4 to 8 membered ring (for example a 5 or 6 membered ring) with the transition metal.

In certain embodiments:

(i) the monodentate ligand comprising a neutral donor atom is selected from the group consisting of amines (e.g. NR′₃), phosphines (e.g. PR′₃), P(OR′)₃, PTA (1,3,5-triaza-7-phosphaadamantane), nitriles (e.g. R′CN), isonitriles (R′NC), thioethers (e.g. R′SR′), sulfoxides (e.g. R′₂SO), CS, CSe, ketones and aldehydes (e.g. R′C(═O)R′), amides (e.g. R′C(═O)NR′₂), R′C(═S)R′, R′C(═Se)R′, R′S(═O)₂R′, R′C(═S)NR′₂, R′C(═S)OR′, R′C(═S)SR′, R′C(═O)SR′, imines (e.g. R′₂C═NR′), heterocycles, carbenes (e.g. CR′₂ and N-heterocyclic carbenes), alkenes, alkynes, NO⁺, and MePTA⁺; or
(ii) the monodentate ligand comprising an negatively charged donor atom is selected from the group consisting of halides, hydroxide, R′O⁻ (for example alkoxides and aryloxides, such as phenoxide), amine anions (e.g. R′₂N⁻), NO⁻, NO₃⁻, NO₂⁻, SO₂²⁻, thiolates (e.g. R′S⁻), sulfonates (R′SO₃⁻), sulfenates (e.g. R′SO₂⁻), phosphates and derivatives thereof (e.g. OPO₃R′₂⁻, OPO₃R′²⁻, OPO₃³⁻) carbonates and derivatives thereof (e.g. OCO₂R′⁻, OCO₂²⁻), thiolato (e.g. R′S⁻), pseudohalides (for example CN⁻, N₃⁻, SCN⁻, NCS⁻, OCN⁻, and NCO⁻), carboxylates (e.g. R′CO₂⁻), amidates (e.g. R′C(═O)NR′⁻), thiocarbamates (e.g. R′C(═S)NR′⁻), carbamates (e.g. NR′₂CO₂⁻), carbanions (for example alkyl, aryl, alkenyl, alkynyl, and allyl anions), and hydride.

In certain embodiments, the bidentate ligand comprises two groups comprising a donor atom independently selected from —NR′₂, —PR′₂, —P(OR′), —CN, —NC, —R′SR′, —R′SO, —C(═O)R′, —C(═O)OR′, —C(═O)NR′₂, —C(═S)R′, —C(═S)NR′₂, —C(═S)OR′, —C(═S)SR′, —C(═O)SR′, —C(═NR′)R′, —O⁻, —S⁻, —NR′⁻, —SO₃⁻, —OP(═O)O₂R′, —OP(═O)O₂²⁻, —CO₂⁻, —C(═O)NR′⁻, —C(═S)NR′⁻, or —NR′CO₂⁻; or the bidentate ligand comprises a bridged heterocycle, an N-heterocyclic carbene, a cyclic or acyclic diene, or an acyclic diyne.

In exemplary embodiments, the complex is a compound of the formula (II-A2), (II-A3), (II-A4), (II-A5), or (III-B2):

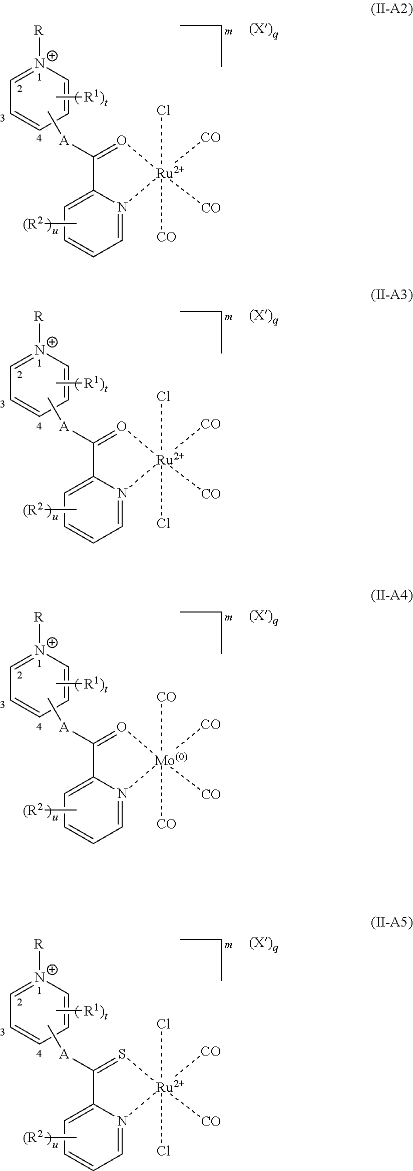

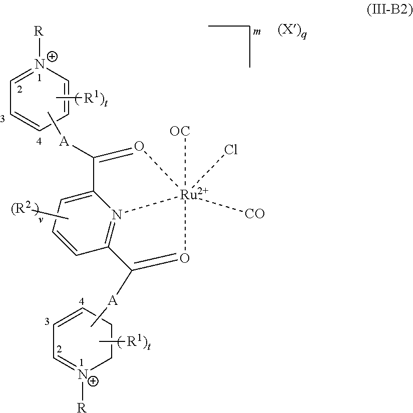

wherein the variables are as defined in any of the preceding embodiments described herein; or a pharmaceutically acceptable salt, solvate, tautomer, stereoisomer, or resonance form thereof.

In exemplary embodiments, the complex is a compound of formula (II-A2):

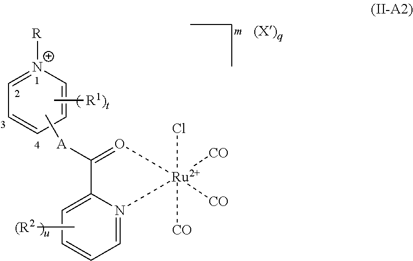

wherein the variables are as defined in any of the preceding embodiments described herein; or a pharmaceutically acceptable salt, solvate, tautomer, stereoisomer, or resonance form thereof.

In exemplary embodiments, the complex is a compound of the formula (II-A3) as defined above; or a pharmaceutically acceptable salt, solvate, tautomer, stereoisomer, or resonance form thereof.

In exemplary embodiments, the complex is a compound of the formula (II-A4) as defined above; or a pharmaceutically acceptable salt, solvate, tautomer, stereoisomer, or resonance form thereof.

In exemplary embodiments, the complex is a compound of the formula (II-A5) as defined above; or a pharmaceutically acceptable salt, solvate, tautomer, stereoisomer, or resonance form thereof.

In exemplary embodiments, the complex is a compound of the formula (III-B2) as defined above; or a pharmaceutically acceptable salt, solvate, tautomer, stereoisomer, or resonance form thereof.

In exemplary embodiments, each pyridinium ring attached to A is attached to A via the 4-position of the pyridinium ring.

In certain embodiments, the complex comprises the pH responsive ligand in the form of a conjugate base of the protonated form.

In certain embodiments, the complex comprises the pH responsive ligand in a protonated form.

In various embodiments, each E is coordinated to the transition metal and A is a negatively charged nitrogen atom (—N⁻—); or each A is coordinated to the transition metal and Y=E is not in protonated form.

In various embodiments, each E is coordinated to the transition metal and A is a protonated nitrogen atom (—NH—); or each A is coordinated to the transition metal and Y=E is in protonated form.

In exemplary embodiments, E is coordinated to the transition metal and A is a negatively charged nitrogen atom (—N⁻—).

In exemplary embodiments, E is coordinated to the transition metal and A is a protonated nitrogen atom (—NH—).

In various embodiment, m is selected from −1, 0, 1, 2, 3, 4, 5, or 6. In various embodiments, m is 0, 1, 2, 3, or 4. In various embodiments, m is from 0, 1 or 2.

In various embodiments, the composition has an alkaline pH.

In various embodiments, the composition maintains the complex at an alkaline pH in a subject after administration to the subject, and is formulated to allow the complex to release carbon monoxide (CO) at a site of desired activity in the subject.

In various embodiments, the composition maintains the complex at an alkaline pH upon administration to an organ, tissue, or cell or a composition comprising an organ, tissue or cell, and is formulated to allow the complex to release CO at a site of desired activity in or around the organ, tissue or cell.

In various embodiments, the composition is formulated to modulate the CO at a site of desired activity in a subject, or around an organ, tissue or cell to be treated.

In exemplary embodiments, composition is a pharmaceutical composition comprising a pharmaceutically acceptable carrier, diluent or excipient.

In various embodiments, the method comprises administration of an effective amount of the complex, composition or pharmaceutical composition of the invention.

In various embodiments, the method comprises contacting the organ, tissue or cell with an effective amount of the complex, composition or pharmaceutical composition of the invention.

In another aspect, the present invention provides a pH responsive ligand of the formula (I) as defined in any of the aspects or embodiments herein relating to the complexes of the present invention.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

Although the present invention is broadly as defined above, those persons skilled in the art will appreciate that the invention is not limited thereto and that the invention also includes embodiments of which the following description gives examples.

### BRIEF DESCRIPTION OF THE FIGURES

Preferred embodiments of the invention will be described by way of example only and with reference to the Figures, in which:

FIG. 1 shows graphs comparing the CO-releasing abilities of pH-CORM-1 at pH 6.4, 6.8 and 7.4 at 20° C. The absorbance at 540 nm was normalised so that the smallest value of each condition was converted to 0 while the largest value was converted to 100.

FIG. 2 shows graphs comparing the CO-releasing abilities of pH-CORM-1 at pH 6.4, 6.8 and 7.4 at 37° C. The absorbance at 540 nm was normalised so that the smallest value of each condition was converted to 0 while the largest value was converted to 100.

FIG. 3 shows graphs comparing the CO-releasing abilities of 1 at pH 6.4, 6.8 and 7.4 at 20° C. The absorbance at 540 nm was normalised so that the smallest value of each condition was converted to 0 while the largest value was converted to 100.

FIG. 4 shows graphs comparing the CO-releasing abilities of 1 at pH 6.4, 6.8 and 7.4 at 37° C. The absorbance at 540 nm was normalised so that the smallest value of each condition was converted to 0 while the largest value was converted to 100.

FIG. 5 shows graphs comparing the CO-releasing abilities of 2 at pH 6.4, 6.8 and 7.4 at 20° C. The absorbance at 540 nm was normalised so that the smallest value of each condition was converted to 0 while the largest value was converted to 100.

FIG. 6 shows graphs comparing the CO-releasing abilities of 2 at pH 6.4, 6.8 and 7.4 at 37° C. The absorbance at 540 nm was normalised so that the smallest value of each condition was converted to 0 while the largest value was converted to 100.

FIGS. 7 and 8 are graphs showing the conversion of deoxymyoglobin to carbonmonoxy myoglobin over time for Ru(CO)₂Cl₂L at pH 6.4 and 7.4, respectively.

FIGS. 9 and 10 are graphs showing the conversion of deoxymyoglobin to carbonmonoxy myoglobin over time for Ru(CO)₂Cl₂L″ at pH 6.4 and 7.4, respectively.

FIGS. 11 and 12 are graphs showing the conversion of deoxymyoglobin to carbonmonoxy myoglobin over time for Mo(CO)₄L at pH 6.4 and 7.4, respectively.

FIGS. 13 and 14 are graphs showing the conversion of deoxymyoglobin to carbonmonoxy myoglobin vs time for [Ru(CO)₂Cl(BnL′)]Cl at pH 6.4 and 7.4, respectively.

FIG. 15 is a graph showing the time dependent change in the absorption at 555 nm in the UV-vis spectrum at pH 6.4 and 7.4 for Mo(CO)₄L.

FIG. 16 is a picture showing the molecular structure of Ru(CO)₂Cl₂L as determined by X-ray diffraction analysis.

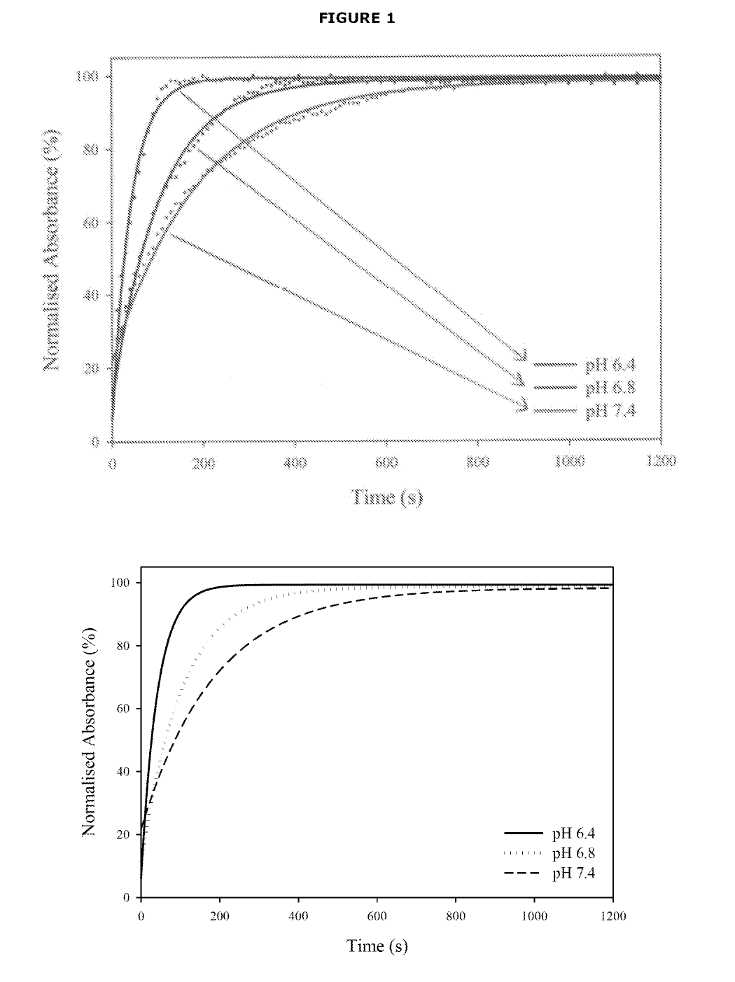

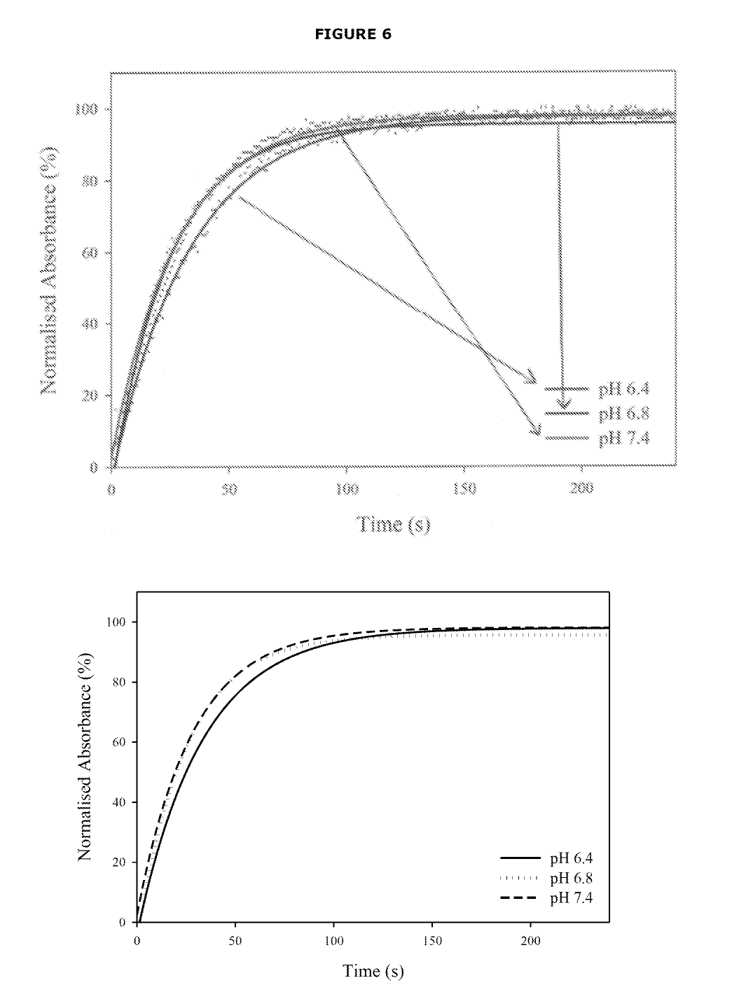

In each of FIGS. 1-6, the upper graph shows distribution of the data points and a fitted line for each data series and the lower graph shows fitted lines as a solid line (pH 6.4), dotted line (pH 6.8), or dashed line (pH 7.4) for the same data.

### DETAILED DESCRIPTION OF THE INVENTION

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

As used herein the term “and/or” means “and” or “or”, or both.

As used herein “(s)” following a noun means the plural and/or singular forms of the noun.

“Subject” as used herein is preferably an animal. Preferably the animal is a mammal. Preferably the mammal includes human and non-human mammals including but not limited to cats, dogs, horses, cows, sheep, deer, mice, rats, primates (including gorillas, rhesus monkeys and chimpanzees), pigs, possums and other domestic farm or zoo animals, but not limited thereto. Preferably, the mammal is human.

As used herein, the terms “treat”, “treating” and “treatment” refer to therapeutic measures which alleviate, ameliorate, manage, prevent, restrain, stop or reverse a disease or disorder, including the symptoms associated with or related to that disease or disorder. The subject may show observable or measurable (statistically significant) decrease in one or more of the symptoms associated with or related to the disease or disorder to be treated, as known to those skilled in the art, as indicating improvement.

An “effective amount” or “effective dose” as used herein means an amount sufficient to produce the desired physiological effect or an amount capable of achieving a desired result. By way of non-limiting example, a desired result is treating any one or combination of inflammation, hypertension, abnormal cell proliferation, cell apoptosis, allograft rejection, organ rejection including liver, heart, kidney, and aortic rejection, cardiovascular diseases or conditions, liver failure, tumor growth, myocardial ischemia, myocardial infarction, nephrotoxicity including cisplatin induced nephrotoxicity, renal failure, platelet aggregation, reperfusion injury including myocardial ischemia reperfusion injury, microbial infection including eukaryotic, bacterial, fungal and viral infections. In another example, a desired result is treating any one of an organ that has been removed from a subject, an organ that has been isolated from the subject's blood supply, an isolated organ in vitro or ex vivo, and an organ that is at risk of ischemic damage.

The general chemical terms used in the formulae herein have their usual meanings.

The term “alkyl” as used herein alone or in combination with other terms, unless indicated otherwise, refers to a radical of a straight-chain or branched saturated hydrocarbon group. In various embodiments, the alkyl group has from 1 to 10 carbon atoms (“C1-10 alkyl”). For example, an alkyl group can have 1 to 8 carbon atoms (“C1-8 alkyl”), 1 to 6 carbon atoms (“C1-6 alkyl”), 1 to 4 carbon atoms (“C1-4 alkyl”), 1 to 3 carbon atoms (“C1-3 alkyl”), or 2 to 6 carbon atoms (“C2-6 alkyl”). Examples of alkyl groups include but are not limited to methyl (C1), ethyl (C2), n-propyl (C3), isopropyl (C3), n-butyl (C4), tert-butyl (C4), sec-butyl (C4), iso-butyl (C4), n-pentyl (C5), 3-pentanyl (C5), amyl (C5), neopentyl (C5), 3-methyl-2-butanyl (C5), tertiary amyl (C5), n-hexyl (C6), n-heptyl (C7), n-octyl (C8), n-nonyl (C9), n-decyl (C10), and the like.

The term “alkenyl” as used herein alone or in combination with other terms, unless indicated otherwise, refers to a radical of a straight-chain or branched hydrocarbon group having one or more carbon-carbon double bonds. In various embodiments, the alkenyl group has from 2-10 carbon atoms (“C2-10 alkenyl”). For example, an alkenyl group can have 2 to 8 carbon atoms (“C2-8 alkenyl”), 2 to 6 carbon atoms (“C2-6 alkenyl”), or 2 to 4 carbon atoms (“C2-4 alkenyl”). The one or more carbon-carbon double bonds can be internal (such as in 2-butenyl) or terminal (such as in 1-butenyl). Examples of alkenyl groups include but are not limited to ethenyl (C2), 1-propenyl (C3), 2-propenyl (C3), 1-butenyl (C4), 2-butenyl (C4), butadienyl (C4), pentenyl (C5), pentadienyl (C5), hexenyl (C6), heptenyl (C7), octenyl (C8), octatrienyl (C8), and the like.

The term “alkynyl” as used herein alone or in combination with other terms, unless indicated otherwise, refers to a radical of a straight-chain or branched hydrocarbon group having one or more carbon-carbon triple bonds. In various embodiments, alkynyl group has from 2-10 carbon atoms (“C2-10 alkynyl”). For example, an alkynyl group can have 2 to 8 carbon atoms (“C2-8 alkynyl”), 2 to 6 carbon atoms (“C2-6 alkynyl”), or 2 to 4 carbon atoms (“C2-4 alkynyl”). The one or more carbon-carbon triple bonds can be internal (such as in 2-butynyl) or terminal (such as in 1-butynyl). Examples of alkynyl groups include, without limitation, ethynyl (C2), 1-propynyl (C3), 2-propynyl (C3), 1-butynyl (C4), 2-butynyl (C4), pentynyl (C5), hexynyl (C6), heptynyl (C7), octynyl (C8), and the like.

The term “carbocyclyl” or “carbocyclic ring system” (or “carbocyclic” when referring to a ring system) as used herein alone or in combination with other terms, unless indicated otherwise, refers to a monocyclic, bicyclic or polycyclic hydrocarbon ring system, wherein each ring is either completely saturated or contains one or more units of unsaturation, but where no ring is aromatic. Representative carbocyclyl or carbocyclic groups include cycloalkyl groups (e.g., cyclopentyl, cyclobutyl, cyclopentyl, cyclohexyl and the like), and cycloalkenyl groups (e.g., cyclopentenyl, cyclohexenyl, cyclopentadienyl, and the like). In various embodiments, carbocyclic or carbocyclyl groups comprise from 3-12 ring carbon atoms, for example from 3-10, 3-8, 3-6, or 5-10 ring carbon atoms. In various embodiments, carbocyclic or carbocyclyl groups comprise from 3-10 ring carbon atoms. Examples of carbocyclic or carbocyclyl groups include but are not limited to cyclopropyl (C3), cyclopropenyl (C3), cyclobutyl (C4), cyclobutenyl (C4), cyclopentyl (C5), cyclopentenyl (C5), cyclohexyl (C6), cyclohexenyl (C6), cyclohexadienyl (C6) cycloheptyl (C7), cycloheptadienyl (C7), and the like.

The term “carbocyclylalkyl” as used herein alone or in combination with other terms, unless indicated otherwise, refers to an alkyl group substituted with a carbocyclyl group. The carbocyclylalkyl group is attached to the parent moiety through the alkyl group.

The term “aryl” or “aromatic ring system” (or the term “aromatic” when referring to a ring system) as used herein alone or in combination with other terms, unless indicated otherwise, refers to a monocyclic, bicyclic or polycyclic hydrocarbon ring system, wherein at least one ring is aromatic. Representative aryl groups and aromatic ring systems include fully aromatic ring systems, such as phenyl, naphthyl, and anthracenyl, and ring systems where an aromatic carbon ring is fused to one or more non-aromatic carbon rings, such as indanyl or tetrahydronaphthyl, and the like. In various embodiments, aryl or arormatic ring systems comprise from 6-14 ring carbon atoms, for example from 6-12, or from 6-10 ring carbon atoms.

The term “arylalkyl” as used herein alone or in combination with other terms, unless indicated otherwise, refers to an alkyl group substituted with an aryl group. The arylalkyl group is attached to the parent moiety through the alkyl group.

The term “heteroaryl” or “heteroaromatic ring system” (or “heteroaromatic” when referring to a ring system) as used herein alone or in combination with other terms, unless indicated otherwise, refers to a monocyclic, bicyclic or polycyclic ring system wherein at least one ring is both aromatic and comprises a heteroatom. In various embodiments, a ring which is aromatic and comprises a heteroatom comprises 1, 2, 3, or 4 ring heteroatoms in such ring. In various embodiments, each heteroatom is independently selected from O, N, S, or B, preferably O, N, or S. In various embodiments, the heteroaryl group or heteroaromatic ring system comprises from 5 to 16, from 5 to 14, from 5 to 12, from 5 to 10, from 5 to 8, or from 5 to 6 ring atoms. In various embodiments, the heteroaryl group or heteroaromatic ring system comprises from 5-10 ring atoms and 1-4 ring heteroatoms. Examples of heteroaryl groups or heteroaromatic ring systems include but are not limited to ring systems where (i) each ring comprises a heteroatom and is aromatic, e.g., imidazolyl, oxazolyl, thiazolyl, triazolyl, pyrrolyl, furanyl, thiophenyl pyrazolyl, pyridinyl, pyrazinyl, pyridazinyl, pyrimidinyl, indolizinyl, purinyl, naphthyridinyl, and pteridinyl; (ii) each ring is aromatic or carbocyclyl, at least one aromatic ring comprises a heteroatom and at least one other ring is a hydrocarbon ring or e.g., indolyl, isoindolyl, benzothienyl, benzofuranyl, dibenzofuranyl, indazolyl, benzimidazolyl, benzthiazolyl, quinolyl, isoquinolyl, cinnolinyl, phthalazinyl, quinazolinyl, quinoxalinyl, carbazolyl, acridinyl, phenazinyl, phenothiazinyl, phenoxazinyl, and tetrahydroisoquinolinyl; and (iii) each ring is aromatic or carbocyclyl, and at least one aromatic ring shares a bridgehead heteroatom with another aromatic ring. Examples of heteroaryl groups or heteroaromatic ring systems also include but are not limited to ring systems in which at least one ring is aromatic and comprises a heteroatom and at least one other ring is non-aromatic and comprises a heteroatom. In certain embodiments, the heteroaryl group or heteroaromatic ring system is a monocyclic or bicyclic ring, wherein each of said rings contain 5 or 6 ring atoms where 1, 2, 3, or 4 of said ring atoms are a heteroatom independently selected from N, O, and S. In certain embodiments, the heteroaryl group or heteroaromatic ring system is monocyclic.

The term “heterocyclyl” or “heterocyclic ring system” (or “heterocyclic” when referring to a ring system) as used herein alone or in combination with other terms, unless indicated otherwise, refers to monocyclic, bicyclic and polycyclic ring system wherein at least one ring is saturated or partially unsaturated (but not aromatic) and comprises a heteroatom, and no ring is both aromatic and comprises a heteroatom. In various embodiments, a ring which is saturated or partially unsaturated and comprises a heteroatom comprises 1, 2, 3, or 4 ring heteroatoms in such ring. In various embodiments, each heteroatom is independently selected from O, N, S, or B, preferably O, N, or S. In various embodiments, the heterocyclyl group or heterocyclic ring system comprises from 3 to 16, from 3 to 14, from 3 to 12, from 3 to 10, from 3 to 8, or from 3 to 6 ring atoms, or from 5-12, 5-10, or 5-8 ring atoms, or 5 or 6 ring atoms. In various embodiments, the heterocyclyl group or heterocyclic ring system comprises from 5-10 ring atoms and 1-4 ring heteroatoms. Examples of heterocyclyl groups or heterocyclic ring systems include, but are not limited to, ring systems in which (i) every ring is non-aromatic and at least one ring comprises a heteroatom, e.g., tetrahydrofuranyl, tetrahydrothienyl, pyrrolidinyl, pyrrolidonyl, piperidinyl, pyrrolinyl, decahydroquinolinyl, oxazolidinyl, piperazinyl, dioxanyl, dioxolanyl, diazepinyl, oxazepinyl, thiazepinyl, morpholinyl, and quinuclidinyl; and (ii) at least one ring is non-aromatic and comprises a heteroatom and at least one other ring is an aromatic carbon ring, e.g., 1,2,3,4-tetrahydroisoquinolinyl. In certain embodiments, the heterocyclyl group or heterocyclic ring system is a monocyclic or bicyclic ring, wherein each of said rings contains 3-7 ring atoms where 1, 2, 3, or 4 of said ring atoms are a heteroatom independently selected from N, O, and S. In certain embodiments, the heterocyclyl or heteroaromatic ring system is monocyclic.

The term “partially unsaturated” as used herein alone or in combination with other terms, unless indicated otherwise, refers to a non-aromatic group that includes one or more double or triple bonds.

The term “ether” as used as used herein alone or in combination with other terms, unless indicated otherwise, refers to a group of the formula -A¹OA², wherein A¹ and A² are each independently selected from aliphatic, carbocylyl, aryl, heteroaryl, and heterocyclyl. In various embodiments, A¹ and A² are each independently alkyl or aryl.

The term “polyether” as used as used herein alone or in combination with other terms, unless indicated otherwise, refers to a group of the formula -A¹(OA²)_{n′}, wherein n′ is 2 or more (for example from 2-20, 2-10, or 2-8) and A¹ and A² at each instance are each independently selected from aliphatic, carbocylyl, aryl, heteroaryl, and heterocyclyl. In various embodiments, A¹ and A² are each independently alkyl or aryl. Example of polyethers include but are not limited to polyalkylene glyol alcohols and alkyl ethers thereof, such polyethylene glycol and polypropylene glycol.

The terms “halo”, “halogen” and “halide” as used herein, unless indicated otherwise, refer to F, Cl, Br, and I.

The term “cyano” as used herein, unless indicated otherwise, refers to a —CN group.

The term “aliphatic,” as used herein alone or in combination with other terms, unless indicated otherwise, refers to a saturated and unsaturated straight chain (i.e., unbranched) or branched acyclic hydrocarbon group. Aliphatic groups include, for example, alkyl, alkenyl, and alkynyl groups. In various embodiments, aliphatic groups comprise from 1-12, 1-8, 1-6, or 1-4 carbon atoms. In some embodiments, the aliphatic group is saturated (i.e. an alkyl group).

The term “heteroaliphatic” as used herein alone or in combination with other terms, unless indicated otherwise, refers to an aliphatic group, wherein one or more carbon atoms are independently replaced by one or more heteroatoms. In various embodiments, each heteroatom is independently selected from O, N, S, or B, preferably O, N, or S. Examples of heteroaliphatic groups include linear or branched heteroalkyl, heteroalkenyl, and heteroalkynyl groups.

As used herein, the term “substituted” is intended to mean that one or more hydrogen atoms in the group indicated is replaced with one or more independently selected suitable substituents, provided that the normal valency of each atom to which the substituent/s are attached is not exceeded, and that the substitution results in a stable compound. Suitable substituents include the above mentioned optional substituents.

Asymmetric centers may exist in the ligands and complexes described herein. Asymmetric centers may be designated as (R) or (S), depending on the configuration of substituents in three dimensional space at the chiral atom. All stereochemical isomeric forms of the compounds, including diastereomeric, enantiomeric, and epimeric forms, as well as d-isomers and I-isomers, and mixtures thereof, including enantiomerically enriched and diastereomerically enriched mixtures of stereochemical isomers, are included herein.

Individual enantiomers can be prepared synthetically from commercially available enantiopure starting materials or by preparing enantiomeric mixtures and resolving the mixture into individual enantiomers. Resolution methods include conversion of the enantiomeric mixture into a mixture of diastereomers and separation of the diastereomers by, for example, recrystallization or chromatography, and any other appropriate methods known in the art. Starting materials of defined stereochemistry may be commercially available or made and, if necessary, resolved by techniques well known in the art.

The compounds described herein may also exist as conformational or geometric stereoisomers, including mer, fac, cis, trans, syn, anti, entgegen (E), and zusammen (Z) isomers. All such stereoisomers and any mixtures thereof are within the scope of the invention.

Also within the scope of the invention are any tautomeric isomers or mixtures thereof of the compounds described. As would be appreciated by those skilled in the art, a wide variety of functional groups and other structures may exhibit tautomerism. Examples include, but are not limited to, keto/enol, imine/enamine, and thioketone/enethiol tautomerism.

The compounds described herein may also exist as isotopologues and isotopomers, wherein one or more atoms in the compounds are replaced with different isotopes. Suitable isotopes include, for example, ¹H, ²H (D), ³H (T), ¹²C, ¹³C, ¹⁴C, ¹⁶O, and ¹⁸O. Procedures for incorporating such isotopes into the compounds described herein will be apparent to those skilled in the art. Isotopologues and isotopomers of the compounds described herein are also within the scope of the invention.

Also within the scope of the invention are pharmaceutically acceptable salts of the compounds described herein. Such salts include, acid addition salts, base addition salts, and quaternary salts of basic nitrogen-containing groups.

Acid addition salts can be prepared by reacting compounds, in free base form, with inorganic or organic acids. Examples of inorganic acids include, but are not limited to, hydrochloric, hydrobromic, nitric, sulfuric, and phosphoric acid. Examples of organic acids include, but are not limited to, acetic, trifluoroacetic, propionic, succinic, glycolic, lactic, malic, tartaric, citric, ascorbic, maleic, fumaric, pyruvic, aspartic, glutamic, stearic, salicylic, methanesulfonic, benzenesulfonic, isethionic, sulfanilic, adipic, butyric, and pivalic.

Base addition salts can be prepared by reacting compounds, in free acid form, with inorganic or organic bases. Examples of inorganic base addition salts include alkali metal salts, alkaline earth metal salts, and other physiologically acceptable metal salts, for example, aluminium, calcium, lithium, magnesium, potassium, sodium, or zinc salts. Examples of organic base addition salts include amine salts, for example, salts of trimethylamine, diethylamine, ethanolamine, diethanolamine, and ethylenediamine.

Quaternary salts of basic nitrogen-containing groups in the compounds may be may be prepared by, for example, reacting the compounds with alkyl halides such as methyl, ethyl, propyl, and butyl chlorides, bromides, and iodides, dialkyl sulfates such as dimethyl, diethyl, dibutyl, and diamyl sulfates, and the like.

The compounds described herein may form or exist as solvates with various solvents. If the solvent is water, the solvate may be referred to as a hydrate, for example, a mono-hydrate, a di-hydrate, or a tri-hydrate. All solvated forms and unsolvated forms of the compounds described herein are within the scope of the invention.

The present invention provides a complex comprising:

a transition metal;
at least one carbon monoxide ligand coordinated to the transition metal; and
a pH responsive ligand coordinated to the transition metal that modulates the release of carbon monoxide from the complex such that the rate of release of carbon monoxide at a pH from about 6.0 to about 6.5 is greater than the rate of release of carbon monoxide at normal physiological pH (7.4);
or a pharmaceutically acceptable salt or solvate thereof.

The transition metal may be selected from groups 5 to 9 and periods 4 to 6 of the periodic table. Examples of such metals include ruthenium, iron, osmium, manganese, vanadium, cobalt, rhodium, iridium, nickel, chromium, molybdenum, or tungsten. In various embodiments, the transition metal is selected from Ru, Os, Mn, Fe, Rh, Ir, Mo, W, V, Ni, Cr, or Co.

The transition metal may be in any suitable oxidation state having regard to the pH responsive ligand, the at least one carbon monoxide ligand, and any other ligand present. In various embodiments, the transition metal is in the +II oxidation state.

In certain exemplary embodiments the transition metal is ruthenium(II).

The complex comprises at least one carbon monoxide (CO) ligand coordinated to the transition metal. Release of the at least one CO ligand from the complex is modulated by the pH responsive ligand.

The maximum number of CO ligands coordinated to the transition metal may depend on the denticity of the pH responsive ligand. The complex may comprise from 1-5 CO ligands coordinated to the transition metal. In various embodiments, the complex comprises two or more CO ligands.

The pH responsive ligand modulates the release of CO from the complex such that the rate of release at a pH from about 6.0-6.5 is greater than the rate of release at normal physiological pH (7.4).

The rate of release of CO from the complex may be determined by any suitable method known in the art. Useful in vitro methods include the myoglobin assay described in the Examples below. The method can be used to determine the initial rate of release of CO from the complex and the half life (t_{1/2}) of release of CO from the complex. The inventors have found that rate of release in certain complexes of the invention can be dependent on temperature, as well as pH.

The pH responsive ligand provides the complexes of the present invention with pH dependent CO-release capability. This may be useful in various therapeutic applications. For example, tissue in pathological states such as in cancer, inflammation, stroke, arthritis and ischemia are typically more acidic than normal, healthy tissue. The variation in pH between healthy and diseased tissue is typically very subtle with an average difference of only 0.5 pH units. Complexes of the present invention are capable of selectively releasing more CO in for example diseased tissue at a lower pH than normal physiological pH.

The release of CO from the complex may be modulated by protonation of the pH responsive ligand. At a pH from about 6.0 to about 6.5 the pH responsive ligand may exist predominantly in a protonated form and at normal physiological pH may exist predominantly in the form of a conjugate base of the protonated form.

The ratio of protonated form to conjugate base at any given pH depends on the pKa of the pH responsive ligand. In certain embodiments, the pH responsive ligand (when coordinated to the transition metal) has a pKa from about 6 to about 8. The pKa of the pH responsive ligand, when coordinated to the transition metal, may be determined by any suitable method known in the art. Suitable methods include, for example, pH titration using spectroscopic methods.

The pH responsive ligand may have more than one pKa, for example where a pH responsive ligand comprises two or more groups of the formula (A). In such embodiments, at least one pKa of the pH responsive ligand is from about 5-9, for example about 6-8.

The pH responsive ligand can be monodentate, bidentate, tridentate, or tetradentate. In exemplary embodiments, the pH responsive ligand is bidentate.

In certain embodiments, the pH responsive ligand comprises at least one (for example one, two, or three) group of the formula (A) as defined herein:

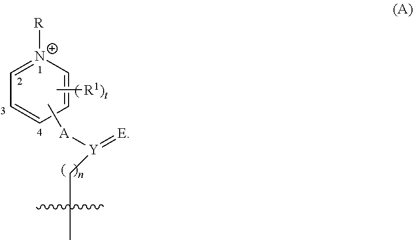

In the ligand comprising the group(s) of formula (A), E at each instance or A at each instance is coordinated to the transition metal. That is, E or A in each group of the formula (A) in the ligand is coordinated to the transition metal.

The formula encompasses both protonated and conjugate base forms of the ligand. When E is coordinated to the transition metal protonation can occur at A, as shown below in Scheme 1 (wherein M is the coordinated transition metal). Conversely, when A is coordinated to the transition metal protonation can occur at E.

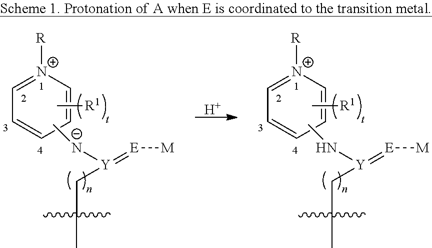

The pyridinium ring is attached to A at the 2- or 4-positions of the pyridinium ring. In exemplary embodiments, each pyridinium ring is attached to A at the 4-position of the pyridinium ring.

It will be apparent to those skilled in the art that a number of resonance forms are possible, as shown for example in Scheme 2. As a result of these resonance forms, the group of the formula (A) is highly stabilized. The group is strongly electron donating towards the transition metal and thus capable of forming strong σ-coordination bonds.

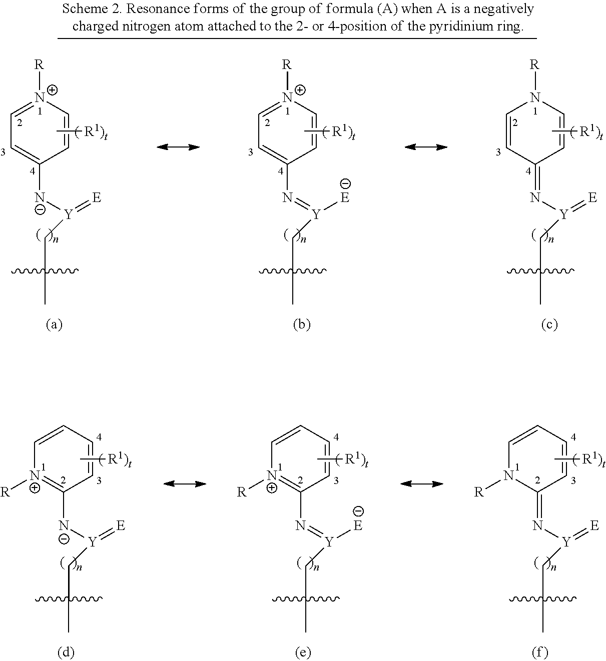

The present invention encompasses all resonance forms of the complexes of the invention. Resonance hybrids of such resonance forms are also within the scope of the invention. For convenience, in this specification typically only one resonance for a given structure will be depicted.

In certain embodiments, the pH responsive ligand has the formula (I) as defined herein:

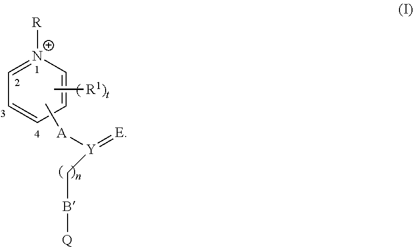

pH responsive ligands of formula (I) contain from 1-3 groups of the formula (A), each of which may independently be coordinated to the transition metal via A or E. Ligands of formula (I) may be monodentate when Q is J, bidentate when Q is -E′ or -T-G, or tridentate when Q is -E″-G or -T′GG′. The J, E′, E″, T, and T′ groups are as defined in any of the embodiments set out above.

A bridging group B′ may be present between J, E′, E″, T, and T′ and each attached group of formula (A). The bridging group is as defined in any of the embodiments described herein.

The complex is preferably six coordinate. The six coordinate complex may be octahedral (including substantially octahedral) in geometry. Those skilled in the art will appreciate that where a six coordinate or octahedral complex comprises one or more multidentate ligands the complex may exist in various stereoisomeric forms, for example cis/trans and facial (fac)/meridional (mer) and optical isomers. The present invention includes all such stereoisomers of the complexes of the invention. The coordination geometry of a complex may be determined by various methods known in the art, for example by x-ray crystallography, NMR, CD, UV/vis and IR spectroscopy.

The complex may comprise one or more other ligands coordinated to the transition metal selected from a monodentate (for example chloride) or bidentate ligand, in addition to the pH responsive ligand and at least one CO ligand. The one or more other monodentate or bidentate ligands may occupy the remaining coordination sites of the transition metal.

In exemplary embodiments, the complex does not comprise a pi-coordinated aromatic ring system. In exemplary embodiments, the complex does not comprise a pi-coordinated aromatic or heteroaromatic ring system.

Any suitable monodentate or bidendate ligand may be employed in the complex provided that the complex provides the desired pH dependent CO release. The monodentate or bidentate ligand may be as defined in any of the preceding embodiments.

Numerous monodentate and bidentate ligands are known in the art. Examples include but are not limited to amines, phosphines, phosphites, imines, heterocycles containing N, O, or S donors, hydrazines, semicarbazones, alcohols, ethers, thiols, thioethers, esters, ketones, carboxamide O, sulfoxide O, sulfoxide S, disulfides, diazines, and aminoacids, and ligands comprising any combination of any two or more of said donor atom containing groups; carboxylates, thiocarboxylates, amidates, dithiocarboxylates, xanthates, carbamates, thiocarbamates, dithiocarbamates, salicyclaldimines, salicyclate esters, salicyclate amides, monoesters or mono amides of oxalylic acid, acetylacetonates, imine derivatives of acetylacetonates, diimine derivatives of acerylacetonates, thioacetylacetonates, dithioacetylacetonates, deprotonated amino acids, hydrogen carbonate, dihydrogen phosphate, hydrogen sulfate, hydrogen carbonate, and nitrate, and ligands comprising any combination of any two or more of said donor atom containing groups; oxalate, thiooxalate, catecholate, dithiolates, dialkoxides, diamides, diamidates, carbonate, hydrogen phosphate, sulfate, and carbonate, and ligands comprising any combination of any two or more of said donor atom containing groups; carboxylates, dicarboxylates, acetylacetonate and derivatives thereof, dithiocarbamate, (thio)semicarbazones, and Schiff bases, and ligands comprising any combination of any two or more of said donor atom containing groups; bisphosphines, bisphosphites, bisamines, bisheterocyclic compounds, bisnitrile, bisimines, dienes such as cyclooctadiene.

Those skilled in the art will appreciate that monodentate and bidentate ligands can for example comprise positively charged groups (for example Me-PTA⁺). Such ligands can be zwitterionic or charged depending on the donor atom(s) and other groups present in the ligand. Additionally, substituents on the monodentate or bidentate ligands or the monodentate or bidentate ligands themselves may impart desirable pharmacological properties such as solubility.

In various embodiments, the complex is a compound of the formula (II):

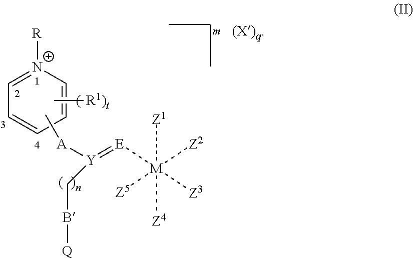

In the compound of formula (II), E at each instance is coordinated to the transition metal. The compound of formula (II) can be a compound of the formula (II-A) or (II-B) as defined herein. More specifically, the compound can be a compound of the formula (II-A1) or (II-B1) as defined herein.

Each Y=E in the complex can, in certain embodiments, be independently selected from C═O or C═S. In exemplary embodiments, each Y=E is C═O.

In exemplary embodiments, the compound is a compound of the formula (II-A2) as defined herein.

The complex may comprise the pH responsive ligand in a protonated form or in the form of a conjugate base of the protonated form. Either form of the complex may be formulated into a composition for use, depending on the nature of the composition. In certain embodiments, it may be desirable to use complex is in the form of a conjugate base of the protonated form.

It will be apparent that the charge of the complex can vary depending on the oxidation state of the transition metal and charge(s), if any, of the pH responsive ligand and other ligands present. In various embodiments, the charge of the complex, m, is −1, 0, 1, 2, 3, 4, 5, or 6.

Where the complex is charged one or more cations (if the complex is anionic) or anions that balance the charge of the complex are present. Such cations and anions may be referred to as countercations or counteranions. Any suitable cation or anion may be used to balance the charge. Examples of suitable anions include but are not limited to halides (for example F⁻, Cl⁻, Br⁻, I⁻), sulfonates (for example tosylate or triflate), bulky anions such as PF₆⁻, and metal complexes (for example anionic metal carbonyl complexes). As described herein, ions that balance the charge of the complex can be exchanged for other ions, which may for example be more physiologically acceptable.

Complexes of the invention may be prepared by reacting a pH responsive ligand with a suitable transition metal precursor. The pH responsive ligand may be reacted in a protonated form or in the form of a conjugate base of the protonated form. The transition metal precursor can be a carbonyl complex of the transition metal that contains at least one carbonyl ligand that is retained on coordination of the pH responsive ligand and one or more other ligands that are displaced on coordination of the pH responsive ligand. The number of ligands displaced depends on the denticity of the pH responsive ligand. The reaction is typically carried out in a suitable liquid carrier, for example one or more organic solvents. Suitable solvents will be apparent to those skilled in the art. Alternatively, complexes of the invention may be prepared by reacting a transition metal complex or salts and a pH responsive ligand to coordinate the pH responsive ligand to the transition metal and then introducing one or more CO ligands to the transition metal complex comprising the pH responsive ligand.

For example, Ru(II) complexes of the present invention can be prepared by reacting tricarbonyldichlororuthenium(II) dimer with a pH responsive ligand in conjugate base form in a suitable organic solvent (for example dichloromethane) in the presence of a base (for example potassium carbonate). The reaction can be carried out at room temperature. Alternatively, Ru(II) complexes of the present invention can be prepared from fac-[RuCl₂(CO)₃(THF)]. The fac-[RuCl₂(CO)₃(THF)] is treated with a silver(I) salt (e.g. AgOTf) in THF to precipitate silver(I) chloride. The resulting complex is then treated with pH responsive ligand in conjugate base form to form the complex of the invention.

In another embodiment, Ru(II) complexes of the present invention can be prepared from [Ru(CO)₂Cl₂]n. [Ru(CO)₂Cl₂]n by treatment with a pH responsive ligand, in conjugate base form, in suitable solvent such as methanol or tetrahydrofuran under reflux to form the corresponding complex of the invention.

In another embodiment, molybdenum complexes of the present invention can be prepared from Mo(CO)₄(piperidine)₂. The reaction may be carried out by treating the Mo(CO)₄(piperidine)₂ with a pH responsive ligand in a solvent such as dichloromethane at ambient temperature.

The pH responsive ligand can be prepared by using known synthetic chemistry techniques (for example, the methods generally described in Louis F Fieser and Mary F, Reagents for Organic Synthesis v. 1-19, Wiley, New York (1967-1999 ed.) or Beilsteins Handbuch der organischen Chemie, 4, Aufl. Ed. Springer-Verlag Berlin, including supplements (also available via the Beilstein online database)). Starting material for the synthetic sequence may be commercially available or may be literature methods or prepared by analogous methods.

Preparation of the pH-responsive ligand may involve the protection and deprotection of various chemical groups. The need for protection and deprotection, and the selection of appropriate protecting groups, can be readily determined by a person skilled in the art. Protecting groups and methods for protection and deprotection are well known in the art (see e.g. T. W. Greene and P. G. M. Wuts, Protective Groups in Organic Synthesis, 3^{rd} Ed., Wiley & Sons, Inc., New York (1999)).

For example, pH responsive ligands useful for preparing compounds of formula (II-A1) can be prepared as shown in (Scheme 3). Briefly, optionally substituted pyridine carboxylic acid (V) is refluxed with thionyl chloride to provide the corresponding acid chloride, which is then treated with optionally substituted 4-amino pyridine (VIII) in dichloromethane to provide the compound of formula (VI). The reaction can be carried out in the presence of a base such as NEt₃. Reaction with RCl in acetonitrile and subsequent deprotonation using KOH provides the desired pH responsive ligand (VII) in conjugate base form. Corresponding pH responsive ligands wherein the pyridinium ring is attached at the 2-position can be prepared by substituting the compound of formula (VIII) with the corresponding 2-amino pyridine.

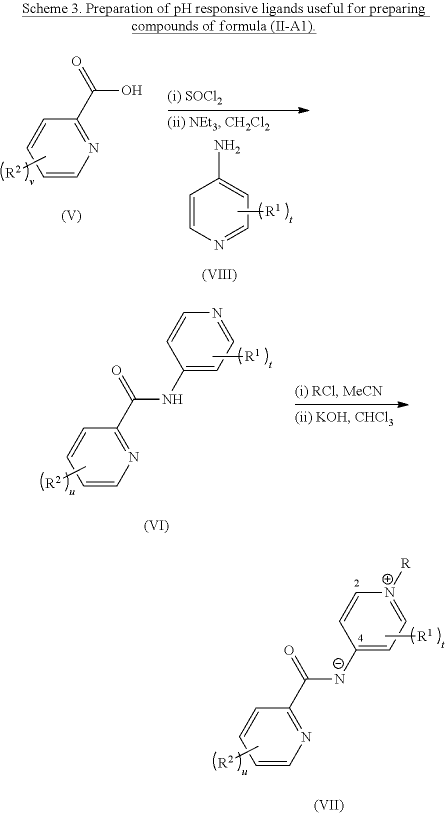

Compounds of formula (VII) wherein the group corresponding to Y=E is C═S, rather than C═O may be prepared by an analogous route from a compound of the formula (VI) wherein the group corresponding to Y=E is C═S. The pyridine carbothiamide is treated with RCl as described above for the compound of formula (VI). Alternatively, the reaction may be carried out in another suitable solvent such as tetrahydrofuran. Deprotonation may be carried out by treatment with for example aqueous sodium bicarbonate or NMe₃. The deprotonation reaction may be carried out in any suitable solvent, for example dichloromethane or tetra hydrofuran.

pH responsive ligands useful for preparing compounds of formula (II-B1) can be prepared analogously as shown in Scheme 4.

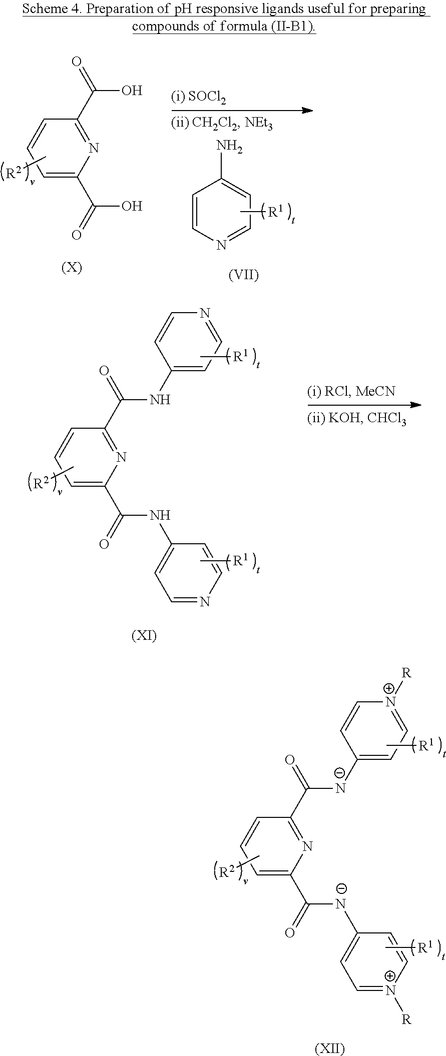

pH responsive ligands of formula (VII) and (XII) wherein E at each instance is S, for example, can be prepared by similar methods, as can the corresponding derivatives wherein the pyridinium rings are attached via the 2-position.

Analogous methods can be used to prepare compounds of formula (I) and (II) wherein Q is -TGG′; T for example is a trisubstituted benzene ring, and n for example at each instance is 0 (Scheme 5). Trisubstituted carboxylic acid (XV) is used as the starting material. Conversion to the compound of formula (XVI) may be carried out as described above with respect to Scheme 3. Alternatively, coupling of the compound of formula (VII) may be carried out by reacting the compounds of formula (XV) and (VII) under amide coupling conditions, for example using HATU or another suitable activating agent. Where R is methyl, methyl triflate may be used as the alkylating agent.

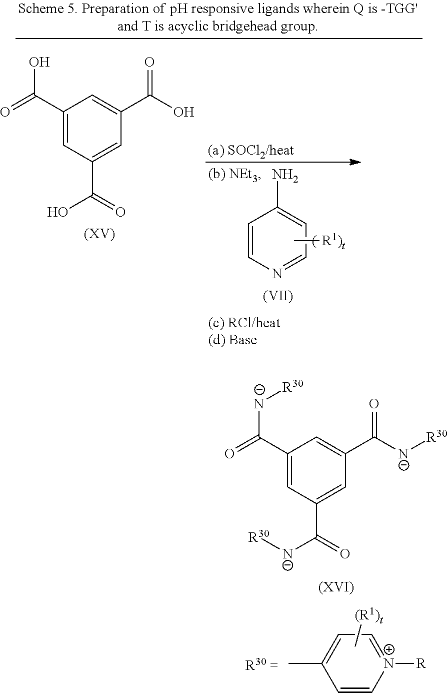

Compounds of formula (I) and (II) wherein Q is -TGG′; T for example is CR′, SiR′, B, or P; and n for example is 1 may be prepared analogously (Scheme 6).

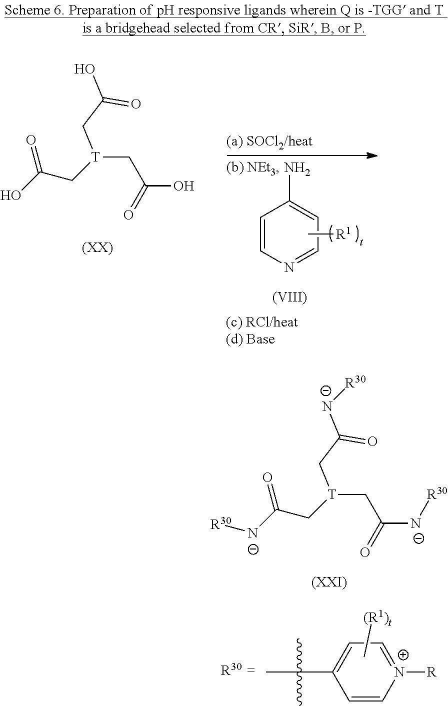

In another aspect, the present invention provides a composition comprising a complex of the present invention, and a carrier, diluent or excipient.

The composition can have an alkaline pH, such that the rate of CO release from the complex is reduced, for example prior to administration. In various embodiments, the composition maintains the complex at an alkaline pH in a subject after administration to the subject, and is formulated to allow the complex to release carbon monoxide (CO) at a site of desired activity in the subject.

In various embodiments, the composition maintains the complex at an alkaline pH upon administration to an organ, tissue, or cell or a composition comprising an organ, tissue or cell, and is formulated to allow the complex to release CO at a site of desired activity in or around the organ, tissue or cell.

In various embodiments, the composition is formulated to modulate the CO at a site of desired activity in a subject, or around an organ, tissue or cell to be treated.

The composition is typically a pharmaceutical composition comprising a pharmaceutically acceptable carrier, diluent or excipient.

In one embodiment an alkaline pH is a pH that is greater than the physiological pH in a mammal, organ, tissue or cell to be treated. In one embodiment an alkaline pH is a pH that is greater than 7.0, 7.1, 7.2, 7.3, 7.4, or 7.5.

In one embodiment the subject is a mammal. The mammal can be a human or a non-human mammal selected from the group consisting of pigs, cows, horses, dogs, cats, primates, and mice. In one embodiment the mammal is a human.

In one embodiment a site of desired activity is a site in a subject, organ or tissue, or is a cell where the desired activity will have a therapeutic effect.

In one embodiment a site in a subject where the desired activity will have a therapeutic effect is a site in the subject that is associated with a disease or condition to be treated.

In one embodiment an organ or tissue where the desired activity will have a therapeutic effect is an organ or tissue that is associated with, or manifests a disease or condition to be treated.

In one embodiment a cell where the desired activity will have a therapeutic effect is a cell associated with or comprised in an organ or tissue that is associated with or manifests a disease or condition to be treated.

In one embodiment the disease or condition to be treated is selected from the group consisting of inflammation, hypertension, abnormal cell proliferation, cell apoptosis, allograft rejection, organ rejection, cardiovascular diseases or conditions, liver failure, tumor growth, myocardial ischemia, myocardial infarction, nephrotoxicity, renal failure, platelet aggregation, reperfusion injury, and microbial infection.

In one embodiment the organ rejection is liver, heart, kidney, or aortic rejection.

In one embodiment the nephrotoxicity is including cisplatin induced nephrotoxicity.

In one embodiment the reperfusion injury is ischemia reperfusion injury.

In one embodiment the ischemia reperfusion injury is selected from the group consisting of renal ischemia reperfusion injury, renal transplant ischemia reperfusion injury, liver ischemia reperfusion injury, liver transplant ischemia reperfusion injury, myocardial ischemia reperfusion injury and heart transplant reperfusion injury.

In one embodiment a microbial infection is a eukaryotic, bacterial, fungal or viral infection. In one embodiment a eukaryotic microbial infection is infection with a protist.

In one embodiment administration to an organ, tissue, or cell comprises administration in situ. In one embodiment administration to an organ, tissue or cell comprises administration in vitro, ex vivo or in vivo.

In one embodiment, release of CO at a site of desired activity around the organ, tissue or cell is release of CO within a composition comprising the organ, tissue or cell.

In one embodiment the composition is a fluid that surrounds or at least partially surrounds the organ, tissue or cell.

In one embodiment, the composition is administered, or is formulated for separate, simultaneous or sequential administration with an additional agent.

In one embodiment, the composition is to be administered orally, topically or parenterally. In one embodiment the composition is formulated for oral, topical or parenteral administration. Preferably the composition is to be administered, or is formulated for administration, by a direct, intravenous, intradermal, subcutaneous, transdermal, topical, transmucosal, oral, or systemic route.

In one embodiment, the composition is formulated as a dosage form. In one embodiment the dosage form comprises a solid, a liquid, a paste, an ointment, a powder including a compressed powder, a gel or a slurry, or may be provided as a bolus injection, or may be comprised within a pill or a patch, a suppository, an implant comprising a porous material, an implant comprising a non-porous material, an implant comprising a gelatinous material or a coated implant.

A composition of the invention can be formulated for therapeutic or prophylactic treatments in various ways as known and disclosed in the art. For example, a complex of the invention can be formulated for administration in a pharmaceutical composition. Pharmaceutical compositions may include, but are not limited to, pharmaceutically acceptable carriers, proteins, small peptides, salts, excipients, thickeners, diluents, buffers, preservatives, surface active agents, neutral or cationic lipids, lipid complexes, liposomes, penetration enhancers, carrier compounds and other pharmaceutically acceptable carriers and the like in addition to the agent. Such compositions and formulations can be used as described herein.

A pharmaceutically acceptable carrier may be liquid or solid and is selected as known in the art, in view of a planned manner of administration. A pharmaceutically acceptable carrier provides for the desired bulk, consistency, etc of a pharmaceutical composition that is to be used or delivered in a particular context.

A pharmaceutically acceptable carrier may include binding agents (e.g., pregelatinized maize starch, polyvinylpyrrolidone (PVP) or hydroxypropyl methylcellulose, and the like, fillers such as lactose or other sugars, microcrystalline cellulose, pectin, gelatin, calcium sulfate, ethyl cellulose, polyacrylates or calcium hydrogen phosphate, etc.); lubricants (e.g., magnesium stearate, talc, silica, colloidal silicon dioxide, stearic acid, metallic stearates, hydrogenated vegetable oils, corn starch, polyethylene glycols, sodium benzoate, sodium acetate, etc.); disintegrates (e.g., starch, sodium starch glycolate, etc.); or wetting agents (e.g., sodium lauryl sulphate, etc.).

Penetration enhancers may be included in pharmaceutical compositions in order to enhance the delivery of the complex of the invention. Examples of penetration enhancers include fatty acids, bile salts, surfactants and non-surfactants, but are not limited thereto. Single penetration enhancers may be used alone or in combination with any other penetration enhancer disclosed herein.

Examples of fatty acids (and derivatives thereof) useful as penetration enhancers include, but are not limited to, oleic acid, lauric acid, capric acid, myristic acid, palmitic acid, stearic acid, linoleic acid, linolenic acid and physiologically acceptable salts thereof.

Likewise, numerous surfactants are well known and disclosed in the art. Examples include, but are not limited to, sodium lauryl sulfate, polyoxyethylene-9-lauryl ether and polyoxyethylene-20-cetyl ether.

Examples of non-surfactants include, but are not limited to, unsaturated cyclic ureas, 1-alkyl- and 1-alkenylazacyclo-alkanone derivatives and non-steroidal anti-inflammatory agents such as diclofenac sodium, indomethacin and phenylbutazone.

The complex of the invention can be formulated in pharmaceutical compositions that contain additional functional or therapeutic components or delivery reagent. Such other components can be considered adjunct components as may be conventionally found in pharmaceutical compositions, at their art-established usage levels. Examples of such components include compatible pharmaceutically-active materials such as local anesthetics or anti-inflammatory agents. Additional materials useful in physically formulating various dosage forms of a pharmaceutical composition may also be included, such as dyes, flavouring agents, preservatives, antioxidants, opacifiers, thickening agents and stabilizers.

In one embodiment, a complex of the invention is formulated with a delivery reagent. A delivery agent may be a molecule, molecular structure or mixture of molecules or compounds that is admixed, used to encapsulate, or otherwise associated with an agent that is used in the methods of the invention. Exemplary delivery reagents include, but are not limited to, enteric coatings for oral dosage forms that protect the complex of the invention from acid conditions in the stomach.

In one embodiment, a delivery agent may be a cell-penetrating peptide as known or used in the art. Peptide vectors have been used to deliver various macromolecules into cells (across plasma membranes), including delivery of proteins and nucleic acids. Exemplary cell-penetrating peptides include, but are not limited to, MPG, a short peptide vector (for example comprising an RGD sequence that interacts with integrins), Penetratin-1, a 16-amino-acid polypeptide derived from the third alpha-helix of the homeodomain of Drosophila antennapedia, biotin, transportan, pVEC, MAP and MTS. In some embodiments, cell-penetrating peptides may be conjugated to liposomes or other delivery agents as described herein, and may be used to aid in the delivery of any complex of the invention as contemplated herein.

Additional delivery agents include, but are not limited to, various targeting ligands as known and used in the art, such as folic acid, polyethylene glycols, carbohydrate clusters, cross-linking agents and the like.

In one embodiment, colloidal dispersion systems may be used as delivery vehicles to enhance the in vivo stability of a complex of the invention. A colloidal dispersion system can also be used to provide a timed and/or transient release of the complex of the invention. Release of a complex of the invention can be by continuous release at a prescribed rate or can be by pulsed release of specified amounts at pre-determined dosage intervals. Such timed and/or transient release is comprehended by the art and will be formulated with particular regard for the complex of the invention to be delivered as is art-understood, in accordance with known and used methods, and as described herein, to provide the desired amounts or to maintain the desired levels of the complex of the invention at a site of desired activity.

Preferably the delivery vehicle targets or maintains the complex of the invention to or at a particular organ, tissue or cell type. Exemplary colloidal dispersion systems include, but are not limited to, microcapsules, nanocapsules, microspheres, bioadhesive microspheres, nanospheres, biodegradable nanospheres, beads, microbeads, gels and hydrogels and lipid-based systems including oil-in-water emulsions, slurries, gels, pastes, micelles, mixed micelles and liposomes.

As known in the art and used herein, the terms microparticles, microspheres, microcapsules and nanoparticles refers to a particle, which is typically a solid, containing the complex of the invention to be delivered. The complex of the invention can be comprised within the core of the particle or may be attached to a polymer that comprises or covers the particle. Microparticles (or microcapsules or microspheres) and nanoparticles generally differ in size. Microparticles typically have a particle size range of about 1 to about 1000 microns. Nanoparticles typically have a particle size range of about 10 to about 1000 nm.

Liposomes in a carrier delivery system can be liposomes comprising a complex of the invention or a plurality of liposomes comprising a plurality of complexes of the invention. Liposomes are microscopic spheres having an aqueous core surrounded by one or more outer layers made up of lipids arranged in a bi-layer configuration. As known in the art, liposomes can be categorized into various types: multilamellar (MLV), stable plurilamellar (SPLV), small unilamellar (SUV) or large unilamellar (LUV) vesicles. Liposomes can be prepared from various lipid compounds, which may be synthetic or naturally occurring, including phosphatidyl ethers and esters, such as phosphotidylserine, phosphotidylcholine, phosphatidyl ethanolamine, phosphatidylinositol, dimyristoylphosphatidylcholine; steroids such as cholesterol; cerebrosides; sphingomyelin; glycerolipids; and other lipids. Suitable liposomes which may be employed to deliver a complex of the invention include, but are not limited to, fusogenic liposomes, immunoliposomes and PEG conjugated liposomes, but not limited thereto.

A composition of the invention, including a pharmaceutical composition of the invention may be administered in a number of ways depending upon whether local or systemic treatment is desired and upon the area to be treated. Administration may be topical (including intranasal, epidermal, and transdermal), oral or parenteral. Parenteral administration includes direct application, systemic, subcutaneous, intraperitoneal or intramuscular injection, intravenous drip or infusion, inhalation, insufflation or intrathecal or intraventricular administration. A composition of the invention, including a pharmaceutical composition of the invention may be delivered by admixing with a composition comprising an organ, tissue or cell to be treated as described herein.

A composition of the invention, including a pharmaceutical composition of the invention may be formulated for parenteral administration in any appropriate solution, including sterile aqueous solutions which may also contain buffers, diluents and other suitable additives.

A composition of the invention, including a pharmaceutical composition of the invention may be formulated for oral administration in powders or granules, aqueous or non-aqueous suspensions or solutions, capsules, pills, lozenges or tablets. Thickeners, flavouring agents, diluents, emulsifiers, dispersing aids or binders may be desirable. It will be appreciated that the oral dosage form protects the complexes of the invention from the highly acidic conditions in the stomach on administration.

A composition of the invention, including a pharmaceutical composition of the invention may be formulated for topical or direct administration in transdermal patches, subdermal implants, ointments, lotions, creams, gels, drops, pastes, suppositories, sprays, liquids and powders. Conventional pharmaceutical carriers, aqueous, powder or oily bases, thickeners and the like may be necessary or desirable.

A person skilled in the art will be able to choose the appropriate mode of administration of a composition of the invention, including a pharmaceutical composition of the invention, as described herein with reference to the literature and as described herein. By way of non-limiting example, systemic application may be useful for the treatment and prevention of certain ischemic diseases or conditions whereas a local application may be useful for the treatment of others, including for the treatment of organs, tissues or cells in vitro, or ex vivo, but not limited thereto.

In one embodiment, the direct application is local application. Local application includes application of a composition of the invention, including a pharmaceutical composition of the invention described herein in combination with a delivery reagent or additional therapeutic agent that serves to retain the agent on or in a particular cell or tissue or within a particular region of the body of a subject.

A complex of the invention may be formulated as bioequivalent compounds, including pharmaceutically acceptable salts and prodrugs. Such formulation encompasses any pharmaceutically acceptable salts, esters, or salts of such esters, or any other compound which, upon administration to an animal including a human, is capable of providing (directly or indirectly) the biologically active metabolite or residue thereof. Pharmaceutically acceptable salts retain the desired biological activity of the parent compound and do not impart undesired toxicological effects thereto.

A complex of the invention can also be formulated as prodrugs or in prodrug form. A prodrug is a therapeutic agent that is prepared in an inactive form that is converted to an active form (i.e., drug) within the body or cells of a subject by the action of endogenous enzymes or other chemicals and/or conditions.

The formulation of compositions of the invention, including pharmaceutical compositions of the invention and their subsequent administration is within the skill of those in the art. A particular and effective dosage regime will be dependent on severity of the disease or condition to be treated and on the responsiveness of the treated subject to the course of treatment. An effective treatment may last from several days to several months, or until an acceptable therapeutic outcome is effected or assured or until an acceptable reduction of the disease or condition is observed. An optimal dosing schedule (s) may be calculated from drug accumulation as measured in the body of a treated subject. It is believed to be within the skill of persons in the art to be able to easily determine optimum and/or suitable dosages, dosage formulations and dosage regimes. Of course, the optimum dosages may vary depending on the potency of a complex of the invention in various applications, but can be estimated from an EC50s found to be effective in suitable cells in vitro and in an appropriate in vivo animal model. In general, dosage can range from 0.001 g to 99 g per kg of body weight, and may be given once or more daily, weekly, or monthly, but not limited thereto.

In one embodiment, the composition of the invention, including a pharmaceutical composition of the invention, further comprises or is formulated with an additional therapeutic agent. The additional therapeutic agent can be any appropriate therapeutic agent used to treat or prevent any symptom, side effect or other consequence of treatment, either as a result of the use of complex, composition or pharmaceutical composition of the invention, or for any other reason related to the desired treatment. In various embodiments, the additional therapeutic agent is active against ischemic disease or conditions.

Where the complex, composition or pharmaceutical composition of the invention is formulated with an additional therapeutic agent, then the dosing of the complex, composition or pharmaceutical composition of the invention and the additional therapeutic agent can be separate, simultaneous or concurrent, as is appropriate. Repetition rates for dosing can be based on measured residence times and concentrations of a given agent in the cells, fluids or tissues of the subject that is being or that is to be treated. Maintenance therapy may be desirable in successfully treated patient in order to prevent the recurrence of the disease or condition, wherein the agent is administered in maintenance doses, ranging from 0.001 g to 99 g per kg of body weight, once or more daily, to once every month.

The CO monoxide releasing complexes of the present invention can provide various beneficial therapeutic effects.

The present invention provides a method of treating a disease or condition modulated by carbon monoxide (CO) or a disease or condition responsive to CO modulation in a subject in need thereof, the method comprising administering to the subject a complex or a composition of the present invention.

The present invention also provides a method of modulating the levels of carbon monoxide in a subject in need thereof, the method comprising administering to the subject a complex or a composition of the present invention that modulates the levels of CO at a site of desired activity in a subject, or in an organ, tissue or cell to be treated.

More specifically, the present invention provides a method of treating disease or condition selected from the group consisting of inflammation, hypertension, abnormal cell proliferation, cell apoptosis, allograft rejection, organ rejection, cardiovascular diseases or conditions, liver failure, tumor growth, myocardial ischemia, myocardial infarction, nephrotoxicity, renal failure, platelet aggregation, reperfusion injury, and microbial infection in a subject in need thereof, the method comprising administering to the subject a complex or composition of the present invention.

The present invention also provides a method of treating allograft rejection in a subject in need thereof, the method comprising administering a complex or composition of the present invention to a cell donor, tissue donor, or organ donor prior to transplantation of a cell, tissue, or organ from the donor to the subject in need thereof.

The present invention also provides a method of preserving a cell, tissue, or organ, the method comprising contacting the cell, tissue, or organ with a complex or composition of the present invention.

The cell, tissue, or organ and cell donor, tissue donor, or organ donor may be human or non-human. Treatment by such methods can, for example, reduce reperfusion injury to viable extracorporeal cells, tissue, and organs and reduce allograft rejection on transplantation of such cells, tissue, or organs.

The composition is typically a pharmaceutical composition. An effective amount of the complex, composition or pharmaceutical composition of the invention is typically administered or used in the above methods.

The skilled worker will appreciate that the various embodiments disclosed herein that are related to the administration of a complex or composition of the invention to a subject, or to the contacting of an organ, tissue or cell with a complex or composition of the invention are also applicable to the methods of the invention.

All such embodiments are specifically contemplated herein as forming part of the methods of the invention.

The present invention also provides use of a complex or composition of the invention in the manufacture of a medicament for the uses recited in the aforementioned methods of the invention.

The present invention also provides a complex or composition of the invention for the uses recited in the aforementioned methods of the invention.

The following non-limiting examples are provided to illustrate the present invention and in no way limit the scope thereof.

### EXAMPLES

### 1. General Details

### 1.1 Reagents

Tricarbonyldichlororuthenium(II) dimer ([Ru(CO)₃Cl₂]₂) was synthesised following the method reported by Gibson, Hsu and Steinmetz (Gibson, D. H.; Hsu, W.; Steinmetz, A. L.; Johnson, B. V. J. Org. Chem. 1981, 208, 89-2).

The THF adduct of [Ru(CO)₃Cl₂]₂, tricarbonyldichlororuthenium-tetrahydrofuran, was synthesised following literature procedures (Johnson, B.; Johnston, R.; Lewis, J. J. Chem. Soc. A: Inorg. Phys. Theoret. 1969, 792-797; and Bruce, M.; Stone, F. J. Chem. Soc. A. 1967, 1238-1241).

N-(Pyridin-4-yl)picolinamide was synthesised as described below according to literature methods (Mishra, A.; Kaushik, N. K.; Verma, A. K.; Gupta, R. Eur. J. Med. Chem. 2008, 43, 2189-2196).

The preparations of the ligand L and [HL]Cl described herein were based on the methods published by Boyd, Zafar and Wright (Boyd, P. D.; Wright, L. J.; Zafar, M. N. Inorg. Chem. 2011, 50, 10522-10524).

The myoglobin used in the assays to detect carbon monoxide release was isolated from equine skeletal muscle and was used as purchased from Sigma Aldrich.

### 1.2 Instruments and Reaction Conditions Used

NMR spectra were measured on a Bruker DRX-400 spectrometer at 25° C. Chemical shifts are reported in ppm. All spectra were recorded in deuterated chloroform (CDCl₃) or deuterated dimethyl sulfoxide (d⁶-DMSO) with ¹H NMR spectra being referenced to the proteo-impurity in d⁶-DMSO (δ=2.50 ppm) or the proteo-impurity in CDCl₃ (δ=7.26 ppm). The ¹³C{¹H} NMR spectra were also referenced to d⁶-DMSO (δ=39.5 ppm) or CDCl₃ (δ=77.2 ppm). Infrared spectra were recorded in the range of 4000 to 380 cm⁻¹ on a Perkin-Elmer Spectrum 400 spectrometer using an ATR accessory or on a Bruker Vertex 70 using an ATR accessory. Elemental analyses of nitrogen, carbon and hydrogen were obtained from the Microanalytical Laboratory at the University of Otago, Dunedin. High resolution mass spectrometry was recorded on a Bruker MicrOTOF-QII instrument coupled with a KD scientific syringe pump using electrospray ionisation. UV-visible spectra were obtained on an Ocean Optics spectrometer running spectra suite software.

Unless stated all reactions were carried out at room temperature under an atmosphere of nitrogen. Solvents used were of analytical grade apart from dichloromethane, diethyl ether and n-hexane which were purified using an LC Technology Solutions SP-1 stand-alone solvent purification system. In addition, methanol was dried over 4 Å molecular sieves and stored in a Schlenk tube under a nitrogen atmosphere prior to use.

### 1.3 Characterisation

Assignments of bands in the IR spectrum were made by considering the relative absorption frequencies in cm-1 to those of similar compounds in the literature where possible.

Assignments of signals in the NMR spectra were made based on chemical shift positions (in ppm) in the ¹H NMR, ¹³C NMR and ³¹P NMR spectra as well as the integral values in the ¹H NMR spectrum. Assignment was also made based on two dimensional ¹H-¹H (COSY) and ¹H-¹³C (HSQC and HMBC) spectra.

### 2. Example 1

This example describes the synthesis of the complex of invention [Ru(CO)₃Cl(L)][Ru(CO)₃Cl₃] (pH-CORM-1).

### 2.1 1-Benzyl-4-(picolinamido)pyridinium chloride ([HL]Cl)

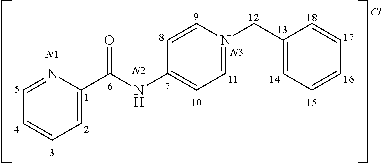

N-(Pyridin-4-yl)picolinamide (1.00 g, 5.00 mmol) was placed in a 100 mL two-necked round bottom flask fitted with a condenser. The flask was evacuated and then an atmosphere of dry nitrogen was re-established in the flask. The flask was charged with acetonitrile (50 mL) resulting in a brown suspension. Benzyl chloride (12.0 mL, 100 mmol, 20 eq.) was added drop-wise over a period of ca. three minutes. The resulting brown solution was heated under reflux for four hours. The light brown solution was then cooled to ambient temperature and most of the acetonitrile was evaporated under reduced pressure to give a concentrated solution (ca. 15 mL). Diethyl ether was added slowly to the solution to facilitate precipitation of a light brown microcrystalline solid. This was collected by filtration and washed with diethyl ether (3×10 mL) to give pure 1-benzyl-4-(picolinamido)pyridinium chloride ([HL]Cl) (1.5 g, 94%).

IR (cm⁻¹): 3388 (br, NH), 1705 (m), 1638 (m), 1575 (m), 1508 (s), 1452 (s), 1327 (s), 1208 (m), 1162 (s), 1096 (m), 1035 (m), 997 (m), 869 (m), 860 (m), 816 (m), 740 (s), 691 (s), 610 (s), 518 (s).

¹H NMR (d₆-DMSO, δ): 12.08 (s, NH), 9.12 (d, 2H, ³J_{HH}=7.4 Hz, H9, 11), 8.81 (m, 1H, H5), 8.55 (d, 2H, ³J_{HH}=7.4 Hz, H8, 10), 8.23 (d, 1H, ³J_{HH}=7.8 Hz, H2), 8.16-8.12 (m, 1H, H3), 7.80-7.77 (m, 1H, H4), 7.54-7.41 (m, 5H, H14-18), 5.77 (s, 2H, H12).

¹³C{¹H} NMR (d₆-DMSO, δ): 164.8 (C6), 152.1 (C7), 148.8 (C5), 148.2 (C1), 145.2 (C9, 11), 138.5 (C3), 134.7 (C13), 129.1, 128.6 (C14-18), 128.3 (C4), 123.6 (C2), 116.4 (C8, 10), 61.6 (C12).

### 2.2 N-(1-Benzylpyridin-4(1H)-ylidene)picolinamide (L)

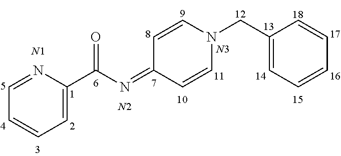

[HL]Cl (200 mg, 0.62 mmol) was suspended in dichloromethane (15 mL) in a clean, dry 50 mL separating funnel. Aqueous potassium hydroxide (15 mL, 1 mol L⁻¹) was added to the suspension and the mixture inverted multiple times. During this procedure the [HL]Cl was deprotonated and extracted into the organic phase. The organic layer was collected. The aqueous layer was extracted three times with dichloromethane (3×15 mL) and the organic portions were combined. The combined organic extract was filtered through a fluted filter paper to remove any residual traces of the aqueous solution. The volume of solvent was lowered under reduced pressure to ca. 15 mL and n-hexane added to facilitate the precipitation of a colourless microcrystalline solid. The solid was collected by filtration, washed with n-hexane and dried in vacuo to give pure N-(1-benzylpyridin-4(1H)-ylidene)picolinamide (L) (163 mg, 91%). The ligand was stored under nitrogen and used directly in subsequent reactions.

IR (cm⁻¹): 2994 (w), 1642 (m), 1574 (m), 1555 (m), 1487 (s), 1449 (m), 1394 (s), 1300 (m), 1243 (m), 1169 (s), 996 (w), 876 (m), 849 (m), 819 (m), 741 (m), 729 (m), 699 (s), 602 (s), 511 (m).

¹H NMR (CDCl₃, δ): 8.74-8.72 (m, 1H, H5), 8.26 (d, 1H, ³J_{HH}=8.0 Hz, H2), 7.79-7.75 (m, 1H, H3), 7.69 (d, 2H, ³J_{HH}=7.6 Hz, H9, 11), 7.56 (d, 2H, ³J_{HH}=7.5 Hz, H8, 10), 7.42-7.41 (m, 3H, Ph), 7.33-7.30 (m, 1H, H4), 7.21-7.19 (m, 2H, Ph), 5.10 (s, 2H, H12).

¹³C{¹H} NMR (CDCl₃, δ): 175.1 (C6), 166.3 (C7), 156.2 (C1), 149.3 (C5), 139.7 (C9, C11), 136.5 (C3), 134.1 (C13), 129.6, 129.5, 127.7 (C14-18), 124.8 (C4), 124.1 (C2), 119.8 (C8, C10), 61.2 (C12).

### 2.3 [Ru(CO)₃Cl(L)][Ru(CO)₃Cl₃] (pH-CORM-1)

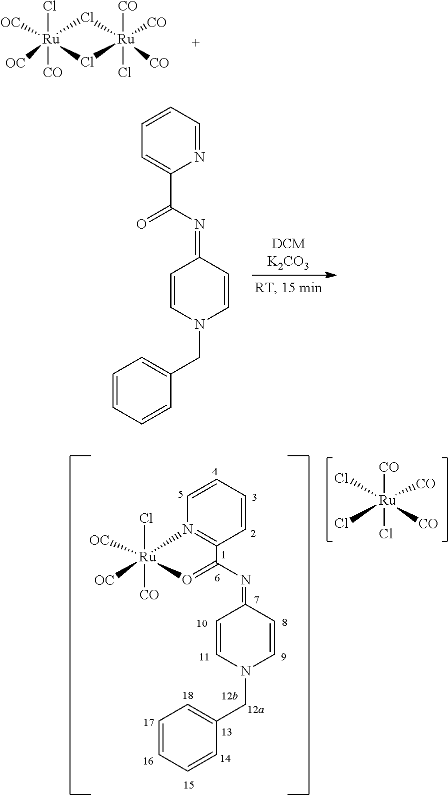

Anhydrous potassium carbonate (1.21 g, 8.79 mmol, 30 eq.) was added to a solution of tricarbonyldichlororuthenium(II) dimer (150 mg, 0.293 mmol) in dichloromethane (20 mL). This suspension was stirred at room temperature for ten minutes after which L (85 mg, 0.293 mmol, 1 eq.) dissolved in dichloromethane (8 mL) was added to the suspension. The suspension was stirred for 15 minutes at room temperature upon which the colour changed from red to bright orange. The solution was filtered over a porosity 4 sinter to remove the potassium carbonate and the resulting orange filtrate taken to dryness in vacuo. The crude material was recrystallised from anhydrous dichloromethane and diethyl ether. The resulting yellow crystals of [Ru(CO)₃Cl(L)]Ru(CO)₃Cl₃ (192 mg, 81%) were collected by filtration and washed with diethyl ether (10 mL).

IR (cm⁻¹): 2125 (s, CO), 2038 (s, CO), 1982 (s, CO), 1651 (m), 1601 (m), 1495 (m), 1329 (s), 1204 (m), 1164 (m), 733 (w), 703 (m), 613 (s), 574 (s), 511 (m), 477 (s).

¹H NMR (CDCl₃, δ): 8.85 (d, 2H, ³J_{HH}=7.0 Hz, H9, 11), 8.66 (d, 1H, ³J_{HH}=5.2 Hz, H5), 8.40 (m, 1H, H2), 8.26-8.24 (m, 2H, H8, H10), 8.23 (d, 1H, ³J_{HH}=1.2 Hz, H3), 7.80-7.77 (m, 1H, H4), 7.50-7.44 (m, 5H, H14-18), 5.81 (d, 1H, ³J_{HH}=14.4 Hz, H12a), 5.70 (d, 1H, ³J_{HH}=14.4 Hz, H12b).

¹³C{¹H} NMR (CDCl₃, δ): 186.9 (CO), 185.4 (CO), 185.2 ((CO)₃), 182.9 (CO), 168.6 (C6), 163.7 (C7), 153.7 (C1), 152.2 (C5), 144.6 (C9, 11), 141.4 (C3), 132.5 (C13), 130.0 (C4), 129.8, 129.4, 129.2 (C14-18), 128.7 (C2), 125.4 (C8, 10), 63.9 (C12).

m/z calculated for [Ru(CO)₃Cl(L)]⁺: 509.9794, found 509.9787.

Anal. calc. for [Ru(CO)₃Cl(L)]⁺[Ru(CO)₃Cl₃]⁻: C, 35.97; H, 1.89; N, 5.25. Found: C, 35.76; H, 2.06; N, 5.28.

Melting point: 126-127° C.

### 3. Example 2

This example describes the synthesis of the complex of the invention [Ru(CO)₃Cl(L)][Cl] from pH-CORM-1.

### 3.1 [Ru(CO)₃Cl(L)][Cl]

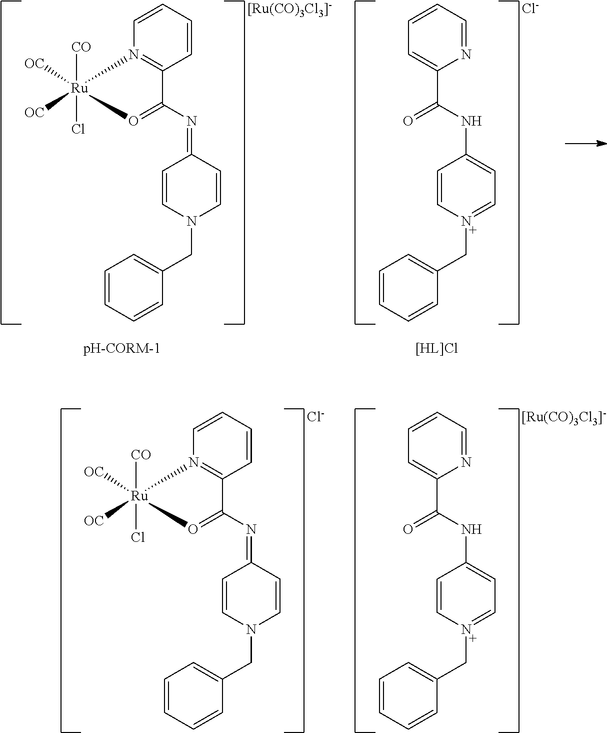

pH-CORM-1 was fully dissolved in toluene and one equivalent of [HL]Cl was added directly to this solution. A pale yellow solid precipitated out of solution. ¹H NMR analysis of the filtrate showed there to be two products. One product corresponded to [HL][Ru(CO)₃Cl₃] and the other corresponded to [Ru(CO)₃Cl(L)]Cl where the H12 (CH₂) signal was split into two doublets (as seen for pH-CORM-1) yet the other signals were slightly shifted to those of pH-CORM-1. The [Ru(CO)₃Cl(L)][Cl] product was not separated.

### 4. Example 3

This example describes the synthesis of the complex of the invention [Ru(CO)₃Cl(L)] [OTf].

### 4.1 [Ru(CO)₃Cl(L)][OTf]

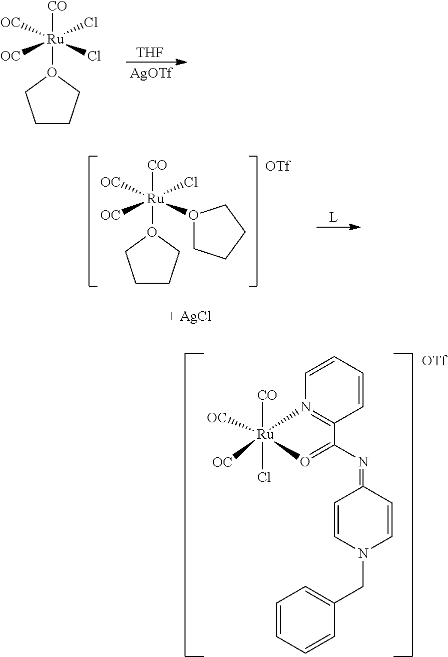

fac-[RuCl₂(CO)₃(THF)] was dissolved in THF and 1.1 equivalents of anhydrous silver triflate were added to the reaction. The solution was left to stir for 5 minutes upon which AgCl precipitated from solution. The precipitate was removed using a small silica column and one equivalent of L was then added directly to the solution. After stirring the reaction at room temperature for 10 minutes the solvent was removed under reduced pressure to give a red solid. ¹H NMR analysis of the product showed that [Ru(CO)₃Cl(L)][OTf] had formed (in mixture with free [HL]⁺). Formation of [Ru(CO)₃Cl(L)][OTf] was evident by the two doublets observed for H12 (CH₂) and shifted signals for the ligand in comparison to L. The [Ru(CO)₃Cl(L)][OTf] product was not separated.

### 5. Example 4

This example describes the synthesis of the ligand [HL][PF₆] and a method that may be used to synthesise the complex of the invention [Ru(CO)₃Cl(L)][PF₆].

### 5.1 1-Benzyl-4-(picolinamido)pyridinium hexafluorophosphate ([HL]PF₆)

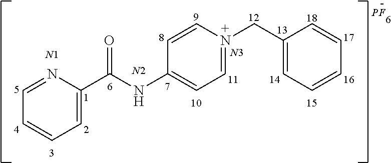

[HL]Cl (0.05 g, 0.154 mmol) was placed in a clean, dry 25 mL round bottom flask and dissolved in methanol (10 mL). Dry ammonium hexafluorophosphate (0.05 g, 0.308 mmol, 2 eq.) was added to this solution and the reaction was stirred at room temperature. A light brown microcystalline solid precipitated out of solution after a few minutes of stirring. The solid was collected by vacuum filtration and dried further in vacuo to give a pure sample of 1-benzyl-4-(picolinamido)pyridinium hexafluorophosphate ([HL]PF₆) (0.078 g, 62%).

IR (cm⁻¹): 1721 (m), 1582 (m), 1640 (m), 1522 (s), 1463 (s), 1435 (m), 1325 (m), 1209 (w), 1096 (w), 828 (vs, PF₆), 737 (m), 692 (s), 556 (s).

¹H NMR (d₆-DMSO, δ): 11.02 (s, NH), 8.98 (d, 2H, ³J_{HH}=7.0 Hz, H9, 11), 8.82 (m, 1H, H5), 8.54 (d, 2H, ³J_{HH}=7.0 Hz, H8, 10), 8.24 (d, 1H, ³J_{HH}=8.0 Hz, H2), 8.14 (m, 1H, H3), 7.80-7.78 (m, 1H, H4), 7.50-7.42 (m, 5H, H14-18), 5.69 (s, 2H, H12).

¹³C{¹H} NMR (d₆-DMSO, δ): 165.3 (C6), 152.7 (C7), 149.3 (C5), 148.6 (C1), 145.6 (C9, 11), 139.0 (C3), 135.1 (C13), 129.7, 129.7, 129.0 (C14-18), 128.8 (C4), 124.1 (C2), 117.0 (C8, 10), 62.3 (C12).

³¹P{¹H} NMR (d₆-DMSO, δ): −144.2 (sept, ³J_{PF}=707.0 Hz, PF₆)

Anal. calc. for [C₁₈H₁₆N₃O][PF₆]·0.5H₂O: C, 48.30; H, 3.88; N, 9.66. Found: C, 48.64; H, 3.86; N, 9.46. ¹H NMR data shows the presence of ca. 0.5 mole equivalents of water of solvation.

Melting point: 202-203° C.

### 5.2 [Ru(CO)₃Cl(L)][PF₆]

[Ru(CO)₃Cl(L)][PF₆] may be formed by adding [HL]PF₆ to a solution of pH-CORM-1 in toluene. The resulting [Ru(CO)₃Cl(L)][PF₆] containing precipitate may then be recovered by filtration and subsequently purified.

### 6. Example 5

This example describes the synthesis of the ligand BnL′ and a method that may be used to synthesise a complex of the invention comprising the ligand BnL′.

### 6.1 N,N′-bis(2-pyridinyl)-2,6-pyridinecarboxamide (H₂L′)

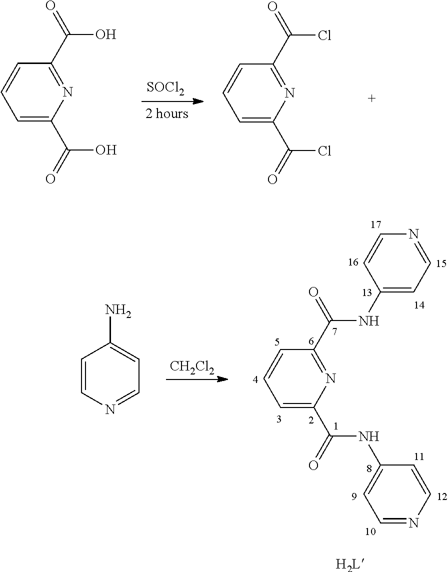

1.64 g (9.8 mmol) of dipicolinic acid was refluxed in 20 mL of thionyl chloride for 5 hours. After cooling down the mixture to room temperature, the excess thionyl chloride was removed under reduced pressure and collected in a secondary trap in a dryice/acetone bath. The white solid formed (2,6-pyridinedicarbonyl dichloride) was then placed under vacuum to dry. 4.613 g (49.02 mmol, 5 equivalent) of 4-aminopyridine was placed into a 250 mL 3-neck round bottom flask. The round bottom flask was fitted with a 50 mL pressure equalizing dropping funnel. The dried white solid 2,6-pyridinedicarbonyl dichloride was dissolved in dichloromethane (ca. 40 mL) then added to the pressure equalizing dropping funnel. 40 mL of dry dichloromethane was added to the 3-neck flask and 6.83 mL (49.0 mmol, 5 equivalent) of triethylamine was also added. The contents of the dropping funnel were then slowly added dropwise to the flask. The mixture was then stirred for 18 hours at ambient temperature. Ethanol (40 mL) was added before concentrating the mixture under reduced pressure to form a white precipitate. The precipitate was filtered to obtain the crude product (4.19 g). The crude product was recrystallized using DMSO/ethanol to yield a pure N,N′-bis(2-pyridinyl)-2,6-pyridinecarboxamide (H₂L′) (1.73 g 55% yield).

¹H NMR (DMSO, δ): 11.25 (s, 2H, N—H), 8.59 (d, 4H, J_{HH}=4.9 Hz, H10, H12, H15, H17), 8.45 (d, 2H, J_{HH}=7.7 Hz, H3, H5), 8.35 (t, 1H, H4), 7.97 (d, 4H, J_{HH}=4.8 Hz, H9, H11, H14, H16).

### 6.2 Benzylation of N,N′-bis(2-pyridinyl)-2,6-pyridinecarboxamide to form BnH₂L′

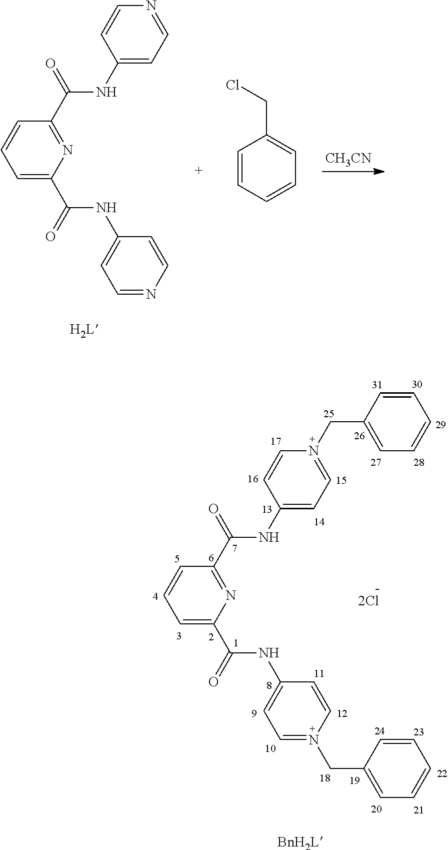

H₂L′ (1.00 g, 3.12 mmol) was dissolved in acetonitrile in a 100 mL 2 neck round bottom flask. To this solution, 23.4 mL (0.20 mol) of benzylchloride was added and the mixture was then heated under reflux for 3 hours. After cooling to room temperature, the solvent was removed under reduced pressure to leave only approximately one-third of the initial volume. To this concentrated solution, diethyl ether was slowly added to yield a white precipitate of pure BnH₂L′ ligand 4,4′-((pyridine-2,6-dicarbonyl)bis(azanediyl))bis(1-benzylpyridin-1-ium) (1.55 g, 86% yield).

¹H NMR (DMSO, δ): 13.08 (s, 2H, N—H), 9.04 (d, 4H, ³J_{HH}=7.23 Hz, H10, H12, H15, H17), 8.92 (d, 4H, J_{HH}=7.4 Hz, H9, H11, H14, H16), 8.51 (d, 2H, ³J_{HH}=7.60 Hz, H3, H5), 8.39 (t, 1H, H4), 7.48-7.43 (m, 10H, H20-H24, H27-H31), 5.73 (s, 4H, H18, H25).

¹³C{¹H} NMR (DMSO, δ): 164.2 (C1, 7), 152.4 (C8, 13), 147.9 (C2, 6), 145.1 (C10, 12, 15, 17), 140.4 (C4), 134.7 (C19, 26), 129.2, 129.1, 128.5 (C20-24, C27-31), 127.7 (C3, 5), 116.9 (C9, 11, 14, 16), 61.7 (C18, 25).

### 6.3 Deprotonation of BnH₂L′

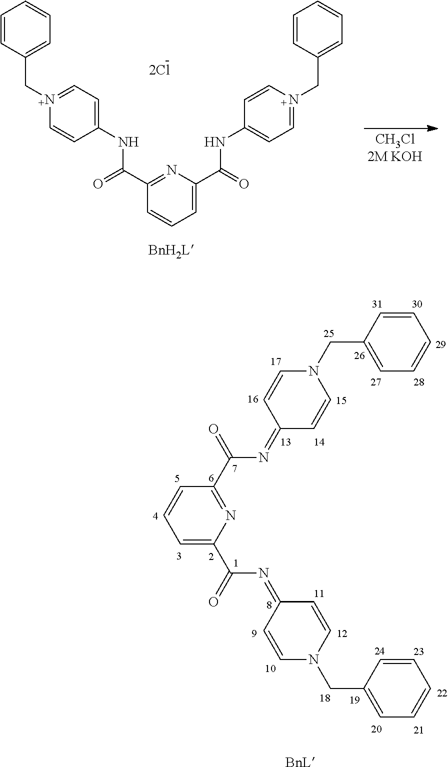

BnH₂L (500 mg) was suspended in CHCl₃ (20 mL) in a separating funnel and 2M KOH (20 mL) was added to the suspension. The mixture was then shaken. The aqueous layer was removed and the organic layer was washed at least 3 times with water. The organic layer was removed, anhydrous Na₂SO₄ was added to the CHCl₃ and the mixture then filtered. The volume of the CHCl₃ was then reduced to approximately 20 mL under vacuum and n-hexane was added to form a precipitate which was collected by filtration and dried under vacuum to obtain pure BnL′ 2,6-bis(1-benzylpyridin-4(1H)-ylidene)pyridine-2,6-dicarboxamide (370 mg, 80% yield).

¹H NMR (DMSO, δ): 8.16 (d, 4H, J_{HH}=7.4 Hz, H10, H12, H15, H17), 8.12 (d, 2H, ³J_{HH}=7.60 Hz, H3, H5), 7.85 (t, 1H, H4), 7.47 (d, 4H, ³J_{HH}=7.4 Hz, H9, H11, H14, H16), 7.43-7.35 (m, 10H, H20-H24, H27-H31), 5.31 (s, 4H, H18, H25).

¹³C{¹H} NMR (DMSO, 6): 173.6 (C1, 7), 164.6 (C8, 13), 156.1 (C2, 6), 141.4 (C10, 12, 15, 17), 136.3 (C4), 128.5 (C19, 26), 129.0, 129.1, 127.8 (C20-24, C27-31), 124.3 (C3, 5), 118.1 (C9, 11, 14, 16), 59.4 (C18, 25).

### 6.4 Complex formation with BnL′

A Ru carbonyl BnL′ complex may be prepared by following a method analagous to that described above for the preparation of pH-CORM-1.

Anhydrous potassium carbonate (1.21 g, 8.79 mmol, 30 eq.) is added to a solution of tricarbonyldichlororuthenium(II) dimer (150 mg, 0.293 mmol) in dichloromethane (20 mL). This suspension is stirred at room temperature for ten minutes after which BnL′ (1 eq.) dissolved in dichloromethane (8 mL) is added to the suspension. The suspension is stirred for 15 minutes at room temperature. The solution is filtered over a porosity 4 sintered glass filter to remove the potassium carbonate and the resulting filtrate is taken to dryness in vacuo to provide a Ru carbonyl BnL′ complex.

### 7. Example 6

This example describes the synthesis of the ligand L″ and the synthesis of the complex of the invention [Ru(CO)₃Cl(L″)][Ru(CO)₃Cl₃].

### 7.1 1-Benzyl-4-(pyridine-2-thiocarboxamido)pyridin-1-ium chloride ([HL″][Cl])

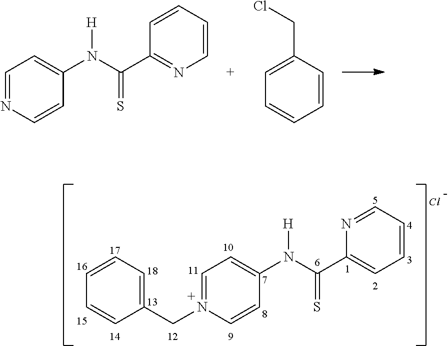

### Procedure A

N-(pyridine-4-yl)pyridine-2-carbothioamide (PYCTA) (120 mg, 0.558 mmol) was dissolved in acetonitrile (20 mL). To the solution, benzyl chloride (2 mL) was added and the mixture was refluxed for 3 hours. The solution was then cooled to room temperature and concentrated under reduced pressure. Diethyl ether was added and the solid formed was collected by filtration and washed with dichloromethane to yield pure 1-benzyl-4-(pyridine-2-carbothioamido)pyridin-1-ium chloride (HL″Cl).

¹H NMR (DMSO, δ): 13.13 (s, N—H), 9.13 (d, J_{HH}=7.4 Hz H9, H11), 8.94 (d, ³J_{HH}=7.4 Hz H8, H10), 8.76-8.74 (m, 1H, H2), 8.47 (d, 1H, J_{HH}=8.0 Hz, H5), 8.11 (t, 1H, H3), 7.78-7.75 (m, 1H, H4), 7.54-7.43 (m, 5H, H14-H18), 5.77 (s, 2H, H12).

### Procedure B

N-(pyridine-4-yl)pyridine-2-carbothioamide (PYCTA) (120 mg, 0.558 mmol) was dissolved in tetrahydrofuran (20 mL). To the solution, benzyl chloride (2 mL) was added and the mixture was refluxed for 3 hours. The solution was then cooled to room temperature and concentrated under reduced pressure. The solid formed was collected by filtration and washed with tetrahydrofuran to yield pure 1-benzyl-4-(pyridine-2-carbothioamido)pyridin-1-ium chloride (HL″Cl).

¹H NMR (CDCl₃, δ): 12.86 (bs, N—H), 9.41 (d, ³J_{HH}=6.5 Hz H9, H11), 8.96 (d, J_{HH}=7.3 Hz H8, H10), 8.59 (d, 1H, J_{HH}=2.2 Hz, H5), 8.44 (d, 1H, J_{HH}=8.0 Hz, H2), 7.84 (t, 1H, H3), 7.52-7.49 (m, 1H, H4), 7.33-7.28 (m, 5H, H14-H18), 6.14 (s, 2H, H12).

¹³C{¹H} NMR (CDCl₃, δ): 192.7 (C6), 151.5 (C7), 150.8 (C1), 147.2 (C5), 145.8 (C9, 11), 138.0 (C3), 133.6 (C13), 129.8, 129.6, 129.5 (C14-18), 127.5 (C4), 124.8 (C2), 117.3 (C8, 10), 63.2 (C12).

m/z calculated for [C₁₈H₁₆N₃S]⁺: 306.1064, found 306.1061.

### 7.2 Deprotonation of [HL″][Cl] to form N-(1-benzylpyridin-4(1H)-ylidene)pyridine-2-carbothioamide (L″)

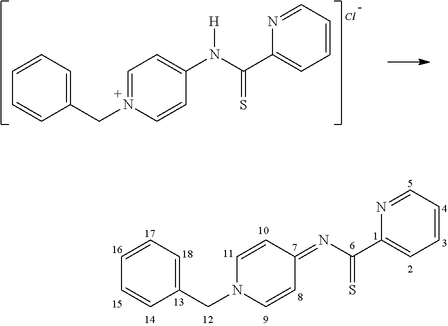

### Procedure A

In a separating funnel, 100 mg of 1-benzyl-4-(pyridine-2-thiocarboamido)pyridinium chloride was suspended in 15 mL of dichloromethane. To the suspension, 15 ml of 0.1 M of Na₂CO₃ was added. The mixture was shaken vigorously and the aqueous layer was extracted at least 3 times with dichloromethane. The dichloromethane extracts were then dried using anhydrous Na₂SO₄ and filtered into a round bottom flask. The solvent was removed under reduced pressure to yield L″ as an orange solid.

¹H NMR (DMSO, δ): 8.52 (d, 2H, H9, H11), 8.47-8.45 (m, 1H, H5), 8.04 (d, 1H, H2), 7.73 (t, 1H, H3), 7.45 (d, 2H, H8, H10), 7.44-7.41 (m, 5H, H14-H18), 7.32-7.28 (m, 1H, H4), 5.50 (s, 2H, H12).

### Procedure B

In a round bottom flask, 1-benzyl-4-(pyridine-2-thiocarboamido)pyridinium chloride (100 mg, 0.29 mmol) was stirred in 15 mL of tetrahydrofuran. To the suspension, trimethylamine (0.4 mL, 2.92 mmol, 10 eq.) was added. The solid began to dissolve once the base was added. The solution was then stirred at room temperature for approximately 15 minutes during which time precipitation was observed to occur. The precipitated trimethylamine hydrochloride was removed by filtration and the solvent was removed under reduced pressure to yield L″ as an orange solid.

¹H NMR (CDCl₃, δ): 8.64-8.62 (d, 1H, H5), 8.52 (d, 1H, J_{HH}=7.92 Hz, H2), 7.95 (d, J_{HH}=7.3 Hz H9, H11), 7.73 (t, 1H, H3), 7.72 (d, ³J_{HH}=7.3 Hz H8, H10), 7.43-7.23 (m, 6H, H4, H14-H18), 5.29 (s, 2H, H12).

¹³C{¹H} NMR (CDCl₃, δ): 197.2 (C6), 167.2 (C7), 159.8 (C1), 150.9 (C5), 141.1 (C9, 11), 136.3 (C3), 133.1 (C13), 129.9, 129.8, 128.3 (C14-18), 124.9 (C2), 124.1 (C4), 120.3 (C8, 10), 62.2 (C12).

### 7.3 [Ru(CO)₃Cl(L″)][Ru(CO)₃Cl₃]

[Ru(CO)₃Cl(L″)][Ru(CO)₃Cl₃] was prepared by following a method analogous that described above for the preparation of pH-CORM-1.

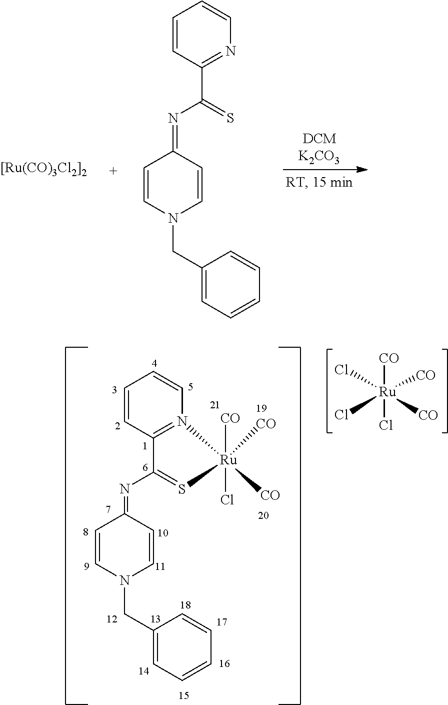

Anhydrous potassium carbonate (1.21 g, 8.79 mmol, 30 eq.) was added to a solution of tricarbonyldichlororuthenium(II) dimer (150 mg, 0.293 mmol) in dichloromethane (20 mL). This suspension was stirred at room temperature for ten minutes after which L″ (1 eq.) dissolved in dichloromethane (8 mL) was added to the suspension. The suspension was stirred for 15 minutes at room temperature.

The solution was filtered over a porosity 4 sintered glass filter to remove the potassium carbonate and the resulting filtrate was taken to dryness in vacuo to provide [Ru(CO)₃Cl(L″)][Ru(CO)₃Cl₃].

¹H NMR (CDCl₃, δ): 8.94 (d, 2H, ³J_{HH}=7.0 Hz, H9, 11), 8.72 (d, 1H, ³J_{HH}=6.4 Hz, H5), 8.45 (d, 1H, ³J_{HH}=9.0, H2), 8.18 (t, 1H, ³J_{HH}=1.2 Hz, H3), 7.69-7.66 (m, 1H, H4), 7.58 (d, 2H, ³J_{HH}=7.0, H8, H10), 7.53-7.43 (m, 5H, H14-18), 5.96 (d, 1H, ³J_{HH}=14.5 Hz, H12a), 5.91 (d, 1H, ³J_{HH}=14.7 Hz, H12b).

¹³C{¹H} NMR (CDCl₃, δ): 187.1 (CO), 185.4 ((CO)₃), 184.9 (CO), 183.6 (CO), 175.9 (C6), 164.5 (C7), 157.8 (C1), 154.6 (C5), 145.5 (C9, 11), 140.7 (C3), 133.1 (C13), 129.9, 129.8, 129.7 (C14-18), 128.9 (C4), 126.9 (C2), 120.1 (C8, 10), 63.9 (C12).

### 8. Example 7

The CO-releasing properties of pH-CORM-1 and 1 and 2, as controls, were analysed using a myoglobin assay as described below.

To examine the effect of pH on the rate of CO liberation from these complexes, myoglobin-binding experiments were conducted at different pH values (6.4, 6.8 and 7.4). The experiments were also conducted at different temperatures (20 and 37° C.) to determine the effect of temperature on CO release.

All experiments were conducted in triplicate and the data was analysed for each experiment individually using Sigma Plot (version 12.5) with the reproducibility being satisfactory.

### 8.1 Synthesis of Controls 1 and 2

[HL][Ru(CO)₃Cl₃] (1)

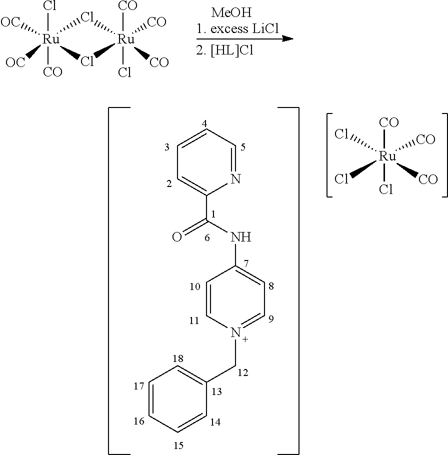

[Ru(CO)₃Cl₂]₂ (0.100 g, 0.195 mmol) was placed in a clean, dry 25 mL two-neck round-bottom flask under nitrogen. Anhydrous methanol (7 mL) was added to fully dissolve the [Ru(CO)₃Cl₂]₂. Dry lithium chloride (0.049 g, 1.17 mmol, 6 eq.) was added to the solution and the resulting yellow solution stirred at room temperature for 22 hours. After this time [HL]Cl (0.127 g, 0.391 mmol, 2 eq.) was added to the solution upon which a fine, light brown compound precipitated out of solution. The solid was collected by vacuum filtration, washed with methanol (3×5 mL) and dried further in vacuo to give a pure sample of [HL][Ru(CO)₃Cl₃] (1) (0.133 g, 59%).

IR (cm⁻¹): 3384 (br, NH), 2126 (s, CO), 2063 (sh, CO), 2048 (sh, CO), 2038 (s, CO), 1710 (m), 1635 (m), 1578 (m), 1521 (s), 1456 (m), 1434 (m), 1319 (w), 1203 (m), 1161 (m), 998 (m), 818 (m), 694 (s), 460 (s).

¹H NMR (CDCl₃, δ): 11.04 (s, NH), 8.92 (d, 2H, ³J_{HH}=7.4 Hz, H9, 11), 8.71 (d, 1H, J_{HH}=4.6 Hz, H5), 8.48 (d, 2H, ³J_{HH}=7.4 Hz, H8, 10), 8.24 (d, 1H, ³J_{HH}=8.0 Hz, H2), 7.99-7.94 (m, 1H, H3), 7.63-7.58 (m, 1H, H4), 7.51-7.42 (m, 5H, H14-18), 5.85 (s, 1H, H12).

¹³C{¹H} NMR (CDCl₃, δ): 185.4 ((CO)₃), 163.6 (C6), 151.2 (C7), 148.8 (C5), 147.4 (C1), 145.7 (C9, 11), 138.2 (C3), 133.0 (C13), 130.1, 129.8, 129.5 (C14-18), 128.3 (C4), 123.3 (C2), 116.9 (C8, 10), 63.9 (C12).

m/z calculated for [Ru(CO)₃Cl₃]: 290.7956, found 290.7947 (negative ion mode).

m/z calculated for [C₁₈H₁₆N₃O]⁺ 290.1293, found 290.1291 (positive ion mode).

Anal. calc. for [Ru(CO)₃Cl₃]⁻[C₁₈H₁₅N₃O]⁺.H₂O: C, 42.05; H, 3.02; N, 7.01. Found: C, 42.02; H, 2.85; N, 7.02. ¹H NMR shows the presence of ca. 1 mole equivalent of water of solvation.

Melting point: 178-179° C.

[Et₄N][Ru(CO)₃Cl₃] (2)

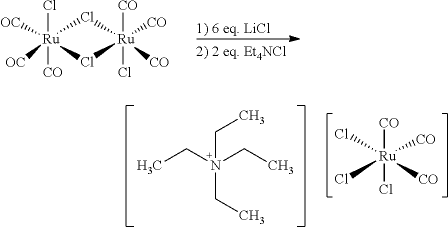

[Ru(CO)₃Cl₂]₂ (0.150 g, 0.293 mmol) was placed in a clean, dry 25 mL two-neck round-bottom flask under nitrogen. Anhydrous methanol (10 mL) was added to fully dissolve the [Ru(CO)₃Cl₂]₂. Dry lithium chloride (0.075 g, 1.17 mmol, 6 eq.) was added to the solution and the resulting yellow solution was stirred at room temperature for 22 hours. After this time tetraethylammonium chloride (0.097 g, 0.586 mmol, 2 eq.) was added to the solution upon which a pale yellow microcrystalline solid precipitated out of solution over ca. five minutes. The solid was collected by vacuum filtration, washed with methanol (3×5 mL) and dried further in vacuo to give a pure sample of [Et₄N][Ru(CO)₃Cl₃] (2) (0.199 g, 87%).

IR (cm⁻¹): 2118 (s, CO), 2031 (s, CO), 1631.76 (m), 1437 (m), 1173 (m), 994 (s), 784 (m), 612 (m), 580 (s), 475 (s).

¹H NMR (CDCl₃, δ): 3.37 (q, 8H, ³J_{HH}=7.3 Hz, CH₂), 1.38-1.35 (m, 12H, CH₃).

¹³C{¹H} NMR (CDCl₃, δ): 185.4 (CO), 53.0 (CH₂), 7.9 (CH₃).

m/z calculated for [Ru(CO)₃Cl₃]⁻: 290.7956, found 290.7956 (negative ion mode).

m/z calculated for [C₈H₂N]⁺: 130.1596, found 130.1595 (positive ion mode).

Anal. calc. for [Ru(CO)₃Cl₃][C₈H₂₀N].0.7CDCl₃: C, 27.73; H, 4.57; N, 2.94. Found: C, 27.85; H, 4.28; N, 2.78. Elemental analysis indicated 0.7 mole equivalents of CDCl₃.

Melting point: 150-151° C.

### 8.2 Myoglobin Assay

### Preparation of Buffer Solutions

A standard literature procedure was followed to make 0.04 mol L⁻¹ phosphate buffer solutions at pH 6.4, 6.8 and 7.4 (Common Stock Solutions, Buffers and Media. Current Protocols in Cell Biology. John Wiley and Sons, 1998).

A solution of NaH₂PO₄.2H₂O (1.25 g, 200 mL, 0.040 M) was added drop-wise to a solution of Na₂HPO₄.2H₂O (1.42 g, 200 mL, 0.040 M) until the desired pH was reached. The pH of each solution was measured with a Mettler Toledo SevenCompact pH meter fitted with a Mettler Toledo InLab Expert Pro pH electrode. The pH meter was calibrated with standard buffer solutions at pH 4.01, 7.00 and 9.21. Each pH measurement was conducted at the same temperature as required for the myoglobin assay. The buffer solutions needed for assays conducted at 37° C. was kept in a water bath at 37° C. for the duration of the experiment to maintain the temperature.

### Assay

The release of CO from complexes pH-CORM-1, 1 and 2 was assessed spectrophotometrically, based on standard literature procedures (Motterlini, R.; Clark, J. E.; Foresti, R.; Sarathchandra, P.; Mann, B. E.; Green, C. J. Circ. Res. 2002, 90, 17-24; and Peng, P.; Wang, C.; Shi, Z.; Johns, V. K.; Ma, L.; Oyer, J.; Copik, A.; Igarashi, R.; Liao, Y. Org. Biomol. Chem. 2013, 11, 6671-6674), by measuring the conversion of deoxy-myoglobin (deoxy-Mb) to carbonmonoxy-myoglobin (MbCO).

Myoglobin solutions (50 μM) were freshly prepared prior to each measurement by dissolving the protein (1.76 mg, 50 μmol) in 40 mM phosphate buffer (2000 μL) at pH 6.4, 6.8 or 7.4 and at 20° C. or 37° C. The solution was deoxygenated by bubbling nitrogen through the solution. While still bubbling with nitrogen gas, sodium dithionite (4 μL, 20 mM) was added from a 1M stock solution to convert the myoglobin to deoxy-Mb. The reduced myoglobin solution (2000 μL) was placed into a screw-cap quartz cuvette (path length 1.0 cm) containing a 5 mm Teflon magnetic stirrer bar. The cuvette was sealed with a Teflon cap fitted with a septum and bubbled with nitrogen for 60 seconds using one needle to deliver the nitrogen and another one for nitrogen to exit to ensure the solution was sealed under an atmosphere of nitrogen. 10 μL of an 8 mM solution of either pH-CORM-1, 1 or 2 in DMSO were injected into the cuvette containing the deoxy-myoglobin solution under nitrogen to give a final CORM concentration of 40 μM in solution. The solutions were stirred at a constant rate for the duration of the experiment.

The UV-visible spectra were obtained on a diode array UV-visible spectrometer. This consisted of an Ocean Optics LS-1 tungsten halogen lamp, connected with fibre optics to a cuvette holder, which was in turn connected to a USB2000-VIS-NIR detector operating between 350 and 100 nm. The spectrometer was fitted with a Quantum Northwest TC125 temperature control unit which kept the cuvette at the desired temperature for the duration of the experiment. Stirring was also controlled via this unit. OOIbase32 software version 2.0.6.2 (Ocean Optics) was used to obtain the data from 189 nm to 896 nm. The experimental parameters were set up to run 10 scans to average and spectra were recorded every 1 second for the assays conducted at 37° C. and every 10 seconds for the assays conducted at 20° C. A box car width of 5 was applied to assays conducted at 20° C. while a box car width of 3 was applied to assays conducted at 37° C. The UV-visible experiments were conducted in triplicate for each condition.

A baseline measurement of carbonmonoxy-myoglobin was obtained at pH 6.4, 6.8 and 7.4 and 20° C. by bubbling carbon monoxide gas through a solution of deoxy-myoglobin for two minutes.

### 8.3 Results

The CO releasing properties of pH-CORM-1 were first investigated at 20° C. Addition of pH-CORM-1 to a solution of deoxy-Mb in pH 6.4 phosphate buffer resulted in deoxy-Mb being rapidly converted to MbCO. This was indicated by the change in the spectra from that of deoxy-Mb to that typical of MbCO. Four isosbestic points were observed at 515, 550, 570 and 585 indicating that the deoxy-Mb is fully converted to MbCO in the reaction. These isosbestic points observed in the reaction are in line with those reported in the literature (Schatzschneider, U. Inorg. Chim. Acta. 2011, 374, 19-23) and were observed for all experiments. The approximate time for complete carbonylation under these conditions was 5 minutes. The formation of MbCO indicates that pH-CORM-1 releases CO in solution under these conditions. The absorption maxima at 540, 555 and 576 nm can be traced over time to calculate the rate of CO transfer from pH-CORM-1 to deoxy-Mb. During the course of the reaction the absorption maximum of deoxy-Mb at 555 nm decreased while the absorption maxima of MbCO at 540 and 577 nm increased indicating that MbCO was being formed.

When the same reaction was carried out at pH 6.8, the same results were found with MbCO being formed in solution over time. The rate at which deoxy-Mb was fully converted into MbCO, however, was slower at this pH with the approximate time for complete carbonylation being 7 minutes.

The myoglobin assay was then carried out at pH 7.4, which is considered normal physiological pH. Upon addition of pH-CORM-1 to a solution of deoxy-Mb in pH 7.4 phosphate buffer, the UV-visible spectrum changed to that of MbCO, consistent with the experiments conducted at pH 6.4 and 6.8. The release of CO from pH-CORM-1 at pH 7.4, however, was slower in comparison to pH 6.4 and 6.8 with complete carbonylation taking 10 minutes.

The results from these individual experiments show that the process of CO release is independent of the pH value with respect to the species formed (MbCO) and that the pH value only affects the rate of CO release from pH-CORM-1 to deoxy-Mb. The rates of CO release from pH-CORM-1 at 20° C. increases with decreasing pH.

Given that all of the experiments formed the same product (MbCO), the data for the absorbance at 540 nm was normalised for pH 6.4, 6.8 and 7.4 so that the reaction rates could be compared (FIG. 1). As evident from FIG. 1, the release of CO was slower at pH 7.4 in comparison to pH 6.8 and in turn 6.4.

The CO releasing properties of pH-CORM-1 were also tested at 37° C., which is the average body temperature of humans, to assess the rate of CO release from pH-CORM-1 depending on pH. In all conditions, the average rate of CO release was much faster at 37° C. in comparison to the assays conducted at 20° C.

Upon addition of pH-CORM-1 to a solution of myoglobin at pH 6.4 and 37° C., deoxy-Mb was rapidly converted to MbCO as seen for all experiments conducted at 20° C., forming the same isosbestic points seen previously. However, the rate of CO transfer from pH-CORM-1 to deoxy-Mb was much faster than at 20° C. with the reaction going to completion in approximately 20 seconds.

Addition of pH-CORM-1 to a solution of deoxy-Mb at pH 6.8 also resulted in the rapid conversion of deoxy-Mb to MbCO, as was observed at pH 6.4. The time for complete carbonylation was approximately 30 seconds and therefore slower than at pH 6.4 (20 seconds).

The CO-releasing properties of pH-CORM-1 were finally tested at pH 7.4 and 37° C. Upon addition of pH-CORM-1 to a solution of deoxy-Mb at pH 7.4, deoxy-Mb was completely converted to MbCO over a period of 60 seconds.

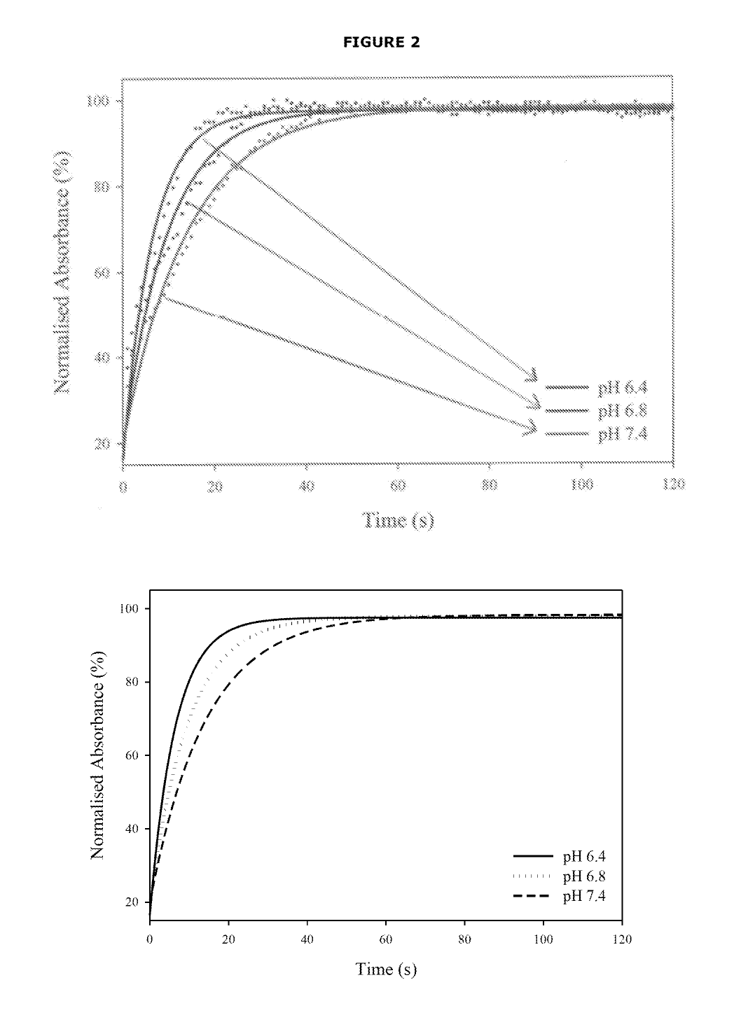

Like the assays conducted at 20° C., the data for the absorbance at 540 nm was normalised for pH 6.4, 6.8 and 7.4 so that their rates could be compared (FIG. 2). The release of CO from pH-CORM-1 was also pH dependent at 37° C. In the same way as observed for 20° C., the release of CO was slower at pH 7.4 in comparison to pH 6.8 and in turn 6.4 although the rate of CO release at each pH was faster in comparison to the rate at 20° C.

Overall, the CO-releasing studies of pH-CORM-1 show that the complex has the ability to release CO in solution at various pH values and temperatures. The formation of MbCO is independent of pH and temperature. However, the rate of CO release from pH-CORM-1 is temperature and pH dependent, i.e., the higher the temperature and the lower the pH, the quicker the CO release.

Compound 1 was used as a control for the pH dependent CO releasing studies of pH-CORM-1. In 1, the PYA ligand is present in the protonated form ([HL]⁺) and is not coordinated to the ruthenium centre but rather counterbalances the charge of [Ru(CO)₃Cl₃]⁻.

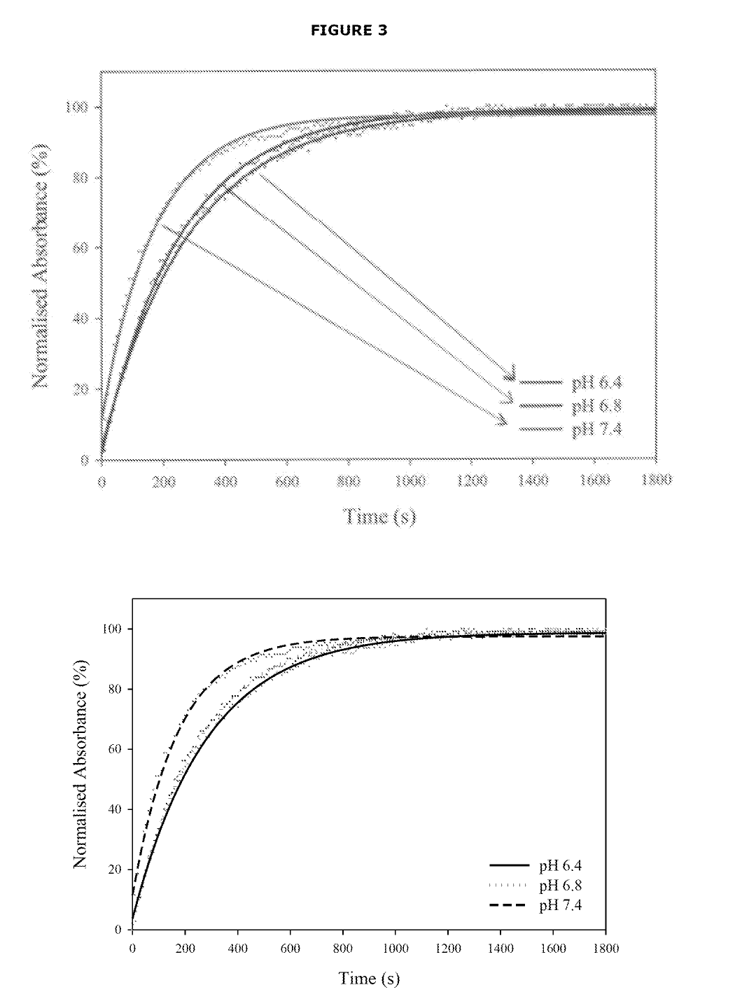

Upon addition of 1 to a solution of deoxy-Mb in phosphate buffer, MbCO was formed over a period of approximately 20 minutes. The formation of MbCO was confirmed by the absorption maximum of deoxy-Mb at 555 nm decreasing and the two absorption maxima of MbCO at 540 and 577 nm increasing as a function of time, as seen for experiments using pH-CORM-1. As in the case of pH-CORM-1 the experiments were conducted at pH 6.4, 6.8 and 7.4 and at 20 and 37° C. The approximate time for complete carbonylation of deoxy-Mb by 1 was slower in comparison to pH-CORM-1 under analogous conditions with about 20 minutes till completion. The release of CO from 1 was largely pH independent, with release being slightly more rapid at pH 7.4 (FIG. 3). Without wishing to be bound by theory, the inventors believe this may be due to deprotonation of [HL]⁺ under these slightly basic conditions which may promote coordination of L to ruthenium, facilitating the displacement of one or more CO ligands.

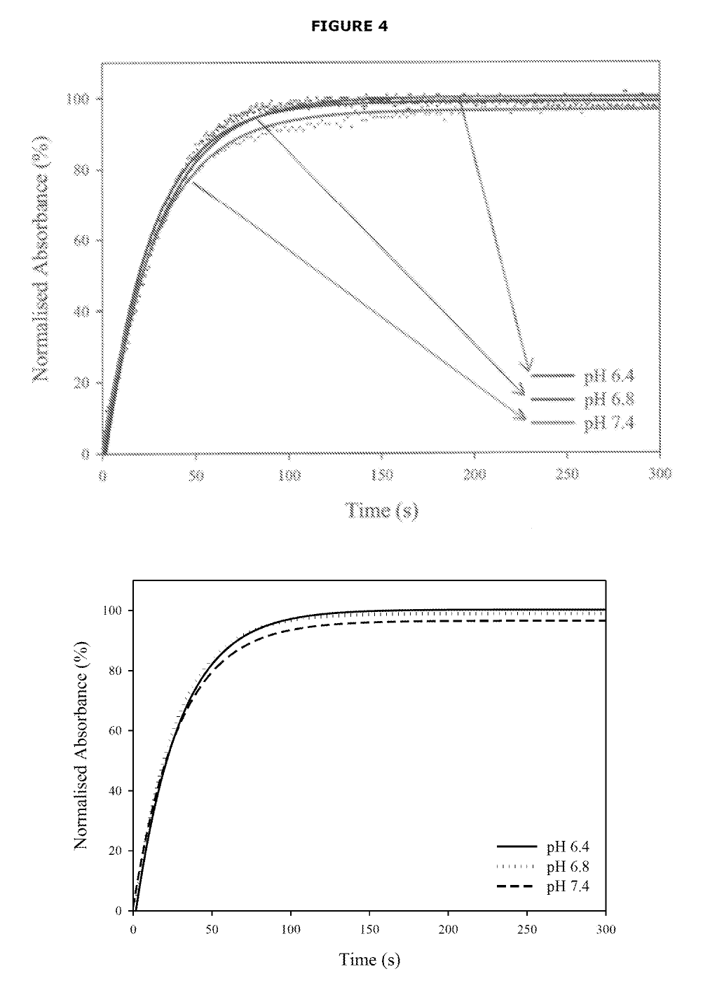

The CO releasing properties of 1 were also investigated at 37° C. Upon addition of 1 to a solution of deoxy-Mb, MbCO was rapidly formed in solution over a period of 180 seconds. The release of CO under these conditions from 1 was slower than from pH-CORM-1 under the same conditions. The release of CO from 1 at this temperature was much faster than at 20° C. Although the approximate time to complete carbonylation varied slightly, the rate of CO release was comparable across all three pH values (FIG. 4).

Overall, the CO-releasing studies of 1 show that this compound has the ability to release CO in solution at various pH values and temperatures. The release of CO from 1 does not seem to be pH dependent, but is temperature dependent with CO release being much faster at 37° C. in comparison to 20° C.

An analogue of compound 1 without a PYA ligand present, either coordinated or in solution, was synthesised for use as a control. In this compound Et₄N⁺ counterbalances the charge of [Ru(CO)₃Cl₃]⁻ to form [Et₄N][Ru(CO)₃Cl₃] (2). Although 1 did not show pH dependence in regard to CO release, the inventors believe that [HL]⁺ may undergo reversible deprotonation and coordination to ruthenium which may affect the CO-release. In 2, however, this is not possible.

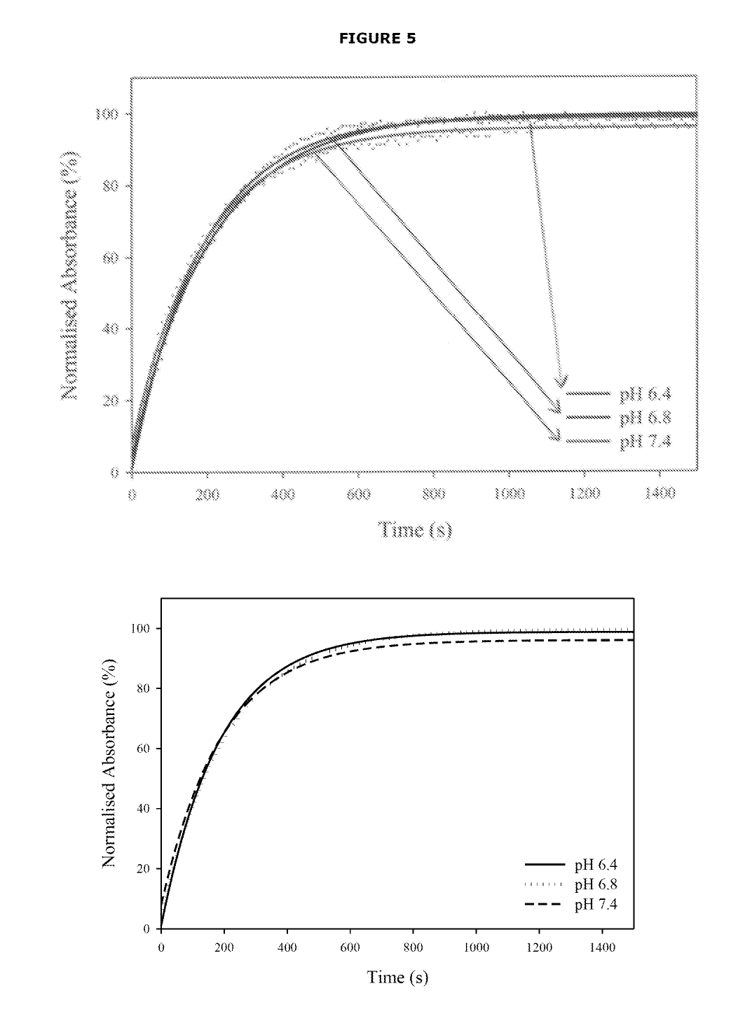

When the myoglobin assays were conducted at 20° C. the release of CO from 2 was not pH dependent. Upon addition of 2 to a solution of deoxy-Mb at pH 6.4 the absorption spectrum of deoxy-Mb changed to that typical of MbCO over a period of 15 minutes with the same isosbestic points forming at 515, 550, 570 and 585 nm. As observed for pH-CORM-1 and 1, the absorbance maximum of deoxy-Mb (555 nm) decreased over time while the two absorption maxima of MbCO (540 and 577 nm) increased over time. The same results were found at pH 6.8 and 7.4 with MbCO forming over approximately 15 minutes. The rate of CO release from 2, therefore, is independent of pH at 20° C. as was observed for 1 but not for pH-CORM-1. This is evident when comparing the normalised absorption at 540 nm for all pH values (FIG. 5). This is evidence that the pH dependent release of CO observed for pH-CORM-1 is due to the characteristics of the complex and properties of the ligand N-(1-benzylpyridin-4(1H)-ylidene)picolinamide (L).

### Kinetics of CO Release

The rate of CO transfer for all conditions was calculated by analysing the change in absorbance at 540 nm. The change in absorbance at 540 nm was plotted as a function of time for all experiments conducted and an exponential rise to maximum equation was fitted to the data to calculate the rate constant of CO transfer (Equation 1):

y=y₀+a(1−exp^{-kt})

where y=absorbance at time ‘t’, y₀+a=A∞−A₀, and k=rate constant. The rate constants were determined for each of the experiments conducted for pH-CORM-1, 1 and 2. The equation was generated using the programme Sigma Plot (version 12.5). A rate constant was calculated for every experiment and the average rate is reported (unless stated otherwise). The derived equation was a good fit for the data analysed as determined by the coefficient of determination for each line. The coefficient of determination (R²) is an indication of how well the data fits a given equation, with a value of 1 being a perfect fit. For the six conditions the R² value ranged from 0.9448 to 1.000, indicating very good fits of the data to the equation.

The half-life (t_{1/2}) of each reaction was calculated from the rate constant. The reactions were assumed to be first order reactions thus the half-life can be calculated from Equation 2 which is derived from the rate law of first order reactions:

t_{1/2}=ln(2)/k

where k=the calculated rate constant from Equation 1. The results are shown in Tables 1 and 2 below.

At 20° C., the rate of CO release from pH-CORM-1 was pH dependent with the average rate of CO release being faster at pH 6.4 (k=2.1×10⁻² s⁻¹, t_{1/2}=33 s) in comparison to pH 6.8 (k=9.6×10⁻³ s⁻¹, t_{1/2}=72 s) and pH 7.4 (k=5.4×10⁻³ s⁻¹, t_{1/2}=129 s). The trend of CO release being faster at pH 6.4 in comparison to pH 6.8 and 7.4 is also evident when comparing the normalised change in absorption at 540 nm for each pH value (FIG. 1).

In contrast, the release of CO from 1 did not follow the same trend; the average rate of CO release from 1 was slightly faster at pH 7.4 than at more acidic conditions (see Table 1). The three analogous experiments conducted at pH 6.4 using 1 had varied calculated rate constants, leading to a large standard deviation (Table 1). This variation is may have been due to inconsistent stirring in the cuvette during these experiments.

The average rate of CO release from 2 at 20° C. is similar at all studied pH values (see Table 1). In the CO releasing studies of 2 at pH 7.4, only experiment 3 was used in the calculation of the rate constant and half-life because in experiment 1 and 2 the absorbance at 540 nm fluctuated as a function of time rather than steadily increasing. The results from experiment 1 and 2 may have been due to an experimental error.

The results from the assays conducted at 20° C. show that the rate of CO release from pH-CORM-1 is pH dependent while the CO release from 1 and 2 is not pH dependent in the same manner. This is due to the presence of the PYA ligand in the ruthenium carbonyl complex cation in pH-CORM-1.

While all the synthesised compounds feature [Ru(CO)₃Cl₃]⁻, only pH-CORM-1 undergoes quick ligand exchange. Therefore, there is no significant contribution to the overall rate of CO release from the [Ru(CO)₃Cl₃]⁻ anion.

The rates of CO release and associated half-lives were also calculated for the CO-releasing studies conducted at 37° C. For all compounds, the average rate of CO release was much faster in assays conducted at 37° C. in comparison to those conducted at 20° C. (see Tables 1 and 2). The average rate of CO release from pH-CORM-1 at 37° C. still showed pH-dependence with CO release being faster at pH 6.4 (k=1.2×10⁻¹ s⁻¹, t_{1/2}=6 s) in comparison to pH 6.8 (k=9.4×10⁻² s⁻¹, t_{1/2}=7 s) and pH 7.4 (k=7.2×10⁻² s⁻¹, t_{1/2}=10 s). In comparison to the assays at 20° C., however, this effect was less pronounced because as CO release was very fast at all pH values.

The rate of CO release from 1 at 37° C. did not show this same pH-dependent behaviour.

The average rate of CO release from 2 was slightly slower at pH 6.4 (k=2.9×10⁻² s⁻¹, t_{1/2}=24 s) in comparison to pH 6.8 (k=3.9×10⁻²s⁻¹, t_{1/2}=19 s) and pH 7.4 (k=3.6×10⁻² s⁻¹, t_{1/2}=19 s) although this difference was not significant. The rate at which CO was transferred from 2 to deoxy-Mb was comparable to 1. Both contain [Ru(CO)₃Cl₃]⁻ as the CO source. The rate of CO release from 2 was slower in comparison to pH-CORM-1.

Overall the results from the assays conducted at 37° C. show that CO is released from pH-CORM-1 in a pH-dependent manner but this is not observed for 1 or 2. This pH dependent effect is not as pronounced in comparison to the assays conducted at 20° C. as the release is very quick at all pH values. There was a clear temperature-dependent release of CO from all of the compounds studied, with CO release being much faster at 37° C. than at 20° C.

TABLE 1
Average rate constant of CO release from pH-CORM-1, 1 and 2
to deoxy-Mb for all conditions. Experiments were conducted in
triplicate. Standard deviations are given in parenthesis.

| | k/s⁻¹ | |
|---|---|---|
| | 20° C. | 37° C. |
| pH-CORM-1 | | |
| pH 6.4 | 2.1 (±0.41) × 10⁻² | 1.2 (±0.28) × 10⁻¹ |
| pH 6.8 | 9.6 (±0.27) × 10⁻³ | 9.4 (±0.78) × 10⁻² |
| pH 7.4 | 5.4 (±0.020) × 10⁻³ | 7.2 (±0.12) × 10⁻² |
| [HL][Ru(CO)₃Cl₃] (1) | | |
| pH 6.4 | 4.0 (±1.5) × 10⁻³ | 3.5 (±1.3) × 10⁻² |
| pH 6.8 | 3.9 (±0.080) × 10⁻³ | 3.6 (±0.73) × 10⁻² |
| pH 7.4 | 5.3 (±0.52) × 10⁻³ | 3.4 (±0.18) × 10⁻² |
| [Et₄N][Ru(CO)₃Cl₃] (2) | | |
| pH 6.4 | 5.1 (±0.41) × 10⁻³ | 2.9 (±0.17) × 10⁻² |
| pH 6.8 | 5.6 (±1.1) × 10⁻³ | 3.9 (±1.1) × 10⁻² |
| pH 7.4 | 5.7 × 10⁻³* | 3.6 (±0.050) × 10⁻² |

TABLE 2
Average half-lives for all CO- releasing studies conducted
for pH-CORM-1, 1 and 2. Experiments were conducted in triplicate
and standard deviations are reported in parenthesis.

t_{1/2} (s)

| | 20° C. | 37° C. |
|---|---|---|
| pH-CORM-1 | | |
| pH 6.4 | 33 (±7) | 6 (±1) |
| pH 6.8 | 72 (±2) | 7 (±1) |
| pH 7.4 | 129 (±1) | 10 (±1) |
| [HL][Ru(CO)₃Cl₃] (1) | | |
| pH 6.4 | 172 (±32) | 21 (±4) |
| pH 6.8 | 177 (±4) | 20 (±4) |
| pH 7.4 | 131 (±14) | 20 (±1) |
| [Et₄N][Ru(CO)₃Cl₃] (2) | | |
| pH 6.4 | 137 (±11) | 24 (±1) |
| pH 6.8 | 124 (±14) | 19 (±5) |
| pH 7.4 | 123* | 19 (±1) |

*Only Experiment 3 was used in this calculation and so no standard deviation is reported.

### 9 Example 8

The in vitro anticancer activity of pH-CORM-1 and [HL]Cl, 1 and 2, as controls, was determined by the following method, which is based on previously published methods (Moon, S.; Hanif, M.; Kubanik, M.; Holtkamp, H.; Sohnel, T.; Jamieson, S. M. F.; Hartinger, C. G. Chem. Plus Chem. 2015, 231-236).

### 9.1 Method

HCT116 (colon cancer cells) and NCI-H460 (large cell lung carcinoma) cells were supplied by ATCC, while SiHa cells (cervical cancer) were supplied by Dr. David Cowan, Ontario Cancer Institute, Canada. Cells were maintained in αMEM (Life Technologies) with 5% FCS (fetal calf serum from Moregate Biotech) at 37° C. in a humidified incubator with 5% CO₂. Cells were seeded at the appropriate density and allowed to settle for 24 hours, before the compounds (in 0.5% DMSO at the highest concentration) were added at 3-fold serial dilutions. After 72 h compound exposure, the cells were fixed with 10% TCA (trichloroacetic acid from Merck Millipore) for 1 h at 4° C., then washed before addition of 50 μl of 0.4% sulforhodamine B solution (Sigma Aldrich) for 30 min at room temperature in the dark. After washing with 1% acetic acid, the aminoxanthene dye was solubilised with 100 μl/well unbuffered Tris base (10 mM; Serva) on an orbital shaker for at least 30 min in the dark. The optical density was measured on a BioTek EL808 microplate reader at an absorbance of 490 and 450 nm (reference wavelength) and was used to determine the percentage of cell-growth inhibition. IC₅₀ values were calculated with SigmaPlot12.5 using a three-parameter logistic sigmoidal dose-response curve between the calculated growth inhibition and the compound concentration. The presented IC₅₀ values are the mean of 3 independent experiments, where 10 concentrations were tested in duplicate for each compound.

### 9.2 Results

Results from the anticancer assays showed that 1 with HL⁺ as the counter cation was the most active compound in all cancer cell lines tested, with IC₅₀ values in the low μM range (e.g., 24 μM in HCT116). pH-CORM-1 with L coordinated to the metal centre had activity intermediate to 1 and 2, the latter being non-cytotoxic in the investigated concentration range, and pH-CORM-1 being moderately cytotoxic with IC₅₀ values up to 119 μM in the HCT116 cell line.

These results suggest that the PYA ligand whether coordinated to the Ru centre in pH-CORM-1 or present as the counter cation in 1, is the cytotoxicity-determining factor. This is supported by the anticancer activity of [HL]Cl which showed similar IC₅₀ values as 1 (Table 3). In contrast, the [Ru(CO)₃Cl₃]⁻ complex anion does not appear to be cytotoxic.

The solubility in water (a measure for hydrophilicity) appears to have an impact on the cytotoxicity.

TABLE 3
Biological studies on known cancer cell
lines and their corresponding IC₅₀ values

| | Solubility | | | |
|---|---|---|---|---|
| | in water | Average IC₅₀ Values (μM) | | |
| Compound | (mM) | NCI-H460 | HCT116 | SiHa |
| [HL]Cl | 12.28 | 54 (±13) | 20 (±1) | 30 (±11) |
| pH-CORM-1 | 1.56 | 164 (±39) | 119 (±10) | 148 (±9) |
| 1 | 1.45 | 73 (±16) | 24 (±2) | 26 (±5) |
| 2 | 6.78 | >1600 | >1600 | >1600 |

The results of the anticancer tests, overall, show that pH-CORM-1 and 1 are moderately cytotoxic to cancer cell lines. Compound 2, which does not contain [HL]⁺ or L but rather Et₄N⁺, is not active against any of the cancer cell lines in the concentration range used in this assay. The biological activity of pH-CORM-1 and 1, therefore, is mediated by the form of the ligand present—either as the counter cation in the protonated [HL]⁺ form or coordinated to the Ru centre (L).

### Example 9

10.1 Synthesis of Ru(CO)₂Cl₂L

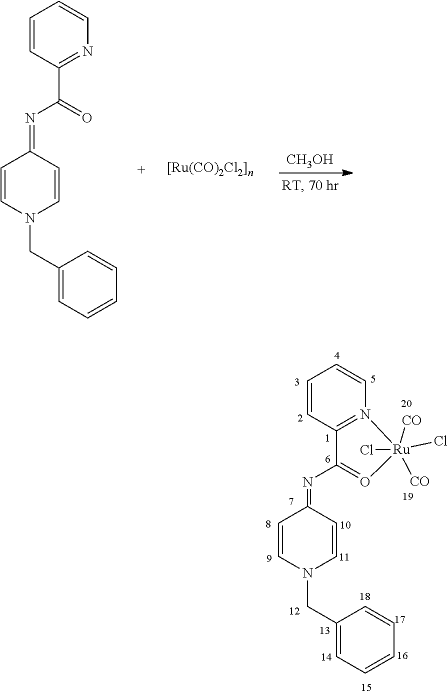

[Ru(CO)₂Cl₂]n (40 mg, 0.175 mmol) in methanol (10 mL) was first refluxed under N₂ for 1.5 hour. The solution was cooled to room temperature before L (50 mg, 0.175 mmol) in methanol (10 mL) was added. The reaction mixture was then stirred for 70 hours. An off-white suspension was formed after 30 minutes of stirring. Two-third of the solvent was removed after 70 hours and isopropanol (10 mL) was added to the solution. The suspension was filtered and washed with isopropanol (3×5 mL) to yield Ru(CO)₂Cl₂L (30.1 mg, 35.6%).

¹H NMR (DMSO, b): 9.03-9.01 (m, 1H, H5), 8.43-8.40 (m, 1H, H2), 8.74 (d, 2H, ³J_{HH}=7.28 Hz, H9, H11), 8.24 (td, 1H, H3), 7.87-7.83 (m, 1H, H4), 7.75 (d, 2H, ³J_{HH}=7.32 Hz, H8, H10), 7.47-7.40 (m, 5H, H14-18), 5.59 (s, 2H, H12).

¹³C{¹H} NMR (DMSO, b): 197.71 (CO), 196.93 (CO), 172.32 (C6), 163.77 (C7), 153.49 (C1), 151.77 (C5), 143.93 (C9, C11), 139.81 (C3), 135.12 (C13), 129.17-128.28 (C14-18), 126.43 (C2), 121.31 (C8, C10), 61.15 (C12).

The molecular structure of Ru(CO)₂Cl₂L as determined by X-ray diffraction is shown in FIG. 16. The complex has octahedral coordination geometry.

X-ray diffraction measurements of single crystals of the complex were carried out on a Siemens/Bruker SMART APEX II Single Crystal Diffractometer with a CCD area detector using graphite monochromated Mo-Kα radiation (λ=0.71073 A).

[Ru(CO)₂Cl₂]n was prepared following a literature procedure: Anderson P A, Deacon G B, Haarmann K H, et al. Inorg Chem. 1995; 34(24):6145-6157.

RuCl₃.H₂O (2.0 g) was placed in a 100 mL two-necked round-bottomed flask. 90% formic acid (50 mL) was added to the flask before adding in paraformaldehyde (1.0 g). The resulting dark brown/red solution was refluxed for 6 hours. The solution changed colour to dark green after 1 hour, then to red-yellow after 4 hours and finally to yellow. The solution was cooled to room temperature and left at 4° C. overnight. The formic acid was then removed in vacuo into a secondary trap in a dry ice/acetone bath. The orange-yellow solid was dried in vacuo for 2 days before it was washed with n-hexane and further recrystallized in acetone:diethylether. The solid was collected by filtration. This yielded [Ru(CO)₂C2]ₙ as a yellow powder (1.37 g, 62%).

### 11 Example 10

### 11.1 Synthesis of Mo(CO)₄L

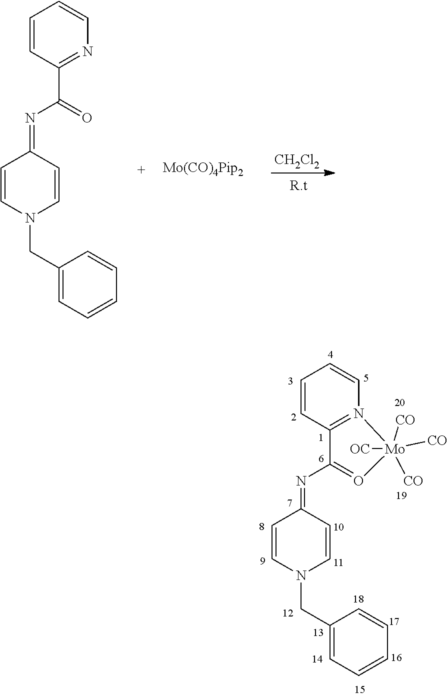

Mo(CO)₄(C₅H₁₁N)₂ (32.7 mg, 0.086 mmol) was dissolved in dichloromethane (5 mL) and stirred for 10 minutes at ambient temperature. To this solution, a solution of L (50 mg, 0.086 mmol) in dichloromethane (2 mL) was added. The reaction mixture was then stirred for 2 hours. The color of the solution change from yellow to dark purple after addition of L. The solvent was removed under reduced pressure to obtain Mo(CO)₄L as a purple solid.

¹H NMR (DMSO, δ): 8.71 (d, 1H, J_{HH}=5.07 Hz, H5), 8.26 (d, 2H, ³J_{HH}=7.44 Hz, H9, H11), 8.17 (d, 1H, ³J_{HH}=7.74 Hz, H2), 7.99 (t, 1H, H3), 7.62-7.57 (m, 1H, H4), 7.44-7.36 (m, 5H, H14-H18), 6.83 (d, 2H, J_{HH}=7.56 Hz, H8, H10), 5.51 (s, 2H, H12).

Tetracarbonylbis(piperidine)molybdenum(0) (Mo(CO)₄(C₅H₁₁N)₂) was obtained commercially or synthesised following a literature procedure: Darensbourg D J, Kump R L. Inorg Chem. 1978; 17(9):2680-2682.

Mo(CO)₆, (2.0 g) and 5 mL of piperidine were refluxed in 20 mL of heptane for 2.5 hours during which time the bright yellow product precipitated from solution. The reaction mixture was filtered hot to isolate Mo(CO)₄(C₅H₁₁N)₂ as a yellow solid. The solid was washed with cold heptane and dried under vacuum.

### 12 Example 11

### 12.1 Synthesis of [Ru(CO)₂Cl(BnL′)]Cl

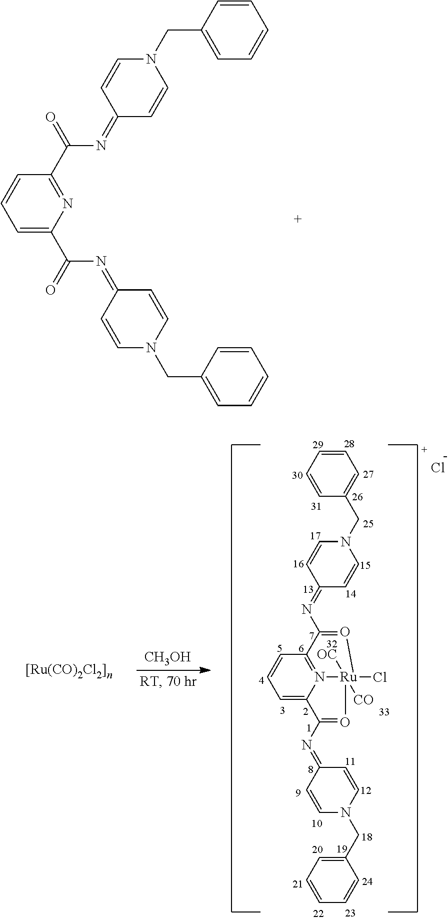

[Ru(CO)₂Cl₂]n (23 mg, 0.1 mmol) was refluxed in methanol (10 mL) for 1.5 hour. After cooling to room temperature, a solution of BnL′ (50 mg, 0.1 mmol) in methanol (10 mL) was then added to the solution. The reaction mixture was stirred for 70 hours. An off-white suspension formed after 30 minutes of stirring. Two-third of the solvent was removed after 70 hours and isopropanol (10 ml) was added to the solution. The suspension was filtered and washed with isopropanol (3×5 mL) to yield [Ru(CO)₂Cl(BnL′)]Cl (30.1 mg, 35.6%).

¹H NMR (DMSO, δ): 8.84 (d, 4H, J_{HH}=7.32 Hz, H10, H12, H15, H17), 8.53 (t, 1H, H4), 8.34 (d, 2H, J_{HH}=7.62 Hz, H3, H5), 7.96 (d, 4H, ³J_{HH}=7.29 Hz, H9, H11, H14, H16), 7.49-7.43 (m, 10H, H20-H24, H27-H31), 5.66 (s, 4H, H18, H25).

¹³C{¹H} NMR (DMSO, δ): 209.16 ((CO)₂), 170.4 (C1, 7), 166.6 (C13, 8), 152.9 (C2, 6), 142.2 (C10, 12, 15, 17), 139.4 (C4), 135.2 (C19, 26), 129.2, 128.9, 128.3 (C20-24, C27-31), 126.1 (C3, 5), 123.3 (C9, 11, 14, 16), 60.9 (C18, 25).

m/z calculated for [Ru(CO)₂Cl(BnL′)]⁺: 692.10 found: 692.0654.

### 13 Example 12

13.1 Synthesis of Ru(CO)₂Cl₂L″

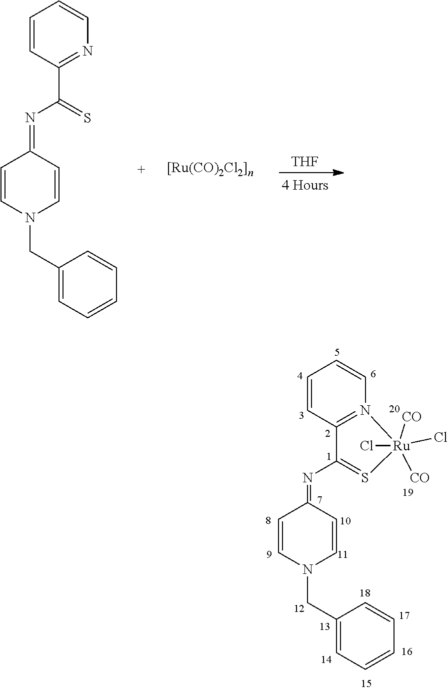

[Ru(CO)₂Cl₂]n (37.3 mg, 0.163 mmol) in tetrahydrofuran (5 mL) was first refluxed under N₂ for 1.5 hour. The solution was cooled to room temperature before L″ (50 mg, 0.163 mmol) in tetrahydrofuran (3 mL) was added. The reaction mixture was then refluxed for 4 hours to obtain Ru(CO)₂Cl₂L″ as a brown precipitate which was collected by filtration.

¹H NMR (DMSO, δ): 9.02 (d, 1H, J_{HH}=5.12 Hz, H5), 8.74 (d, 2H, ³J_{HH}=6.96 Hz, H9, H11), 8.41 (d, 1H, ³J_{HH}=8.44 Hz, H2), 8.21-8.12 (m, 1H, H3), 7.95-7.85 (m, 1H, H4), 7.75 (d, 2H, J_{HH}=7.08 Hz, H8, H10), 7.46-7.43 (m, 5H, H14-H18), 5.6 (s, 2H, H12).

m/z calculated for Ru(CO)₂Cl₂L″: 497.9616 found 497.9633.

### 14 Example 13

The CO-releasing properties of Ru(CO)₂Cl₂L, Mo(CO)₄L, [Ru(CO)₂Cl(BnL′)]Cl, and Ru(CO)₂Cl₂L″ were analysed using a myoglobin assay as described below.

### Preparation of Buffer Solutions

A standard literature procedure was followed to make 0.04 mol L⁻¹ phosphate buffer solutions at pH 6.4 and 7.4 (Common Stock Solutions, Buffers and Media. Current Protocols in Cell Biology. John Wiley and Sons, 1998).

A solution of NaH₂PO₄.2H₂O (1.25 g, 200 mL, 0.040 M) was added drop-wise to a solution of Na₂HPO₄.2H₂O (1.42 g, 200 mL, 0.040 M) until the desired pH was reached. The pH of each solution was measured with a Mettler Toledo SevenCompact pH meter fitted with a Mettler Toledo InLab Expert Pro pH electrode. The pH meter was calibrated with standard buffer solutions at pH 4.01, 7.00 and 9.21. Each pH measurement was conducted at the same temperature as required for the myoglobin assay.

### Assay

The release of CO from the complexes was assessed spectrophotometrically, based on standard literature procedures (Motterlini, R.; Clark, J. E.; Foresti, R.; Sarathchandra, P.; Mann, B. E.; Green, C. J. Circ. Res. 2002, 90, 17-24; and Peng, P.; Wang, C.; Shi, Z.; Johns, V. K.; Ma, L.; Oyer, J.; Copik, A.; Igarashi, R.; Liao, Y. Org. Biomol. Chem. 2013, 11, 6671-6674), by measuring the conversion of deoxy-myoglobin (deoxy-Mb) to carbonmonoxy-myoglobin (MbCO).

Myoglobin solutions (50 μM) were freshly prepared prior to each measurement by dissolving the protein (1.76 mg, 50 μmol) in 40 mM phosphate buffer (2000 μL) at pH 6.4 or 7.4 and at 20° C. The solution was deoxygenated by bubbling nitrogen through the solution. While still bubbling with nitrogen gas, sodium dithionite (4 μL, 20 mM) was added from a 1.00 M stock solution to convert the myoglobin to deoxy-Mb. The reduced myoglobin solution (2000 μL) was placed into a screw-cap quartz cuvette (path length 1.00 cm) containing a 5 mm Teflon magnetic stirrer bar. The cuvette was sealed with a Teflon cap fitted with a septum and bubbled with nitrogen for 60 seconds using one needle to deliver the nitrogen and another one for nitrogen to exit to ensure the solution was sealed under an atmosphere of nitrogen. 10 μL of an 16 mM solution of each complex in DMSO were injected into the cuvette containing the deoxy-myoglobin solution under nitrogen to give a final CORM concentration of 40 μM in solution. The solutions were stirred at a constant rate for the duration of the experiment.

The UV-visible spectra were obtained on a diode array UV-visible spectrometer. This consisted of an Ocean Optics LS-1 tungsten halogen lamp, connected with fibre optics to a cuvette holder, which was in turn connected to a USB2000-VIS-NIR detector operating between 350 and 100 nm. The spectrometer was fitted with a Quantum Northwest TC125 temperature control unit which kept the cuvette at the desired temperature for the duration of the experiment. Stirring was also controlled via this unit. OOIbase32 software version 2.0.6.2 (Ocean Optics) was used to obtain the data from 189 nm to 896 nm. The experimental parameters were set up to run 10 scans to average and spectra were recorded every 10 seconds for the assays. A box car width of 5 was applied to assays. The UV-visible experiments were conducted in triplicate for each condition.

A baseline measurement of carbonmonoxy-myoglobin was obtained at pH 6.4 and 7.4 and 20° C. by bubbling carbon monoxide gas through a solution of deoxy-myoglobin for two minutes.

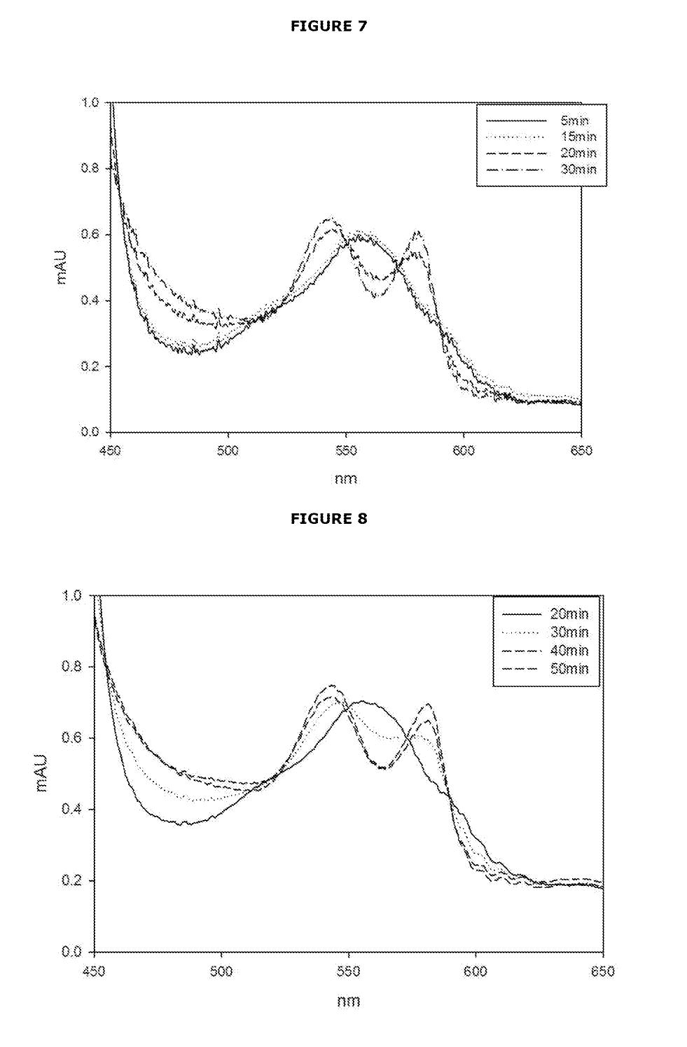

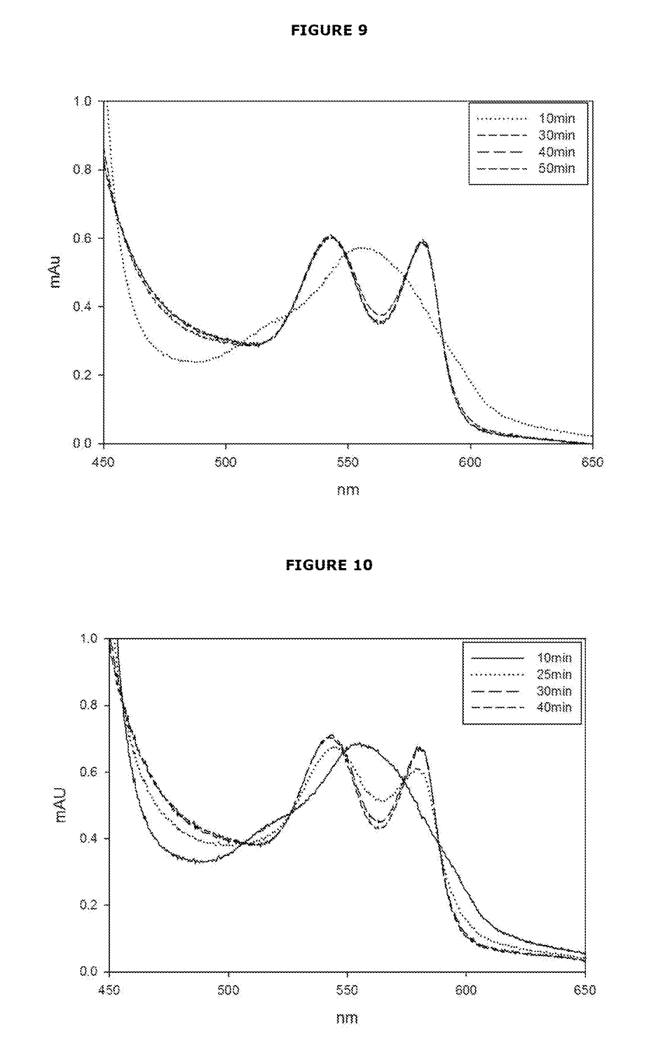

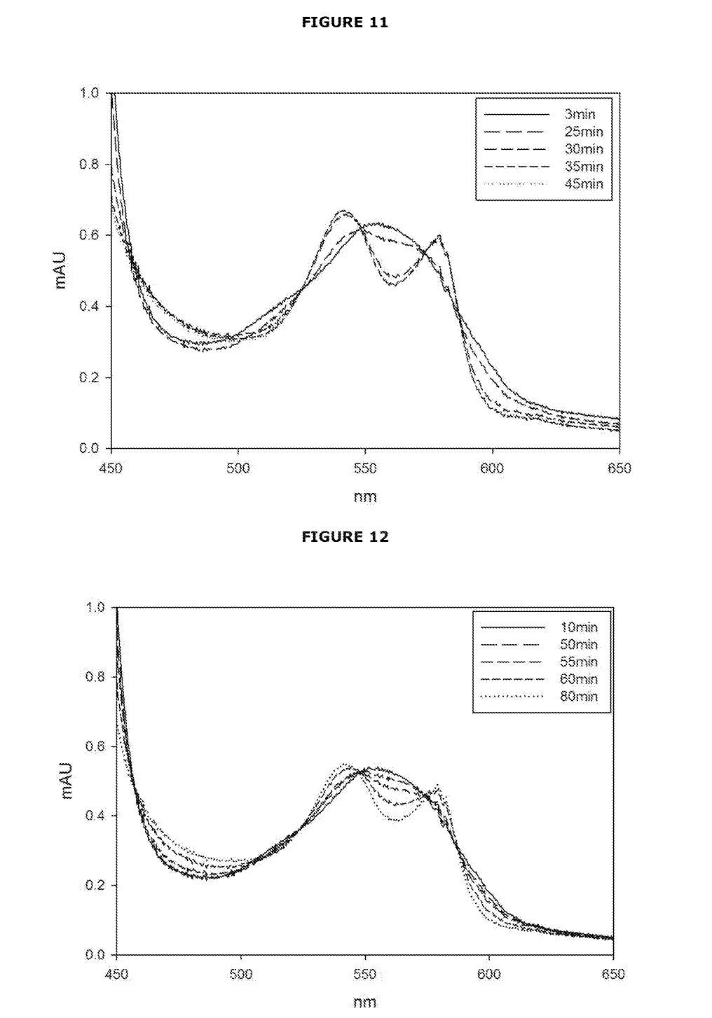

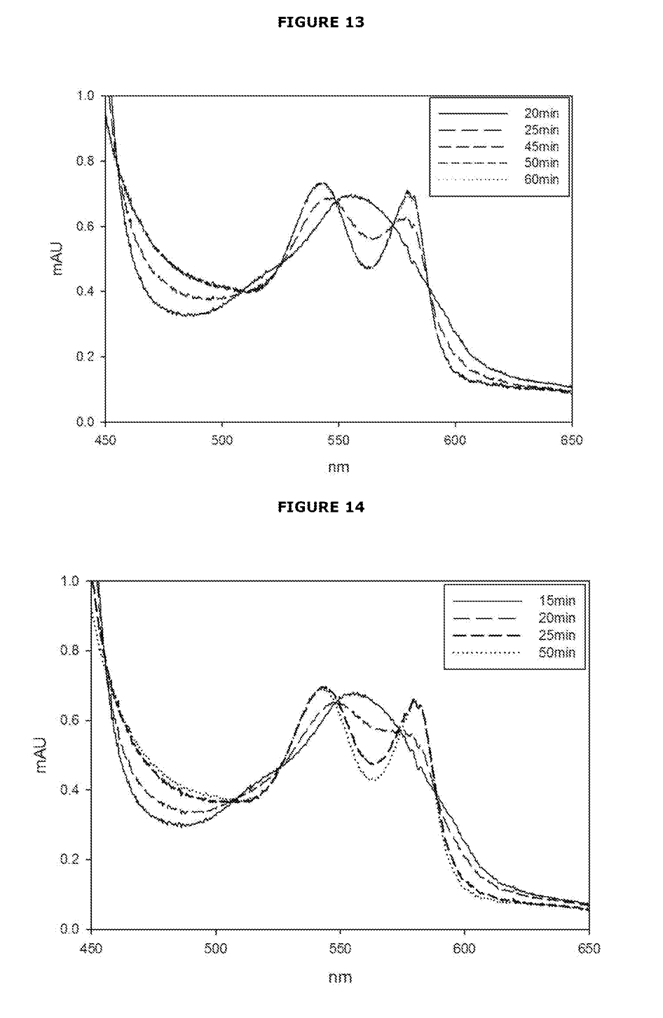

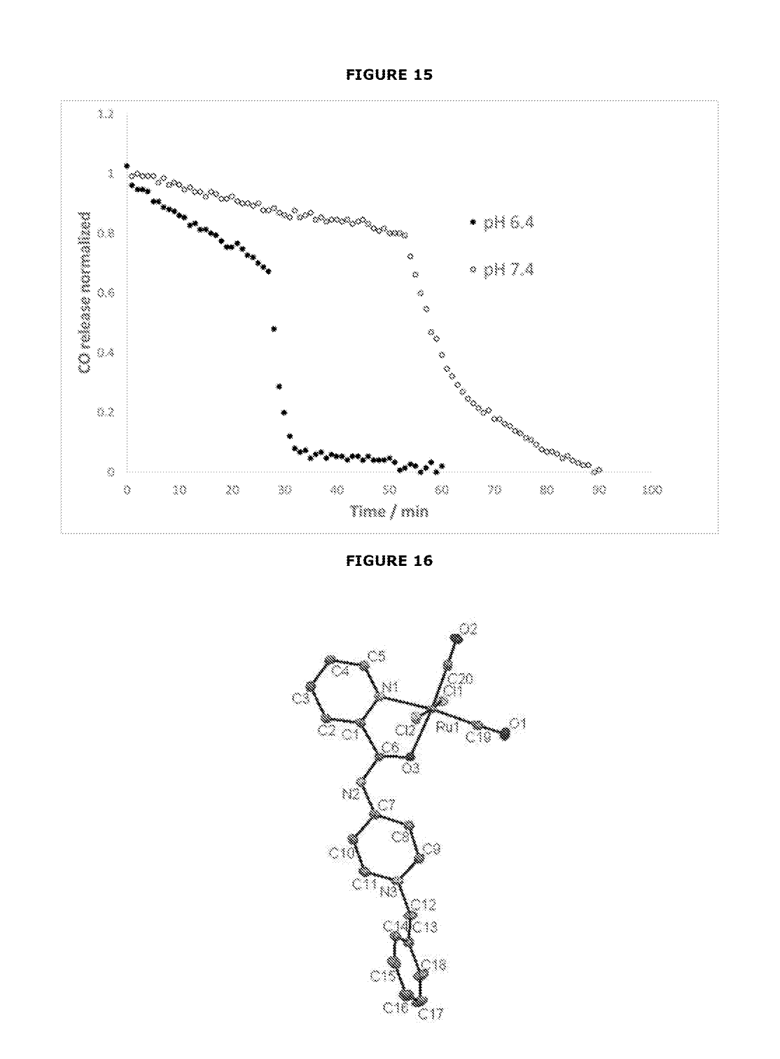

The results are shown in FIGS. 7-15.

Rate constants for the release of CO from the compounds is summarised in Table 4. For all compounds, the rate of release at pH 6.4 was greater than the rate of release at pH 7.4.

TABLE 4
Rate constant of CO release of pH-dependant
CORMs tested at pH 6.4 and 7.4

Rate constant (k/min−1)

| Compound | pH 6.4 | pH 7.4 |
|---|---|---|
| Ru(CO)₂Cl₂L | 4.65(0.65) × 10⁻¹ | 2.76(0.27) × 10⁻¹ |
| Ru(CO)₂Cl₂L″ | 2.65(0.17) × 10⁻¹ | 2.23(0.21) × 10⁻¹ |
| Mo(CO)₄L | 2.83(0.34) × 10⁻¹ | 1.98(0.22) × 10⁻¹ |
| [Ru(CO)₂Cl(BnL′)]Cl | 2.58(0.017) × 10⁻¹ | 1.61(0.20) × 10⁻¹ |

Although the invention has been described by way of example and with reference to particular embodiments, it is to be understood that modifications and/or improvements may be made without departing from the scope of the invention.

1. A complex comprising:
a transition metal;
at least one carbon monoxide ligand coordinated to the transition metal; and
a pH responsive ligand coordinated to the transition metal that modulates the release of carbon monoxide from the complex such that the rate of release of carbon monoxide at a pH from about 6.0 to about 6.5 is greater than the rate of release of carbon monoxide at normal physiological pH (7.4);
or a pharmaceutically acceptable salt or solvate thereof.

2. The complex of claim 1, wherein the initial rate at 20° C. or half-life (t_{1/2}) at 20° C. of release of carbon monoxide at a pH from about 6.0 to 6.5 is at least about 1.1, 1.2, 1.3, 1.4, 1.5, 1.6, 1.7, 1.8, 1.9, 2, 2.5, 3, 3.5, or about 4 times greater than the initial rate of release at 20° C. or the half life of release at 20° C. at normal physiological pH when measured by myoglobin assay.

3. (canceled)

4. (canceled)

5. The complex of claim 1, wherein greater than 50, 60, 70, 75, 80, 85, 90, 95, 96, 97, 98, or 99 mol % of the pH responsive ligand is in a protonated form at a pH from about 6.0 to about 6.5 and greater than 50, 60, 70, 75, 80, 85, 90, 95, 96, 97, 98, or 99 mol % of the pH responsive ligand is in the form of a conjugate base of the protonated form at normal physiological pH.

6. (canceled)

7. (canceled)

8. The complex of claim 1, wherein the pH responsive ligand comprises at least one (for example one, two, or three) group of the formula (A): 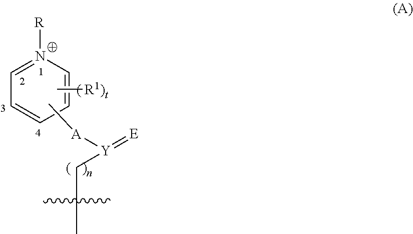
wherein:
E at each instance or A at each instance is independently coordinated to the transition metal;
when E is coordinated to the transition metal A is independently a protonated nitrogen atom (—NH—) or an negatively charged nitrogen atom (—N⁻—) and Y=E is independently C═O, C═S, C═Se, C═NR′, or S(═O)₂;
when A is coordinated to the transition metal A is independently a negatively charged nitrogen atom (—N⁻—) and Y=E is independently C═O, C═S, C═Se, C═NR′, or S(═O)₂ or a protonated form thereof;
each pyridinium ring attached to A is independently attached to A via the 2- or 4-position of the pyridinium ring;
t at each instance is independently an integer from 0-4;
n at each instance is independently an integer from 0-6 (for example 0-3);
R at each instance is independently selected from —PR¹⁰R¹¹ or —NR¹⁰R¹¹ or alkyl, alkenyl, alkynyl, carbocyclyl, carbocyclylalkyl, aryl, arylalkyl, heteroaryl, heterocyclyl, ether, or polyether, each of which is optionally substituted with one or more optional substituents;
R¹⁰ at each instance and R¹¹ at each instance are each independently selected from hydrogen or alkyl, alkenyl, alkynyl, carbocyclyl, carbocyclylalkyl, aryl, arylalkyl, heteroaryl, heterocyclyl, each of which is optionally substituted with one or more optional substituents; or R¹⁰ and R¹¹ together with the atom to which they are attached form a heterocyclic or heteroaryl ring optionally substituted with one or more optional substituents;
R′ at each instance is independently selected from hydrogen or alkyl, alkenyl, alkynyl, carbocyclyl, carbocyclylalkyl, aryl, arylalkyl, heteroaryl, heterocyclyl, each of which is optionally substituted with one or more optional substituents; and
R¹ at each instance is independently N₃, halo, or cyano, or alkyl, alkenyl, alkynyl, carbocyclyl, carbocyclylalkyl, aryl, arylalkyl, heteroaryl, heterocyclyl, ether, or polyether, each of which is optionally substituted with one or more optional substituents;
or a tautomer, stereoisomer, or resonance form thereof.

9. The complex of claim 8, wherein the pH responsive ligand has the formula (I): 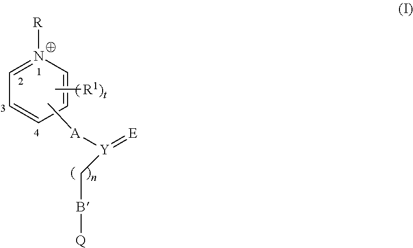
wherein
Q is selected from -J, -E′, -E″-G, -T-G, or 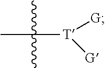
G and G′ are each independently 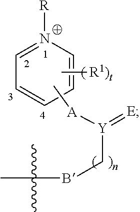
J is a non-coordinating group;
E′ is a donor group comprising a donor atom selected from O, N, C, S, Se, or P coordinated to the transition metal that together with the A or E coordinated to the transition metal and the atoms through which they are attached forms a 4 to 8 membered (for example, 5 or 6 membered) chelate ring with the transition metal;
E″ is a donor group comprising a donor atom selected from O, N, C, S, Se, or P coordinated to the transition metal that together with each A or E coordinated to the transition metal and the atoms through which they are attached independently forms a 4 to 8 membered (for example, 5 or 6 membered) chelate ring with the transition metal;
T is a bond or a non-coordinating group that together with the pair of A or E coordinated to the transition metal and the atoms through which they are attached forms a 5 to 11 membered (for example 5 to 8 membered) chelate ring with the transition metal;
T′ is a non-coordinating group that together with each pair of A or E coordinated to the transition metal and the atoms through which they are attached forms a 6 to 11 membered (for example 6 to 8 membered) chelate ring with the transition metal;
B′ at each instance is independently selected from a bond or a bridging group comprising a linear chain of from 1 to 4 atoms (for example 1 or 2 atoms) selected from C, N, Si, P, B, O, and S, wherein each free valence site is occupied by one or more independently selected R′; and
A, Y=E, t, n, R, R′, and R¹ are as defined the preceding claim;
or a tautomer, stereoisomer, or resonance form thereof.

10. The complex of claim 1, wherein the complex is six coordinate (for example, octahedral).

11. The complex of claim 1, wherein the complex comprises one or more other ligands coordinated to the transition metal selected from a monodentate (for example chloride) or bidentate ligand.

12. (canceled)

13. The complex of claim 9, wherein the complex is a compound of the formula (II): 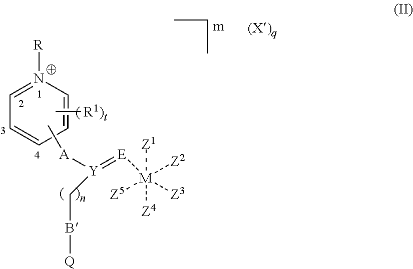
wherein:
m represents the charge of the complex and is 0 or a negative or positive integer;
q is 0 when m is 0 or q is 1 when m is a negative or positive integer;
X′ is one or more anions that balance the charge of the complex when m is a positive integer or one or more cations that balance the charge of the complex when m is a negative integer;
M is a transition metal selected from Ru, Os, Mn, Fe, Rh, Ir, Mo, W, V, Ni, Cr, or Co;
Q is selected from -J, -E′, -E″-G, -T-G, or 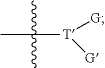
G and G′ are each independently 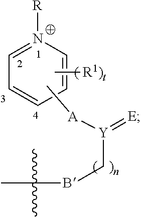
J is a non-coordinating group;
E′ is a donor group comprising a donor atom selected from O, N, C, S, Se, or P coordinated to the transition metal that together with E coordinated to the transition metal and the atoms through which they are attached forms a 4 to 8 membered (for example, 5 or 6 membered) chelate ring with the transition metal;
E″ is a donor group comprising a donor atom selected from O, N, C, S, Se, or P coordinated to the transition metal that together with each E coordinated to the transition metal and the atoms through which they are attached independently forms a 4 to 8 membered (for example, 5 or 6 membered) chelate ring with the transition metal;
T is a bond or a non-coordinating group that together with the pair of E coordinated to the transition metal and the atoms through which they are attached forms a 5 to 11 membered (for example 5 to 8 membered) chelate ring with the transition metal;
T′ is a non-coordinating group that together with each pair of E coordinated to the transition metal and the atoms through which they are attached forms a 6 to 11 membered (for example 6 to 8 membered) chelate ring with the transition metal;
A at each instance is independently is a protonated nitrogen atom (—NH—) or an negatively charged nitrogen atom (—N⁻—);
each pyridinium ring attached to A is independently attached to A via the 2- or 4-position of the pyridinium ring;
Y=E at each instance is independently C═O, C═S, C═Se, C═NR′, or S(═O)₂;
E at each instance is coordinated to the transition metal;
B′, t, n, R, R′, and R¹ are as defined in claim 9;
Z¹, Z², Z³, Z⁴, and Z⁵ are each independently CO, or a monodentate ligand;
or any two cis Z¹, Z², Z³, Z⁴, and Z⁵ together form a bidentate ligand;
or, when Q is -E′, Z⁵ is a coordination bond between the donor atom of E′ and M;
or, when Q is -E″-G, Z⁴ is a coordination bond between the donor atom of E″ and M and Z⁵ is a coordination bond between the E of G and M;
or, when Q is 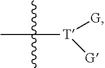
Z⁴ is a coordination bond between the E of G and M and Z⁵ is a coordination bond between the E of G′ and M; and
provided that at least one of Z¹, Z², Z³, Z⁴, and Z⁵ is CO;
or a pharmaceutically acceptable salt, solvate, tautomer, stereoisomer, or resonance form thereof.

14. (canceled)

15. (canceled)

16. The complex of claim 9, wherein J is selected from —OH, —SO₃H, —NO₂, halo, —CN, —C(═O)R′, —C(NR′)R′, —NR′R′, aliphatic, heteroaliphatic, carbocyclyl, aryl, heterocyclyl, or heteroaryl, each of which is optionally substituted with one or more optional substituents.

17. (canceled)

18. The complex of claim 9, wherein E′ and E″ are each independently selected from:
(i) an acyclic group comprising from 1 to 10 carbon atoms (for example 1 to 6 carbon atoms), wherein at least one carbon atom is replaced by the donor atom and wherein one or more other carbon atoms are optionally replaced by a heteroatom selected from O, N, or S, wherein the acyclic group is optionally substituted with one or more optional substituents;
(ii) a carbocyclic, aromatic, heterocyclic, or heteroaromatic ring system substituted with an acyclic group comprising from 1 to 10 carbon atoms (for example 1 to 6 carbon atoms), wherein at least one carbon atom of the acyclic group is replaced by the donor atom and wherein one or more other carbon atoms of the acyclic group are optionally replaced by a heteroatom selected from O, N, or S, wherein the ring system and acyclic group are each independently optionally substituted with one or more optional substituents; or
(iii) a carbocyclic, aromatic, heterocyclic, or heteroaromatic ring system comprising the donor atom, wherein the donor atom is endocyclic, and wherein the ring system is optionally substituted with one or more optional substituents.

19. (canceled)

20. (canceled)

21. (canceled)

22. (canceled)

23. The complex of claim 9, wherein T and T′ are each independently:
(i) a bridgehead comprising a C, N, B, P, or Si atom to which each B′ is attached, wherein each free valence site is occupied by one or more independently selected R′; or
(ii) an acyclic bridgehead group comprising from 2 to 10 carbon atoms, wherein one or more carbon atoms are optionally replaced by a heteroatom selected from O, N, or S, wherein the acyclic bridgehead group is optionally substituted with one or more optional substituents; or
(iii) a cyclic bridgehead group comprising one or more carbocyclic, aromatic, heterocyclic, heteroaromatic, borazine, or phosphazine rings (for example a carbohydrate or calixarene), wherein the cyclic bridgehead group is optionally substituted with one or more optional substituents.

24. (canceled)

25. (canceled)

26. The complex of claim 9, wherein B′ at each instance is independently selected from a bond or a C, N, Si, P, B, O, or S atom, wherein each free valence site is occupied by one or more independently selected R′.

27. (canceled)

28. The complex of claim 9, wherein the complex is a compound of the formula (II-A) or (II-B): 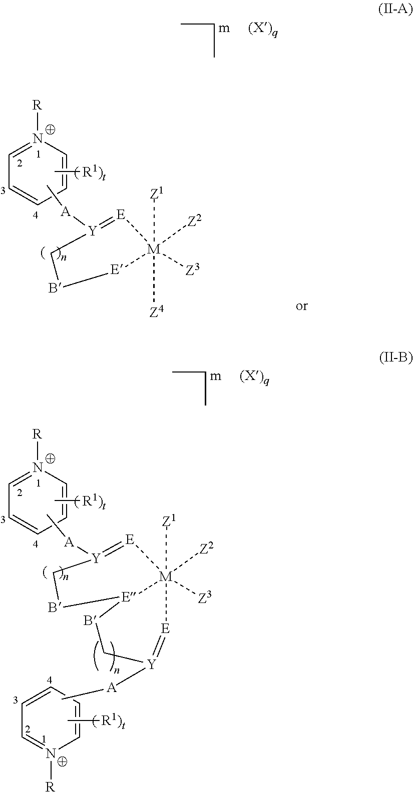
wherein:
E′ and E″ are each independently a carbocyclic, aromatic, heterocyclic, or heteroaromatic ring system comprising an endocyclic donor atom selected from O, N, C, S, Se, or P coordinated to the transition metal, and wherein the ring system is optionally substituted with one or more optional substituents; and
the remaining variables are as defined in any one of the preceding claims;
or a pharmaceutically acceptable salt, solvate, tautomer, stereoisomer, or resonance form thereof.

29. The complex of claim 28, wherein the complex is a compound of formula (II-A1) or (II-B1): 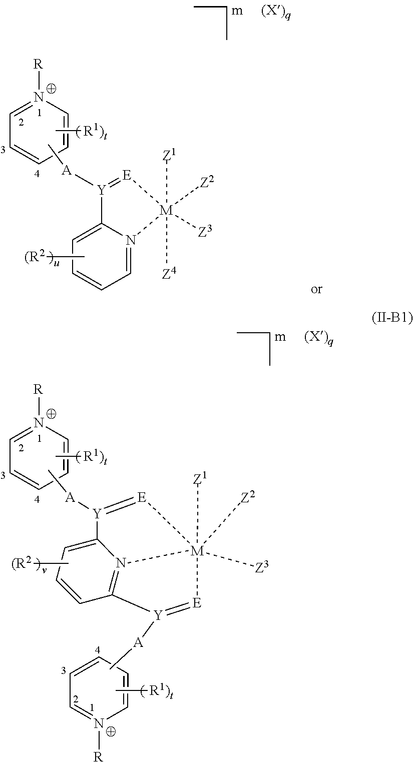
wherein:
R² is an optional substituent independently selected from halogen, —CN, —NO₂, —N₃, —SO₂H, —SO₃H, —OH, —OR^{a}, —ON(R^{b})₂, —N(R^{b})₂, —N(R^{b})₃⁺X⁻, —N(OR^{c})R^{b}, —SH, —SR^{a}, —SSR^{c}, —C(═O)R^{a}, —CO₂H, —CHO, —CR^{a}(OR^{c})₂, —CO₂R^{a}, —OC(═O)R^{a}, —OCO₂R^{a}, —C(═O)N(R^{b})₂, —OC(═O)N(R^{b})₂, —NR^{b}C(═O)R^{a}, —NR^{b}CO₂R^{a}, —NR^{b}C(═O)N(R^{b})₂, —C(═NR^{b})R^{a}, —C(═NR^{b})OR^{a}, —OC(═NR^{b})R^{a}, —OC(═NR^{b})OR^{a}, —NR^{b}C(N(R^{b})₂)N(R^{b})₂⁺X⁻, —OC(═NR^{b})N(R^{b})₂, —NR^{b}C(═NR^{b})N(R^{b})₂, —C(═O)NR^{b}SO₂R^{a}, —NR^{b}SO₂R^{a}, —SO₂N(R^{b})₂, —SO₂R^{a}, —SO₂OR^{a}, —OSO₂R^{a}, —S(═O)R^{a}, —OS(═O)R^{a}, —Si(R^{a})₃, —OSi(R^{a})₃, —C(═S)N(R^{b})₂, —C(═O)SR^{a}, —C(═S)SR^{a}, —SC(═S)SR^{a}, —SC(═O)SR^{a}, —OC(═O)SR^{a}, —SC(═O)OR^{a}, —SC(═O)R^{a}, —P(═O)₂R^{a}, —OP(═O)₂R^{a}, —P(═O)(R^{a})₂, —OP(═O)(R^{a})₂, —OP(═O)(OR^{c})₂, —P(═O)₂N(R^{b})₂, —OP(═O)₂N(R^{b})₂, —P(═O)(NR^{b})₂, —OP(═O)(NR^{b})₂, —NR^{b}P(═O)(OR^{c})₂, —NR^{b}P(═O)(NR^{b})₂, —P(R^{c})₂, —P(OR^{c})₂, —P(R^{c})₃⁺X⁻, —P(OR^{c})₃, —OP(R^{c})₂, —OP(R^{c})₃⁺X⁻, —B(R^{a})₂, —B(OR^{c})₂, —B(OR^{c})₃⁻X⁺, —BR^{a}(OR^{c}), ═O, ═S, ═NN(R^{b})₂, ═NNR^{b}C(═O)R^{a}, ═NNR^{b}C(═O)OR^{a}, ═NNR^{b}S(═O)₂R^{a}, ═NR^{b}, ═NOR^{c}, alkyl (for example C₁₋₁₀ alkyl or C₁₋₂₀ alkyl), perhaloalkyl (for example C₁₋₁₀ perhaloalkyl), alkenyl (for example C₂₋₁₀ alkenyl), alkynyl (for example C₂₋₁₀ alkynyl), carbocyclyl (for example C₃₋₁₀ carbocyclyl), heterocyclyl (for example 3-14 membered heterocyclyl), aryl (for example C₆₋₁₄ aryl), and heteroaryl (for example 5-14 membered heteroaryl), wherein each alkyl, alkenyl, alkynyl, carbocyclyl, heterocyclyl, aryl, and heteroaryl is optionally substituted with from 1 to 5 independently selected R^{d};
R^{a} at each instance is independently selected from C₁₋₁₀ alkyl, C₁₋₁₀ perhaloalkyl, C₂₋₁₀ alkenyl, C₂₋₁₀ alkynyl, C₃₋₁₀ carbocyclyl, 3-14 membered heterocyclyl, C₆₋₁₄ aryl, and 5-14 membered heteroaryl, or two R^{a} groups are joined to form a 3-14 membered heterocyclyl or 5-14 membered heteroaryl ring, wherein each alkyl, alkenyl, alkynyl, carbocyclyl, heterocyclyl, aryl, and heteroaryl is optionally substituted with from 1 to 5 groups independently selected from C₁₋₁₀ alkyl, C₁₋₁₀ perhaloalkyl, C₂₋₁₀ alkenyl, C₂₋₁₀ alkynyl, C₃₋₁₀ carbocyclyl, 3-14 membered heterocyclyl, C₆₋₁₄ aryl, and 5-14 membered heteroaryl;
R^{b} at each instance is independently selected from hydrogen, —OH, —OR^{a}, —N(R^{c})₂, —CN, —C(═O)R^{a}, —C(═O)N(R^{c})₂, —CO₂R^{a}, —SO₂R^{a}, —C(═NR^{c})OR^{a}, —C(═NR^{c})N(R^{c})₂, —SO₂N(R^{c})₂, —SO₂R^{c}, —SO₂OR^{c}, —SOR^{a}, —C(═S)N(R^{c})₂, —C(═O)SR^{c}, —C(═S)SR^{c}, —P(═O)₂R^{a}, —P(═O)(R^{a})₂, —P(═O)₂N(R^{c})₂, —P(═O)(NR^{c})₂, C₁₋₁₀ alkyl, C₁₋₁₀ perhaloalkyl, C₂₋₁₀ alkenyl, C₂₋₁₀ alkynyl, C₃₋₁₀ carbocyclyl, 3-14 membered heterocyclyl, C₆₋₁₄ aryl, and 5-14 membered heteroaryl, or two R^{b} groups are joined to form a 3-14 membered heterocyclyl or 5-14 membered heteroaryl ring, wherein each alkyl, alkenyl, alkynyl, carbocyclyl, heterocyclyl, aryl, and heteroaryl is optionally substituted with from 1 to 5 groups independently selected from C₁₋₁₀ alkyl, C₁₋₁₀ perhaloalkyl, C₂₋₁₀ alkenyl, C₂₋₁₀ alkynyl, C₃₋₁₀ carbocyclyl, 3-14 membered heterocyclyl, C₆₋₁₄ aryl, and 5-14 membered heteroaryl;
R^{c} at each instance is independently selected from hydrogen, C₁₋₁₀ alkyl, C₁₋₁₀ perhaloalkyl, C₂₋₁₀ alkenyl, C₂₋₁₀ alkynyl, C₃₋₁₀ carbocyclyl, 3-14 membered heterocyclyl, C₆₋₁₄ aryl, and 5-14 membered heteroaryl, or two R^{c} groups are joined to form a 3-14 membered heterocyclyl or 5-14 membered heteroaryl ring, wherein each alkyl, alkenyl, alkynyl, carbocyclyl, heterocyclyl, aryl, and heteroaryl is optionally substituted with from 1 to 5 groups independently selected from C₁₋₁₀ alkyl, C₁₋₁₀ perhaloalkyl, C₂₋₁₀ alkenyl, C₂₋₁₀ alkynyl, C₃₋₁₀ carbocyclyl, 3-14 membered heterocyclyl, C₆₋₁₄ aryl, and 5-14 membered heteroaryl;
R^{d} at each instance is independently selected from halogen, —CN, —NO₂, —N₃, —SO₂H, —SO₂H, —OH, —OR^{a}, —N(R^{b})₂, —N(R^{b})₃⁺X⁻, —N(OR^{c})R^{b}, —SH, —SR^{a}, —SSR^{c}, —C(═O)R^{a}, —CO₂H, —CHO, —CO₂R^{a}, —OC(═O)R^{a}, —C(═O)N(R^{b})₂, —NR^{b}CO₂R^{a}, —NR^{b}C(═O)N(R^{b})₂, —C(═NR^{b})R^{a}, —NR^{b}C(N(R^{b})₂)N(R^{b})₂⁺X⁻, —SO₂R^{a}, —OSO₂R^{a}, —C(═S)N(R^{b})₂, —P(═O)(R^{a})₂, —OP(═O)(OR^{c})₂, —P(R^{c})₂, —P(OR^{c})₂, —P(R^{c})₃⁺X⁻, P(OR^{c})₃, —OP(R^{c})₂, —OP(R^{c})₃⁺X⁻, —B(R^{a})₂, —B(OR^{c})₂, ═O, ═S, ═NR^{b}, ═NOR^{c}, alkyl (for example C₁₋₁₀ alkyl or C₁₋₂₀ alkyl), perhaloalkyl (for example C₁₋₁₀ perhaloalkyl), alkenyl (for example C₂₋₁₀ alkenyl), alkynyl (for example C₂₋₁₀ alkynyl), carbocyclyl (for example C₃₋₁₀ carbocyclyl), heterocyclyl (for example 3-14 membered heterocyclyl), aryl (for example C₆₋₁₄ aryl), and heteroaryl (for example 5-14 membered heteroaryl); and
X⁻ is a counteranion;
u is an integer from 0-4;
v is an integer from 0-3; and
the remaining variables are as defined in any one of the preceding claims;
or a pharmaceutically acceptable salt, solvate, tautomer, stereoisomer, or resonance form thereof.

30. (canceled)

31. The complex of claim 8, wherein Y=E at each instance is independently C═O or C═S.

32. (canceled)

33. (canceled)

34. (canceled)

35. (canceled)

36. (canceled)

37. (canceled)

38. (canceled)

39. (canceled)

40. (canceled)

41. The complex of claim 8, wherein each pyridinium ring attached to A is attached to A via the 4-position of the pyridinium ring.

42. (canceled)

43. (canceled)

44. The complex of claim 1, wherein the transition metal is ruthenium, osmium, or molybdenum.

45. (canceled)

46. The complex of claim 9, wherein the complex is a compound of the formula (II-A2), (II-A3), (II-A4), (II-A5), or (III-B2): 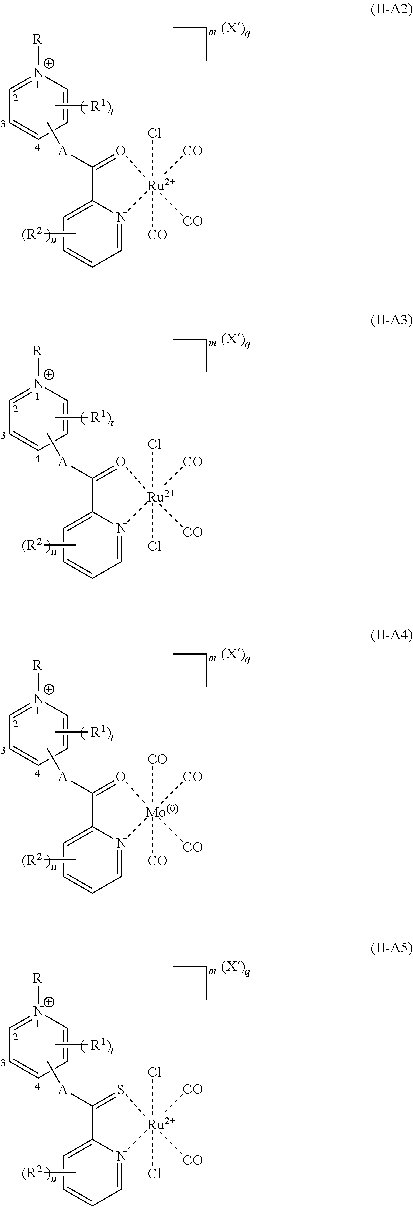 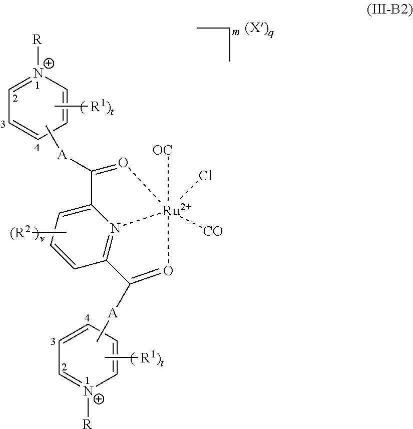
or a pharmaceutically acceptable salt, solvate, tautomer, stereoisomer, or resonance form thereof.

47. A composition comprising a complex according to claim 1, and a carrier, diluent or excipient.

48. A method of treating a disease or condition modulated by carbon monoxide (CO) or a disease or condition responsive to CO modulation in a subject in need thereof, the method comprising administering to the subject a complex of claim 1.

49. (canceled)

50. (canceled)

51. (canceled)

52. (canceled)

53. (canceled)

54. (canceled)
